(19) United States
(12) Patent Application Publication
(10) Pub. No.: US 2011/0145018 A1
(43) Pub. Date: Jun. 16, 2011

(54) DRUG AND MEDICAL DEVICE SAFETY AND SUPPORT INFORMATION REPORTING SYSTEM, PROCESSING DEVICE AND METHOD

(76) Inventors: Edward J. Fotsch, Sausalito, CA (US); Debra Del Guidice, Sausalito, CA (US); Era Prakash, New York, NY (US)

(21) Appl. No.: 13/029,770

(22) Filed: Feb. 17, 2011

Related U.S. Application Data
(63) Continuation-in-part of application No. 12/487,551, filed on Jun. 18, 2009.
Application No. 12/487,551 is a continuation-in-part of application No. 12/175,078, filed on Jul. 17, 2008, now abandoned.
Application No. 12/175,078 is a continuation-in-part of application No. 11/086,118, filed on Mar. 21, 2005.

(51) Int. Cl. G06Q 50/00; G06Q 10/00

(52) U.S. Cl. 705/3; 705/2

(57) ABSTRACT

A reporting system, including a processing device, and method provides drug and medical device safety and support information during a workflow of a healthcare provider. The system and method electronically acquires, maps, generates, compiles, verifies and transfers in real time critical information regarding particular drugs and medical devices required by healthcare providers, such as a prescriber, at the optimum time in which the healthcare provider needs the information. In an embodiment, the drug and medical device safety information is accessed from an associated healthcare website, such as an Electronic Health Record (EHR) web site, during a prescription stage in the healthcare providers workflow for a particular patient. The system and method also includes an adverse reporting system that allows for the drug and medical device safety information to be updated and accurately reported in an efficient and up to date manner. In an embodiment, a healthcare provider reports an adverse event or reaction to a drug by a patient during a workflow at a EHR web site. The adverse event information is forwarded to the Federal Drug Administration (FDA) and the particular drug manufacturer which may update the corresponding drug information. The updated drug information may then be reported by the system to insure that healthcare providers receive the most current, accurate and complete safety information during a workflow. In embodiments, the updated drug and medical information may be provided to malpractice insurance carriers to further ensure safety.

### CROSS-REFERENCE TO RELATED APPLICATIONS

This application is related to Attorney Docket No. MEDE-01000US0, patent application Ser. No. 10/387,041, entitled “HEALTHCARE PROVIDER-PATIENT ONLINE CONSULTATION SYSTEM,” filed on Mar. 10, 2003, naming Fotsch et al. as inventors, which is incorporated herein by reference for all purposes.

This application is also related to Attorney Docket No. MEDE-01000US1, patent application Ser. No. 10/641,982, entitled “HEALTHCARE PROVIDER-PATIENT ONLINE CONSULTATION AND COMPLIANCE PROGRAM,” listing Fotsch et al. as inventors, filed on Aug. 15, 2003, which is incorporated herein by reference for all purposes.

This application is also related to Attorney Docket No. MEDE-01000US2, patent application Ser. No. 11/085,984, entitled “ELECTRONIC PERSONAL HEALTH RECORD SYSTEM,” filed Mar. 21, 2005, naming Fotsch et al. as inventors, which is incorporated herein for all purposes.

This application is also related to Attorney Docket No. MEDE-01000US3, patent application Ser. No. 11/208,144, entitled “ELECTRONIC PERSONAL HEALTH RECORD SYSTEM,” filed on Aug. 19, 2005, naming Fotsch et al. as inventors, which is incorporated herein for all purposes.

This application is also related to Attorney Docket No. MEDE-01002US0, patent application Ser. No. 11/362,644, entitled “METHOD, SYSTEM AND ARTICLE OF MANUFACTURE, SUCH AS A CARD, TO PROVIDE USER SELECTABLE MEDICAL INFORMATION AND INFORMATION TO OBTAIN ELIGIBILITY OF HEALTHCARE PAYMENTS,” filed on Feb. 27, 2006, naming Fotsch et al. as inventors, which is incorporated herein for all purposes.

### CLAIM OF PRIORITY

This application is a continuation-in-part of U.S. patent application Ser. No. 12/487,551 [Attorney Docket No.: MEDE-01003US1], filed on Jun. 18, 2009 entitled, “HEALTHCARE NOTIFICATION METHOD AND SYSTEM INCLUDING A HEALTHCARE WEBSITE,” which is a continuation-in-part of pending U.S. patent application Ser. No. 12/175,078 [Attorney Docket No.: MEDE-01003US0], filed on Jul. 17, 2008 entitled, “HEALTHCARE NOTIFICATION METHOD AND SYSTEM INCLUDING A HEALTHCARE WEBSITE,” which is a continuation-in-part of pending U.S. patent application Ser. No. 11/086,118 [Attorney Docket No.: MEDE-01001US0], filed on Mar. 21, 2005 entitled, “HEALTHCARE NOTIFICATION SYSTEM”, each of which applications is incorporated by reference herein for all purposes.

### FIELD OF THE INVENTION

The present invention relates to healthcare information.

### BACKGROUND

The proliferation of drugs and medical devices to treat various diseases and medical conditions continues to grow. Research on existing as well as proposed new drugs and medical devices provides valuable information regarding their efficacy and safety. Clinical trials required for regulatory approval provide valuable information regarding the use of new drugs and medical device. After drug or medical device approval, further clinical trials and studies provide even more information regarding the approved drug or medical device. In addition, healthcare providers that prescribe the drug or use the medical device may also provide valuable safety information.

Yet despite the ever increase amount of safety information regarding drugs and medical devices, healthcare providers often do not readily have the most current, accurate and complete safety information. In certain circumstances, patient safety may be compromised when a healthcare provider does not have the most current, accurate and complete safety information. In order to obtain the most current safety information, a healthcare provider is often required to take valuable time out of a typical workflow to access the information from various books, notices, manuals or Internet sites, with continued uncertainty and probability that the provider will not access the most recent information. However, this additional research reduces the healthcare provider's efficiency in treating patients, which will likely result in higher medical service costs, and the continued probability of misinformation and the potential for increased patient issues and associated liability.

Similarly, when a healthcare provider discovers a possible adverse event related to a drug or medical device, the healthcare providers does not have an efficient mechanism to timely disseminate the adverse event information to the appropriate entities and other healthcare providers.

### BRIEF DESCRIPTION OF THE DRAWINGS

FIG. 1 illustrates a system 100 to report drug and medical device safety information according to an embodiment.

FIGS. 2-3 illustrate a system, including a processing device, for acquiring, mapping, generating and transferring drug and medical device safety information as well as reporting adverse event information according to an embodiment.

FIGS. 4-5 illustrate a method for acquiring, mapping, generating and transferring drug and medical device safety information as well as reporting adverse event information according to an embodiment.

FIG. 6 illustrates a software architecture of drug safety and support software 109 illustrated in FIGS. 1 and 3.

FIG. 7A illustrates a process for providing a plurality of different types of drug/medical device safety information in various formats for a selected drug/medical device according to an embodiment.

FIG. 7B illustrates mapping external third party drug terminology to a plurality of drug/device safety information in various formats according to an embodiment.

FIG. 8 illustrates a method to provide a plurality of drug/medical device safety information in various formats according to an embodiment.

FIG. 9A illustrates an exemplary web page 600 at an EHR web site that includes a links 601a-c to drug safety information provided by drug and support processing device 110 and software 109.

FIG. 9B illustrates an exemplary web page 610, at an EHR web site, that provides a full label for a selected drug.

FIG. 9C illustrates an exemplary web page 620, at an EHR web site, that provides a concise monograph for a selected drug.

FIG. 9D illustrates an exemplary web page 630, at an EHR web site, that provides a product safety alert for a selected drug.

FIG. 9E illustrates an exemplary web page 640, at an EHR web site, that provides a FDA drug safety communication for a selected drug.

FIG. 9F illustrates an exemplary web page 650, at an EHR web site, that provides a medication guide for a selected drug.

FIG. 10 illustrates an exemplary web page 700, at an EHR web site, that provides an adverse event reporting form.

FIGS. 11A-C illustrate systems to distribute healthcare related information to healthcare providers and patients according to an embodiment.

FIGS. 12A-C illustrate a software architecture of healthcare platform software 1102a illustrated in FIGS. 1A-B according to an embodiment.

FIGS. 13A-G are flow charts to illustrate distributing healthcare related information to healthcare providers and patients according to an embodiment.

FIG. 14 illustrates a hardware architecture of healthcare platform processing device 1102 shown in FIGS. 11A-B according to an embodiment.

FIG. 15A illustrates a healthcare related notification in the form of a HTML web page 1500 provided at healthcare website 1101 shown in FIGS. 11A-B according to an embodiment.

FIG. 15B illustrates a patient healthcare related notification 1501 provided from a healthcare provider via healthcare website 1101 shown in FIGS. 11A-B according to an embodiment.

FIG. 16 illustrates a healthcare related notification with a healthcare provider survey in the form of a HTML web page 1600 provided at healthcare website 1101 shown in FIGS. 11A-B according to an embodiment.

FIG. 17 is a diagram illustrating an exemplary system according to an embodiment.

FIG. 18A illustrates an exemplary HTML email including a notification that may be transmitted to healthcare providers.

FIG. 18B illustrates an exemplary non-HTML email with a link to an HTML web page including notification that may be transmitted to healthcare providers.

FIG. 18C illustrates an exemplary HTML web page with notification and physician response survey that may be transmitted to healthcare providers.

FIG. 18D illustrates an exemplary HTML notification with a physician response survey that may be transmitted to healthcare providers.

FIG. 19 is a diagram illustrating an exemplary system according to an embodiment.

FIG. 20 illustrates an exemplary email 2030 alert to an emergency physician that includes a link 2031 to a HTML web page having a healthcare related notification.

FIG. 21 illustrates an exemplary HTML web page 2100 that provides a healthcare related notification that includes a link 2101 to Continuing Medical Education (“CME”) information.

FIG. 22 illustrates an exemplary HTML web page 2200 that provides a CME test.

FIG. 23 illustrates an exemplary HTML web page 2300 that provides a log in function to an electronic prescription website.

FIG. 24 illustrates an exemplary HTML web page 2400 provided by the electronic prescription website that enables registration for healthcare related notifications.

FIG. 25 illustrates exemplary HTML web pages 2501-2502 used to log in or register for healthcare related notifications at a healthcare website.

FIG. 26 illustrates an exemplary HTML web page 2600 provided by the electronic prescription website that includes a link to a healthcare related notification.

FIG. 27 illustrates an exemplary HTML web page 2700 including healthcare related information that is accessed through a link at the electronic prescription website.

FIG. 28 illustrates an exemplary HTML web page 2800 provided by the electronic prescription website that does not indicate that healthcare related notifications are available as the healthcare related notification has been viewed.

### DETAILED DESCRIPTION

### I. Overview

A reporting system, including a processing device, and method provides drug and medical device safety and support information during a workflow of a healthcare provider, such as a physician. The drug and medical device safety information may, for example, pertain to a medical device recall, drug recall (or correction, such as a label change), newly discovered information about a drug such as drug interactions, use of the drug with patients with various medical disorders, or modifications to the proper dosage and administration of the drug. The system and method electronically acquires, maps, generates, compiles, verifies and transfers in real time critical safety information regarding particular drugs and medical device required by healthcare providers, such as a prescriber, at the optimum time in which the healthcare provider needs the information.

For example, drug and medical device safety information is provided in the workflow at the time when a healthcare provider is at least 1) looking at a patient chart that includes a list of current medications, where one or more medications or devices on that list has new safety information, b) in the context of generally accessing drug or medical device information for possible prescribing, or c) in the context of e-prescribing and/or any other manifestations of drug information within an electronic health/medical record (“EHR”)

The reporting system includes a multi-faceted delivery system that unifies different processing devices, standards and mapping to create a comprehensive drug and medical device reporting system for healthcare providers, regulatory agencies and manufacturers. A multi-faceted mapping protocol links various forms of clinical and non-clinical safety and support information for particular drugs and medical devices, at various levels of detail. The reporting system enables compliance with various regulations as well as increases the likelihood that accurate drug and medical device safety information is timely collected and disseminated to the interested entities, thereby improving patient care and safety.

In an embodiment, the drug and medical device safety information is accessed from an associated healthcare website, such as an electronic health/medical record (“EHR”) website or other application, during a prescription stage in the healthcare provider's workflow for a particular patient. In an alternate embodiment, the associated healthcare website is an electronic prescription (“ERX”) website. An indication that safety information for a particular drug or medical device used by a particular patient is available during a workflow of a healthcare provider at these associated healthcare websites. For example, a hyperlink associated with a drug or medical device used by the patient may be provided to allow access to the most current, accurate and complete safety information. In alternate embodiments, the drug or medical safety information may be provided by a web service and/or embedded extensible markup language (“XML”), structure product labeling (“SPL”) or other equivalent electronic format.

The system and method also includes an adverse reporting system that allows for the drug and medical device safety information to be updated and accurately reported in an efficient and timely manner. In an embodiment, a healthcare provider reports an adverse event or reaction to a drug by a patient during a workflow at an EHR web site. The adverse event information maybe electronically transferred to the Federal Drug Administration (“FDA”) and the particular drug (or pharmaceutical) manufacturer which may update the corresponding drug safety information. The FDA and manufacturers governed by the FDA are responsible for notifying healthcare providers of a product recall, warning or label change. The updated drug/medical device safety information may then be reported electronically by the system to insure that healthcare providers receive the most current, accurate and complete safety information during a workflow.

In an embodiment, reporting adverse drug and medical device events is also provided in an efficient and timely manner during the workflow of a healthcare provider. In an embodiment adverse drug and medical device tools or forms are provided at the highest level in the EHR (for example, main navigation web page) website. In another embodiment, a healthcare provider is provided with adverse drug and medical device tools or forms while accessing related information, such as a decision support web page at the EHR website.

In embodiments, the updated drug and medical information may be provided to malpractice insurance carriers and associated healthcare websites (or associated healthcare vendors) to further ensure safety. A malpractice insurance carrier may then provide clinical education programs and Continuing Medical Education (“CME”) information for a particular drugs or medical devices in response to the adverse event information. Associated healthcare websites may likewise provide education and training in response to the adverse event information.

In embodiments, the drug and medical device information includes a plurality of different types of safety information, obtained from different sources, for each of a plurality of drugs or medical devices. In an embodiment, the different sources include the FDA and manufacturers (drug and medical device). In embodiments, the plurality of different types of safety information for a particular drug or medical device is in different formats and associated with a particular identifier. In an embodiment, the plurality of different types of safety information includes full drug or medical device label (“Full Label”), concise monographs (“Concise”) or summary of the full label, alert, FDA Dear Healthcare Provider Letter (“DHCPL”) or sheet which contains a product safety alert/notification, medication guide (“MG”), risk evaluation and mitigation strategy (“REMS”)-term summary, REMS-Notification Summary and FDA Early Warnings. In embodiments, a full label may be accompanied by CME information. Similarly, an alert may be accompanied by a MG, DHCPL, Package insert of a drug/medical device and/or CME information.

In an embodiment, REMS refers to a FDA program that requires a variety of different actions depending on the severity of the potential safety issues with a particular drug or device. These actions can range from distribution of a MG to patients because of requirements of a healthcare provider in prescribing a particular drug or using a particular medical device to obtaining a certification by the healthcare provider before prescribing or using the medical device. In an embodiment, only healthcare providers that have been certified (or have a certification) for a particular drug and/or medical device are allowed to prescribe the particular drug and/or use the particular medical device on a patient. In an embodiment, a delivery agent, such as a pharmacist and/or medical device manufacturer, would not fill a prescription for a particular medication or provide the medical device unless the certification of the healthcare provider is verified by way of an electronic database. For example, a healthcare provider may be certified after one or more of the following occurs: 1) the healthcare provider reviews education material regarding the medication and/or medical device (that may be provided with healthcare alerts in an embodiment); 2) the healthcare provider passes a test covering the education material; 3) the healthcare provider ensures that the patient is educated regarding the medication and/or medical device; and 4) a document describing the drug and/or medical device including its risks and side effects has been read, understood, accepted, signed and stored in a patient's medical record, such as an electronic health record. In an embodiment, a delivery agent would not fill the prescription for the medication and/or provide the medical device without verifying that not only the healthcare provider is certified, but that the patient has been certified as well. In an embodiment, a patient may be considered certified by having a signed document as described above stored in the patient's medical records that may be verified by the delivery agent.

In an embodiment, certification of a healthcare provider for a particular drugs and/or medical device is provided at least partly by the reporting system. Certifications for both healthcare providers and patients may be stored in an electronic database in the reporting system. The certifications may then be accessed and verified by delivery agents, such as pharmacists and medical device manufacturers.

In an embodiment, the reporting system provides Continuing Medical Education CME information and/or tests including questions associated with a particular drug or medical device. In an embodiment, the CME may be associated with an alert/notification of a particular drug or medical device; this alert/notification can be a safety notification, or CME associated with a REMS program. A healthcare provider may take the tests after reviewing the healthcare notifications in order to satisfy requirements for license renewal or specialty certification (i.e. general CME as well as CME required for Maintenance of Certification (“MOC”) by medical boards). The healthcare system may compare healthcare provider's answers with correct answers in order to award credits. Upon successful completion of CME tests, earned credits by the participating healthcare providers may be stored in and accessed from the healthcare website. In yet another embodiment, the status of other MOC requirements may be stored and accessed from the healthcare website. Different requirements may be required by different medical boards. For example, the American Board of Surgery may have different MOC requirements and different MOC tests than the American Board of Internal Medicine. Other MOC requirements may include verification of the healthcare provider's 1) good medical standing, such as an unrestricted license, hospital privileges and satisfactory references; and 2) practical performance evaluations that may include evaluations of professionalism and communication.

A healthcare website (or portal) provides time-sensitive, safety healthcare related notifications from organizations, such as healthcare agencies, medical device manufacturers and pharmaceutical manufacturers, to healthcare providers, such as physicians. The healthcare related notifications (also referred to herein as notifications or healthcare notifications) may affect the patients of the healthcare provider or the general population. Acknowledgement of the notifications, along with a suite of services, is provided at the healthcare website for healthcare providers.

In an embodiment, the healthcare website is provided by a system including a healthcare platform processing device that is coupled to the Internet along with associated software that generates the notifications from organizations to healthcare providers along with the suite of services.

A medical event or issues affecting a patient or the general population health may arise under a variety of circumstances. For instance, it may be necessary to notify physicians of product recalls or label changes on medications, as well as provide education and certification requirements for certain existing/new medications (drugs) or medical devices. In particular, safety notices may be provided to physicians that result from a clinical trial of a drug and/or medical device. Other possible scenarios affecting the general population may include bio-terrorism outbreaks or local epidemics. The Federal Drug Administration (“FDA”) and manufacturers are charged with the responsibility of notifying physicians and other healthcare providers and their patients in the event of a product recall, warning or label change, and the Centers for Disease Control (“CDC”) and other government agencies bear the responsibility of notifying physicians and other healthcare providers and the public in the event of a local, regional or national public health threat. Thus, the organizations communicating with physicians via the healthcare website may include the FDA, CDC, and other federal agencies, as well as other companies or organizations, such as those that are governed by the FDA. The terms healthcare provider and physician will be used interchangeably herein.

In accordance with an embodiment, FDA regulatory requirements are fulfilled and include notifying physicians of health-related issues with and/or changes to the use of products that could impact patient safety. The FDA regulatory requirements also include a follow-up aspect ensuring that the physicians received the notification transmitted to them and that their patients were notified. In order to satisfy these regulatory requirements, a notification and acknowledgement system is provided as described in further detail below.

In accordance with another embodiment, a notification system and method is provided that enables organizations such as the CDC or FDA (or companies governed by the FDA) to make contact with physicians regarding issues affecting patient health. In an embodiment, the notification system and method enables a notification to be generated and transmitted via electronic mail on behalf of an organization to physicians. The electronic mail will include a link to the healthcare website that includes the notification, as well as a suite of other services. In an embodiment, the electronic mail (or other type of electronic message such as text message) may include a link directly to the healthcare notification.

In an embodiment, an acknowledgement is provided that enables an acknowledgement message to be transmitted back to the healthcare website (or in particular the healthcare platform processing device) and then reported to the corresponding organization. The acknowledgement message may be transmitted automatically or in response to input by the healthcare provider. In an embodiment, the acknowledgement message will indicate that the healthcare provider has received and opened the notification message. In another embodiment, the acknowledgement message may indicate that the healthcare provider has read and understands the notification. In yet another embodiment, the acknowledgement message may indicate that the healthcare provider will follow or has followed the instructions provided in the notification message or, alternatively, that the healthcare provider will notify or has notified patients of the issue affecting patient health that has been identified in the notification message.

In an embodiment, the healthcare website may provide healthcare notifications by way of other associated healthcare websites. An indication that a healthcare notification is available may be provided to healthcare providers at these associated healthcare websites depending upon whether the healthcare provider has already viewed the healthcare notification. For example, a healthcare provider would not receive an indication of the healthcare notification when the healthcare provider has already reviewed the healthcare notification by way of an acknowledged email. Healthcare providers may access the healthcare notifications from the associated healthcare websites by either registering or logging into the healthcare website from the associated healthcare website. In an alternate embodiment, a hyperlink to the healthcare notification may be provided to selected healthcare providers at the associated healthcare websites.

Other services provided at the healthcare website may include accesses to related literature or a dialogue with peers or other healthcare providers regarding the notification or topics of a general nature. Access to other important information may influence the healthcare provider's action with regard to the received notification information.

In accordance with an embodiment, healthcare providers have access to a patient version of the notification and the ability to send the patient version to predetermined patients. This may be accomplished via a network in which the healthcare provider and the patients are members. (This network may be included in the system having the healthcare platform processing device, or a different network, from the system used by organizations to reach healthcare providers with the notification messages.) A healthcare provider may choose to send a notification message to all of their patients. Alternatively, a healthcare provider may select to identify the patients, to which the health-related issue pertains, thereby enabling the healthcare provider to send a notification message to a predetermined subset of patients.

In accordance with an embodiment, a healthcare provider may identify a subset of patients via an electronic health record system (or electronic database) that stores a plurality of patient records. By searching the online health record system, a healthcare provider may identify the subset of patients to which the health-related issue pertains.

Healthcare providers may have important information to share with the notifying organizations, regarding such things as adverse events or reactions, community observations, and other information that is crucial and time-sensitive. An additional service is provided to healthcare providers to share this important and time-sensitive information with the appropriate third parties. In accordance with yet another aspect of the invention, the healthcare website will provide physician-organization communications to report adverse reactions to medications and devices; healthcare findings resulting from a local or regional biological/communicable threats, outbreaks or other crisis. This reporting may be related to a current or prior notification or may be unrelated to the notification. This reporting may be to the appropriate pharmaceutical company or medical device manufacturer, federal agency including but not limited to the FDA, CDC, and other organizations that the physician desires to notify.

Still another service includes allowing healthcare providers access to pharmaceutical samples, when one being prescribed is recalled, has a black-box warning or label change that requires the physician to turn to another drug for his/her patients or when a physician needs medication available to treat local or regional disease outbreaks, bio-terrorism or other threats to patient safety. Facilitating access to sample ordering will allow healthcare providers to effectively and efficiently get to know new medications and facilitate patient access to medications immediately upon diagnoses.

In an embodiment, the healthcare website enables peer review of communications between organizations and healthcare providers. In particular, although healthcare providers may have direct access to the healthcare website to transmit messages, organizations may submit communications from healthcare providers for review by others before they can be transmitted to other healthcare providers. Others, or a governing body, then review the communications to ensure that it meets criteria for delivery to healthcare providers. When the communications meet the criteria, the communications or a portion thereof is transmitted to healthcare providers. Similarly, when responses or acknowledgments are received from healthcare providers, these responses may be compiled by the individuals associated with the organizations with regard to “fulfillment” of the action required of the communication.

Another service at the healthcare website allows healthcare providers the ability to refer back to notifications that have been sent. The ability to create a healthcare provider-specific repository of prior notifications for their reference purposes is important to the continued safe prescribing and monitoring of prescription drugs and medical devices, and to the continued safe practice of medicine for a physician, while treating a patient where a notification contains information that may validate an observation of a patient or population. Still yet another service, allows healthcare providers to save, file, or delete notifications, and retrieve notifications from their files for reference at a later date.

Another service at the healthcare website allows healthcare providers the ability to update their notification profile, to ensure its currency. Accordingly, time critical notifications will be provided in a manner that is most efficient for that particular healthcare provider. For example, one physician may prefer the notification sent directly to a wireless handheld device; while another physician would prefer the notification be provided to his office computer. In each case, the physician will receive the notifications in the most efficient manner based on the physician's practice.

Another service at the healthcare website allows healthcare providers the ability to update their practice profile to ensure its currency. This practice profile may be included in healthcare platform software 1102a or may be a profile used to provide practice information to patients and other healthcare providers from another source.

In an embodiment, the functionality of the healthcare website may be integrated into a portlet or applet within third party systems or applications, including but not limited to physician practice electronic medical/health record systems, practice management systems, and other third party systems. For example, an applet is embedded into an application to facilitate access to notifications. Notifications may be integrated into the workflow of an application so that the notifications are provided by way of a message inbox or task bar.

In the following description, numerous specific details are set forth in order to provide a thorough understanding of embodiments. It will be obvious, however, to one skilled in the art, that embodiments may be practiced without some or all of these specific details. In other instances, well known process steps have not been described in detail in order not to unnecessarily obscure a particular embodiment.

The present embodiments, among other embodiments, describe providing a plurality of different types of drug and medical device safety information via the Internet. The present embodiments describe online healthcare provider-organization notifications and acknowledgements via the Internet. In an example, the healthcare provider is a physician. Thus, the following example will refer to physician-organization communications. The terms healthcare provider and physician will be used interchangeably herein. However, it is important to note that the healthcare provider need not be a physician.

### II. System and Hardware Architecture

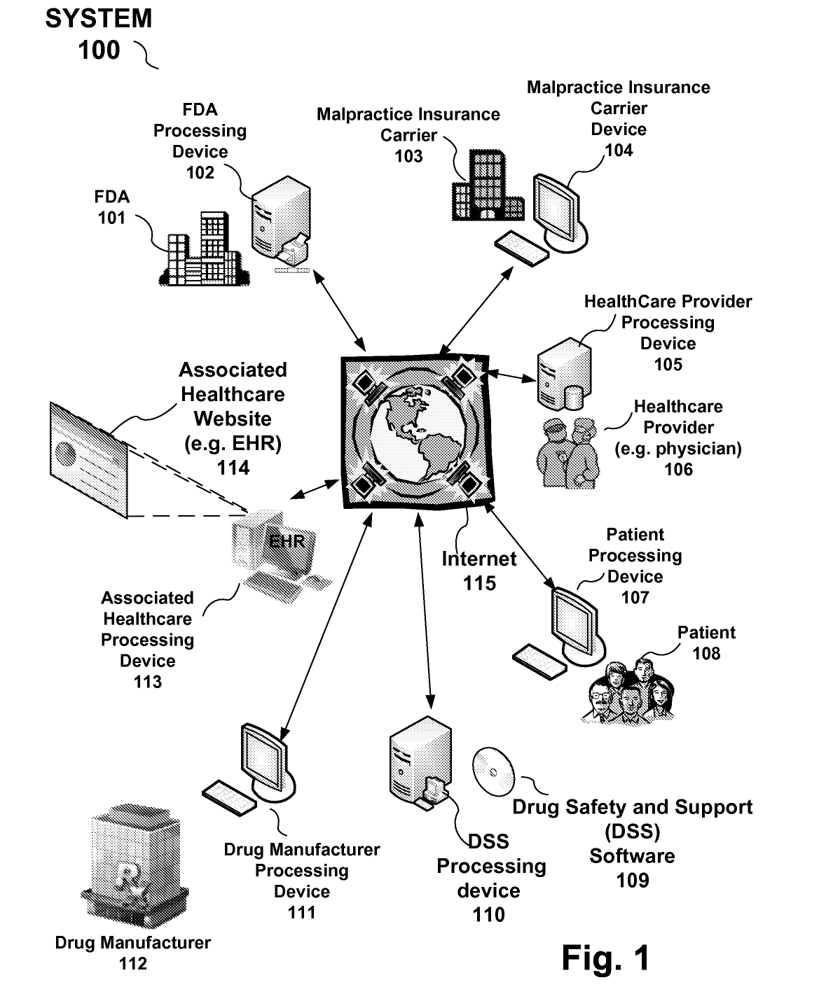

FIG. 1 illustrates a system 100 that provides the most current, accurate and complete drug and medical device safety information, in an efficient and timely manner to one or more healthcare provider(s) 106. System 100 electronically acquires, maps, generates, compiles, verifies and transfers in real time critical safety information regarding particular drugs and medical devices needed by healthcare provider 106 in a workflow. In an embodiment, the safety information is accessible by healthcare providers 106 from Healthcare Provider processing device 105 via Associated Healthcare website 114.

In an embodiment, drug and medical device safety information is acquired by Drug Safety and Support (“DSS”) processing device 110 executing DSS software 109. Drug and medical safety information may be acquired from FDA processing device 102 used by the FDA as well as Drug Manufacturer processing device 111 used by Drug Manufacturer 112. In an embodiment, Drug manufacturing processing device 111 is replaced with or in addition to a Medical Device manufacturer processing device. As described in detail below, DSS processing device 110 along with DSS software 109 maps and compiles a plurality of different types of drug and medical device safety information acquired from FDA processing device 102 and Drug Manufacturer processing device 111 for a plurality of drugs and medical devices. Similarly, DSS processing device 110 along with DSS software 109 generates further safety content associated with the plurality of drugs and medical devices. The plurality of different types of drug and medical device safety information is then accessible from Associated Healthcare website 114 provided by Associated Healthcare processing device 113.

In an embodiment and described in detail below, information including adverse event information regarding a particular drug or medical device is provided by a healthcare provider 106 via Healthcare Provider processing device 105 and Associate Healthcare website 114. In an embodiment, the adverse event information is transferred to Malpractice Insurance carrier 103 via Malpractice Insurance carrier processing device 104. Similarly, Malpractice Insurance carrier 103 via Malpractice Insurance carrier processing device 104 transfers updated safety information to DSS processing device 110.

In an embodiment, information is transferred to and from patient 108 via Patient processing device 107.

In an embodiment, Associate Healthcare website 114 is an EHR or ERX website that provides healthcare services, such as electronic health records for patient 108 or prescription services for patient 108. For convenience, information is described herein as being transferred to and from Associate Healthcare website 114 (or another web site); however, one of ordinary skill in the art understands that information is actually transferred to and from Associated Healthcare processing device 113 executing Associated Healthcare software. Similarly for convenience, Associate Healthcare website 114 (or another website) is described herein as processing information when in actuality Associated Healthcare processing device 113 and Associated Healthcare software is actually performing the processing.

In an embodiment, processing devices 102, 104, 105, 107, 110, 111 and 113 are coupled and communicate by way of Internet 115. In alternate embodiments, DSS processing device 110 along with DSS software 109 is integrated with an Associated Healthcare vendor, in-patient systems, health plan systems and/or pharmacy systems. In embodiments, system 100 may have far greater or fewer processing devices. In embodiments, a processing device may represent multiple hardware components or a network of distributed processing devices or hardware components. Processing devices may be coupled to Internet 115 by way of a wired or wireless connection, singly or in combination.

Associated Healthcare website 114, in an embodiment, is a collection of healthcare related web pages, images, videos or other digital healthcare related services that is hosted on one or more processing devices (such as Associate Healthcare processing device 113) and is accessible via the Internet 115 by client processing devices. In an embodiment, a web page is a digital document that may be written in HTML (Hypertext Markup Language) or an equivalent. The HTML document may be accessible via HTTP (Hypertext Transfer Protocol), a protocol that transfers information from a processing device to another processing device in response to a request. In an embodiment, one or more processing devices in system 100 include a HTML-compatible browser to view HTML web pages. In an embodiment, HTML documents are provided from at least Associated Healthcare processing device 113 to HealthCare Provider processing devices 105 in response to a request. HTML provides basic document formatting and allows “links” or “hyperlinks” to other processing devices (or servers) and files. A link such as a Uniform Resource Locator (“URL”) has a specific syntax that identifies a network path to a server for defining a network connection. Embedded hyperlinks on a given web page can be used to find information related to the given web page. By clicking on or selecting a hyperlink in one web page, the user can display another related web page or even invoke a related software program.

In an embodiment, DSS processing device 110 along with DSS software 109 provides a Drug and Medical Device Safety and Support web site accessible by healthcare provider 105 via Healthcare processing device 105. In an embodiment, a Drug and Medical Device Safety and Support web site is similarly accessible by processing devices 102, 104, 107, 110, 111 and 113.

In embodiments, processing devices transfer information using messages, such as Internet Protocol (“IP”) packets, and a standard protocol such as HTTP. Each processing device illustrated in FIG. 1 includes associated application software. Applications or application software may be accessed through a web browser on their respective processing devices using HTML or by special purpose client software which access interfaces exposed by a processing device. In an embodiment, FDA processing device 102, Drug Manufacturing processing device 111 and Malpractice Insurance Carrier processing device 103 includes application software or machine readable instructions stored in respective storage devices that provide drug and/or medical device safety information to DSS processing device 110. Similarly, Associated Healthcare processing device 113 includes software or machine readable instructions stored on a storage device that provides health related services, such as electronic health records, via Associated Healthcare website 114.

In embodiments, a processing device may include a mainframe computer, server, laptop computer, hand-held computer, personal digital assistant, a facsimile machine, a telephone, a cellular telephone, a pager, short message service (SMS) messaging device, email device, an information appliance, or an equivalent. In an embodiment, a processing device includes a router. In another embodiment, a process device represent a local area network (“LAN”) or wide area network (“WAN”) of processing devices. In an embodiment, a processing device includes at least one integrated circuit processor that executes machine readable instructions or software stored on an electronic storage device. An electronic storage device may include an integrated circuit memory device or other electronic storage technology.

In an embodiment, healthcare providers may include, but not limited to, physicians, physician assistants and non-prescribing individuals associated with clinical trials.

DSS processing device 110 along with DSS software 109 provides drug and medical device safety information along with adverse reporting services/tools to entities illustrated in FIG. 1. In embodiments, DSS processing device 110 along with DSS software 109 provides the following processes, functions, services and/or tools:
1. Electronically acquire a FDA-approved Full Label for a drug or medical device from Manufacturer or FDA;
2. Create a Concise or summary of the FDA-approved Full Label;
3. Electronically map Full Label and Concise to medical industry standard drug and medical device nomenclature or terminology, which may be provided in the National Drug Code (“NDC”) directory, RxNorm, and/or Drug Concept;
4. Electronically acquire further safety information for each drug and/or medical device:
   a. Alerts or notification regarding safety of each drug and/or medical device
   b. Drug Safety Communications, such as FDA DHCPLs or sheets
   c. MGs
   d. REMS Terms Summary which lists possible contents of the REMS-Notification Summary (listed next as e.). REMS Terms Summaries aid healthcare providers understand what REMS is and what the terms mean.
      i. Prescriber Education
      ii. Prescriber Certification
      iii. Patient Education
      iv. Patient Contracts
      v. Prescriber Surveys
      vi. Patient Surveys
      vii. Medication Guides
   e. REMS-Notification Summary
   f. FDA Early Warnings are notifications of the potential for a safety problem. FDA issues an FDA Early Warning after there is enough information on a potential problem to require more research. Once enough information is obtained, the FDA notifies prescribers so they can a) factor the new information as they prescribe, and b) report anything they see with a patient that may be similar to the early information;
5. Generate summary content for a-f above in XML and/or other electronic formats;
6. Electronically map a-f above to Full Label/Concise, and medical industry standard drug and medical device terminology or nomenclature;
7. Generate CME for each drug and/or medical device
   a. Map CME to Full Label
   b. Map CME to Alert;
   c. Map CME to REMS;
8. Electronically acquire and map, by manufacturer and by drug or medical device, the following drug and medical device support services:
   a. Samples, Coupons available to Patients
   b. Patient financial assistance available
   c. Patient education
   d. Adverse Event Reporting
   e. Clinical Reference or clinical information available to prescribers that provides information on all aspects of the drug and answers to Frequently Asked Questions (“FAQ”).
   f. Ask the Expert or a designated individual(s) within a manufacturer organization who can answer detailed questions about a drug for prescribers—especially important when the prescriber has a complicated set of patient issues/other drugs to resolve for as they contemplate prescribing.
   g. Physician Communications/Education
   h. Patient Communications/Education
   i. Registries or patient registries required to facilitate access to patients taking a drug or using a medical device (particularly true for medical devices because unlike drugs there is no information regularly available in the system once a medical device has been prescribed/implanted, and the patient gets “lost” to those that may have important information for them) to let them know of new safety issues with the drug or medical device.
   j. Clinical Trials that are available
   k. Patient medication adherence programs;
9. Provide electronically all of the above, for integration by third parties, including but not limited to EHR vendors, in-patient systems, health plan systems, pharmacy systems;
10. Create a patient-specific set of data based on the information defined above, to include:
   a. Provide direct access to FDA-approved Medication Guides
      i. Links through to Full Labels, Alerts, REMS and other FDA-approved materials available to U.S. physicians
   b. Immediate Patient notification of FDA or other clinical warnings or Alerts
      i. Recalls, Safety notices, new REMS programs by way of EHR web sites
   c. Conduct FDA-required REMS patient assessments
   d. Automate delivery of FDA-approved medical device information
      i. Implantable, home and portable devices
      ii. Triggered by entry of device identifier in Patient's medical record or EHR;
11. Provide electronic adverse event reporting services or tools for drug and medical devices to associated healthcare websites (such as EHR and ERX), manufacturers and government agencies including the FDA and Agency for Healthcare Research and Quality (“AHRQ”);
12. Electronically “crawl” labels for adverse event; identify and auto-gen report to reporter if found;
13. Integrate/map adverse event information to industry-standard format reports;
14. Electronically deliver adverse event reports to federal agencies and manufacturers based on agreed-upon protocols, using industry-standard security mechanisms including encryption for data confidentiality and digital signatures for data integrity and sender verification.

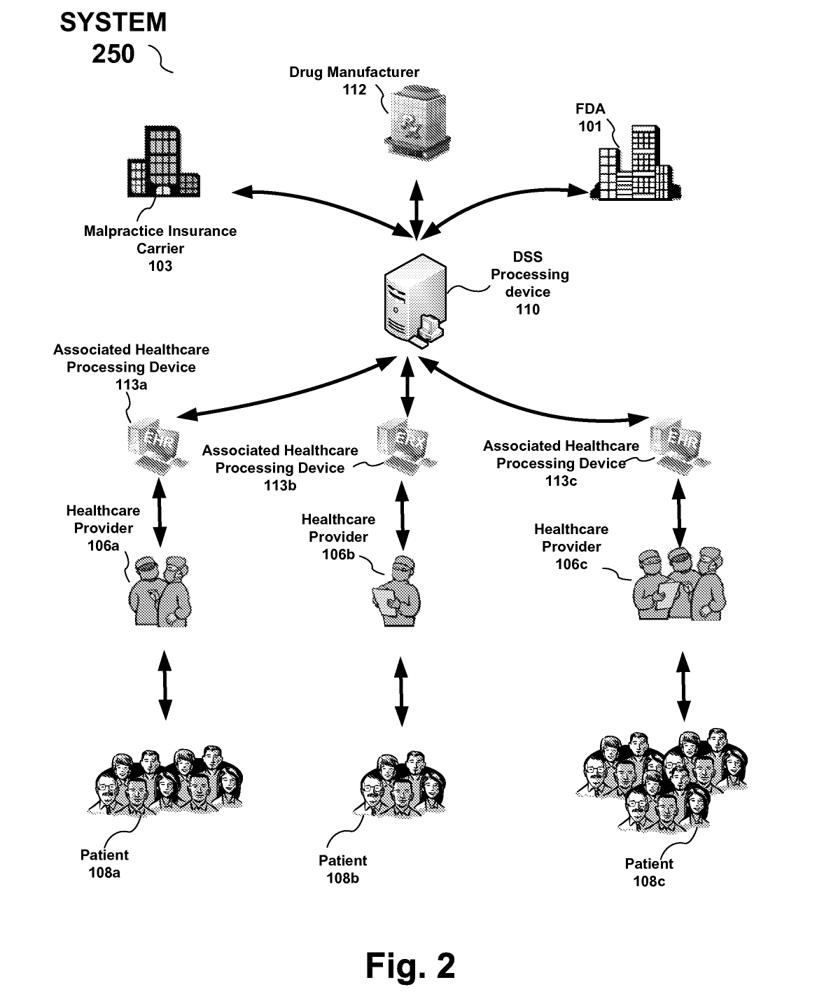

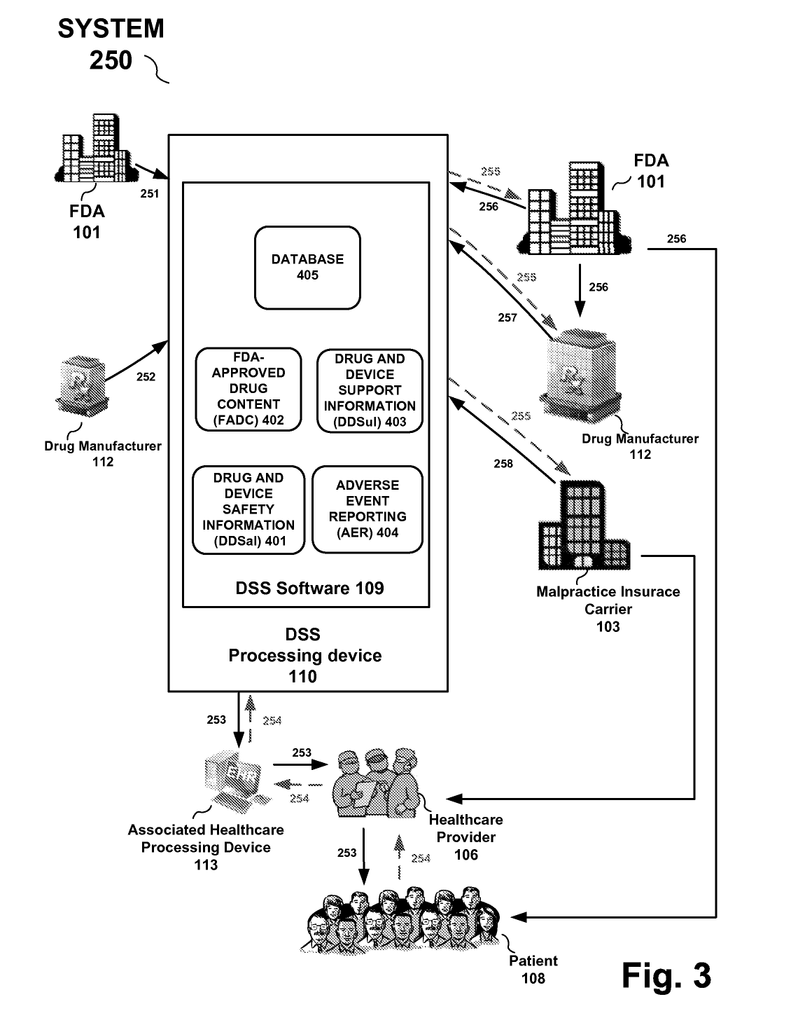

FIG. 2 illustrates a system 200 to provide drug and medical device safety and support information to a plurality of Associated Healthcare processing devices 113a-c from DSS processing device 110 according to an embodiment. For clarity, some associated processing devices and software are omitted from FIG. 2. Similar to FIG. 1, drug and medical device safety and support information is transferred between Malpractice Insurance carrier 103, Drug manufacturer 112 and FDA 101 (in particular processing device associated with these entities) and DSS processing device 110. FIG. 2 illustrates how DSS processing device 110 transfers drug and medical device safety and support information between multiple Associated Healthcare processing devices 113a-c used by multiple different healthcare providers 106a-c having different respective patients 108a-c. Similarly, FIG. 2 illustrates how multiple healthcare providers 106a-c may report multiple different adverse events from patients 108a-c which may be using the same drug or medical device.

FIGS. 3 and 4-5 illustrate an operation of a system 250 and method 300 according to embodiments. FIG. 3 is similar to FIG. 1 with some processing devices and software used by illustrated entities omitted for clarity. When information is described as being transferred between entities illustrated in FIG. 3, information is actually being electronically transferred between associated processing devices and respective software as similarly described herein and illustrated in FIG. 1. In an embodiment, FIG. 3 illustrates the transfer of drug and medical device safety information (or data) by solid arrowed lines and the transfer of adverse event information (or data) by dotted arrowed lines. However, other embodiments have different transfers of drug and medical safety information as well as adverse event information.

FIG. 3 illustrates a DSS processing device 110 having software components which are described in detail below. The software components include DDSaI 401, FADC 402, DDSuI 403, AER 404 and Database 405. In alternate embodiments, more or less software components are included.

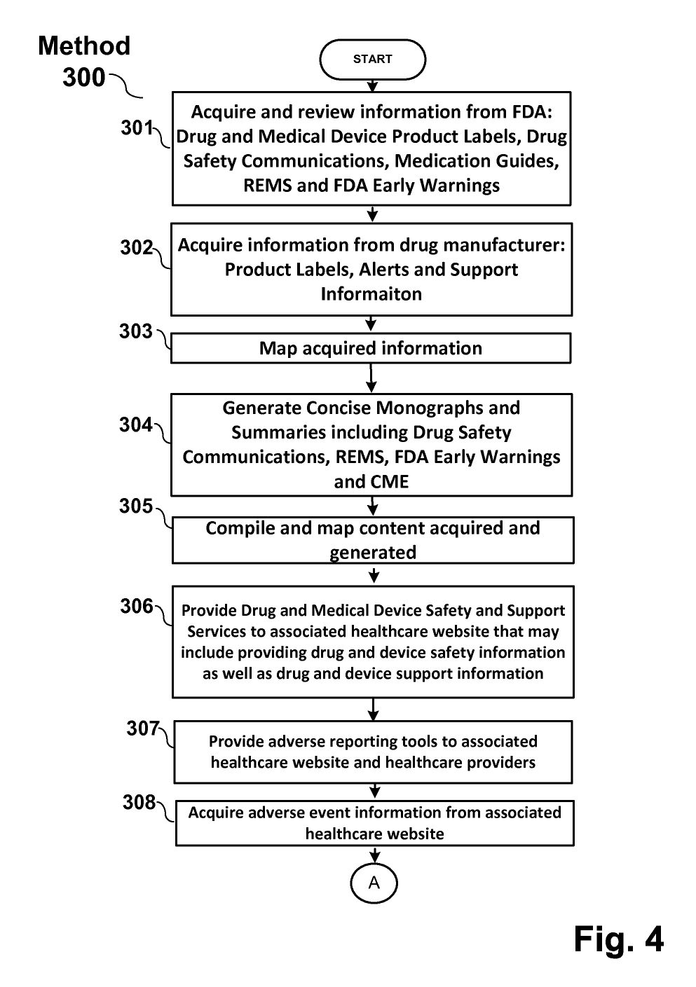

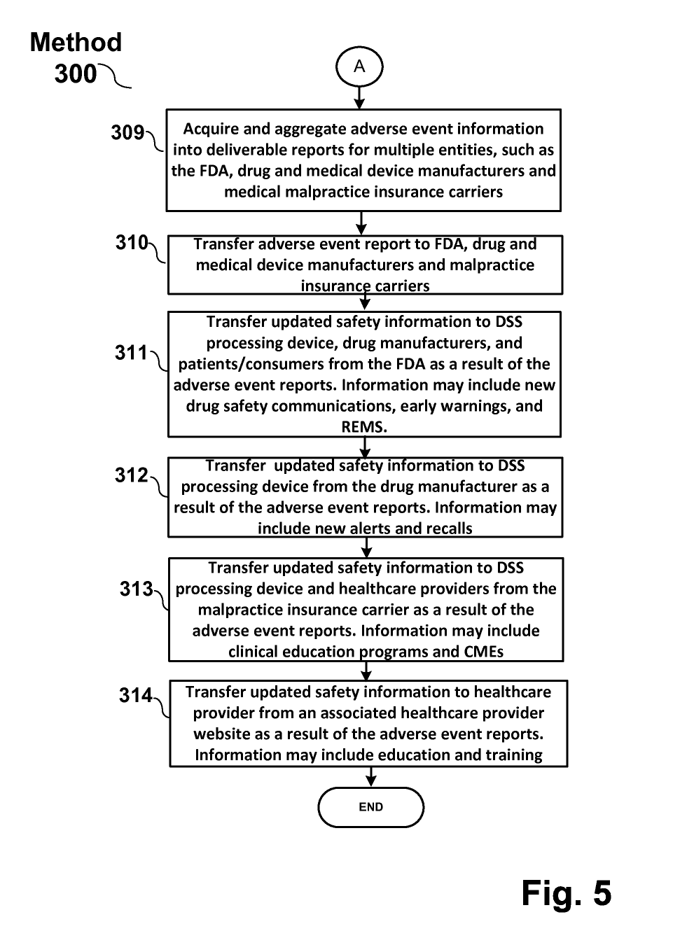

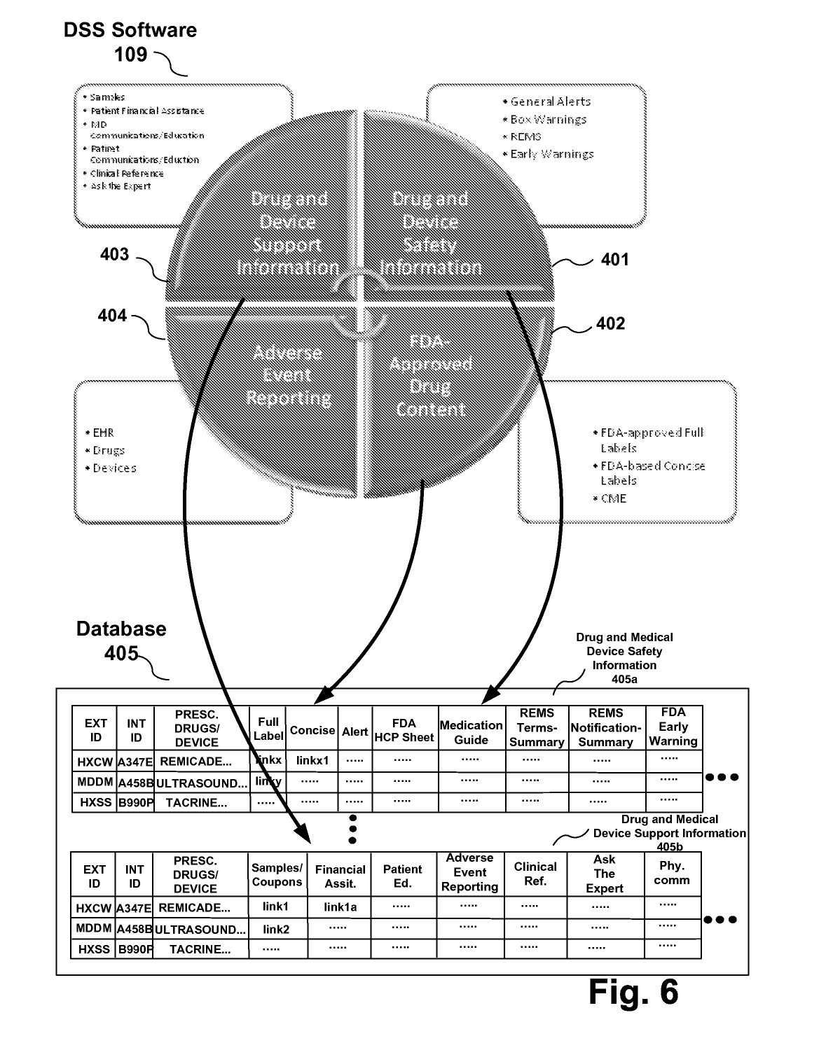

In an embodiment, FIGS. 4-5 illustrate at least the operation of system 250 shown in FIG. 3. As one of ordinary skill in the art would appreciate, FIGS. 4-5 illustrate logic blocks or steps for performing specific functions. In alternate embodiments, more or fewer logic blocks or steps are used. In an embodiment, a logic block or step may represent at least partial execution of a software component as well as execution of a hardware operation or user operation, singly or in combination. For example, many logic blocks in FIGS. 4-5 represent the execution of software components on DSS processing device 110 shown in FIGS. 3 and 6.

Method 300 begins by acquiring and reviewing information from the FDA 101 as illustrated by logic block 301. In an embodiment, DSS processing device 110 and FADC 402 retrieves for a particular drug or medical device (one or more): Full Label, drug safety information (including FDA DHCPLs or sheets), MGs, REMS information and FDA Early Warnings from FDA 101 as illustrated by data 251 illustrated in FIG. 2. In an embodiment, FDA-approved Full Labels are acquired from drug manufacturer 112 as described below. In an embodiment, a portion of drug and medical safety information 405a, as described below and illustrated in FIG. 6, is acquired from FDA 101 and stored in a retrievable from database 405.

Logic block 301 illustrates acquiring further drug and medical device safety information, represented by data 252 in FIG. 3, for the selected drug or medical device from a manufacturer, such as Drug manufacturer 112. In an embodiment, Drug manufacturer labels (including FDA approved Full Labels in an embodiment) and alerts for the selected drug are acquired by processing device 110 and DDSaI 401. In an embodiment, a portion of drug and medical safety information 405a, as described below and illustrated in FIG. 6, is acquired from Drug manufacturer 112 and stored in a retrievable from database 405.

Logic block 302 also illustrates acquiring drug and medical device support information from drug and medical device manufacturers for each drug and medical device. In an embodiment, DDSuI 403 acquires drug and medical device support information from at least drug manufacturer 112. In an embodiment, drug and medical support information 405b, as described below and illustrated in FIG. 6, is acquired from manufacturers and stored in a retrievable from database 405.

Logic block 303 illustrates mapping data 251 and 252 to database 405. In an embodiment, FADC 402 and DDSaI 401 associates external and internal identifies for acquired drug and medical device safety information in database 405. In an embodiment, external identifiers are medical industry standard terminology for particular drugs. In an embodiment, there may be multiple external identifiers from multiple sources.

Logic block 304 illustrates generating further drug and medical device safety information. In an embodiment, logic block 304 illustrates generating Concise monographs and summaries for one or more of the of the drug and medical device safety information received in data 251 and 252. In an embodiment, DDSaI 401 generates a Concise drug or medical device label from a Full Label. In an embodiment, DDSaI 401 generates REM terms and notification summaries. In an embodiment, DDSaI 401 generates a CME for each drug and medical device.

Logic block 305 illustrates compiling acquired and generated drug and medical device safety information. In an embodiment, DDSaI 401 stores the acquired (data 251 and 252) and generated drug and safety information (generated drug and device information in logic block 304) into database 405. In an embodiment, the acquired and generated data, along with external identifiers, are mapped to an associated internal identifier for a particular drug or medical device.

Logic block 306 illustrates providing drug and medical device safety information for a selected drug or medical device by a healthcare provider at an associated healthcare website, such as an EHR web site. In an embodiment, drug and medical device support information for the selected drug or medical device may also be provided (both information is illustrated by data 253 shown in FIG. 3). In an embodiments, DDSaI 401 and DDSuI 403 provide the drug and medical device safety and support information from database 405. In an embodiment, data 253 (or portions thereof) is obtained by healthcare provider 106 from associated healthcare processing device 113 and then relayed to a patient 108. For example, a recently released drug warning or financial assistance plan for using an alternate drug may be provided to patient 108 from a healthcare provider 106 that has selected an indication of the respective safety and support information.

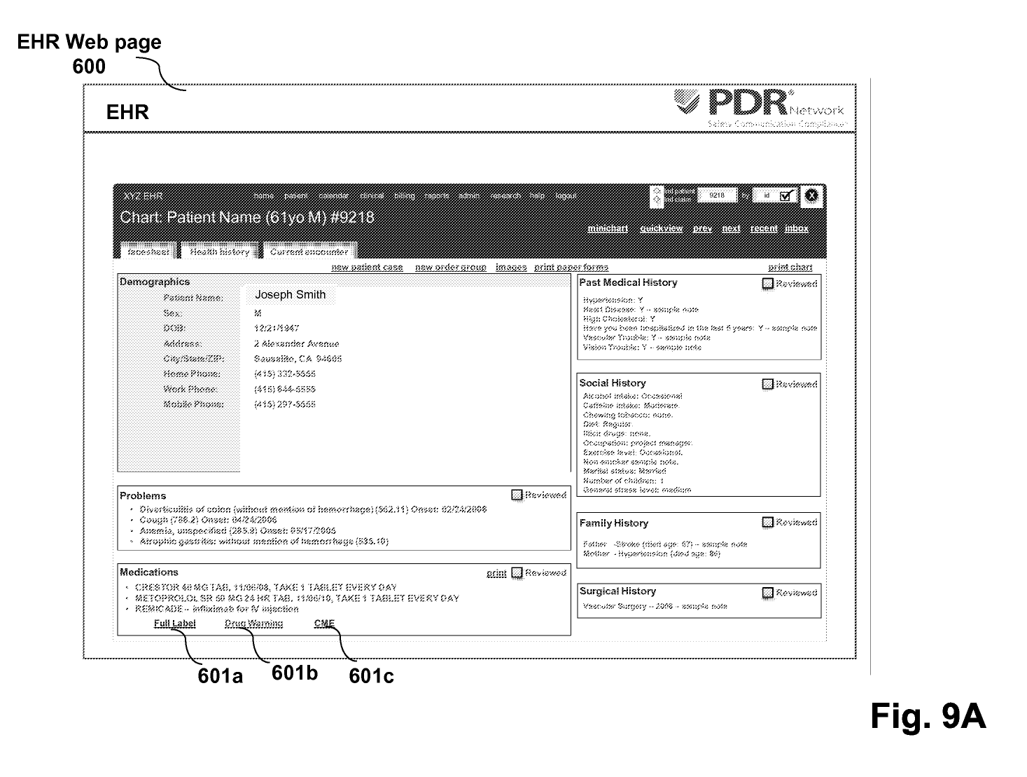

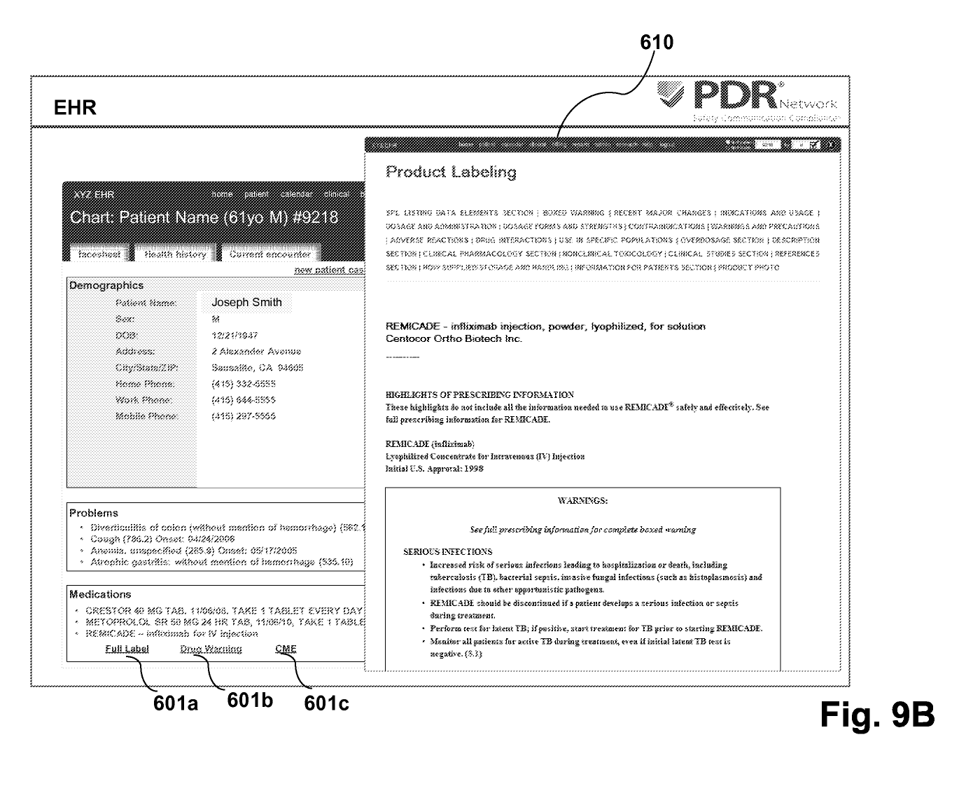

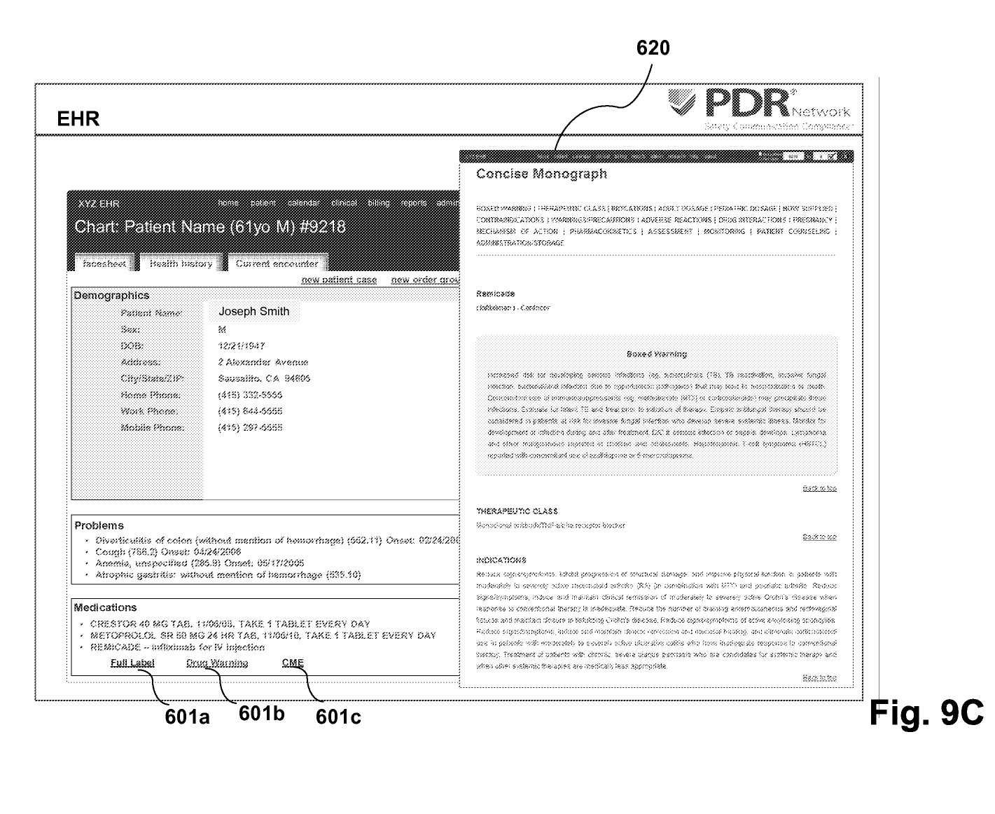

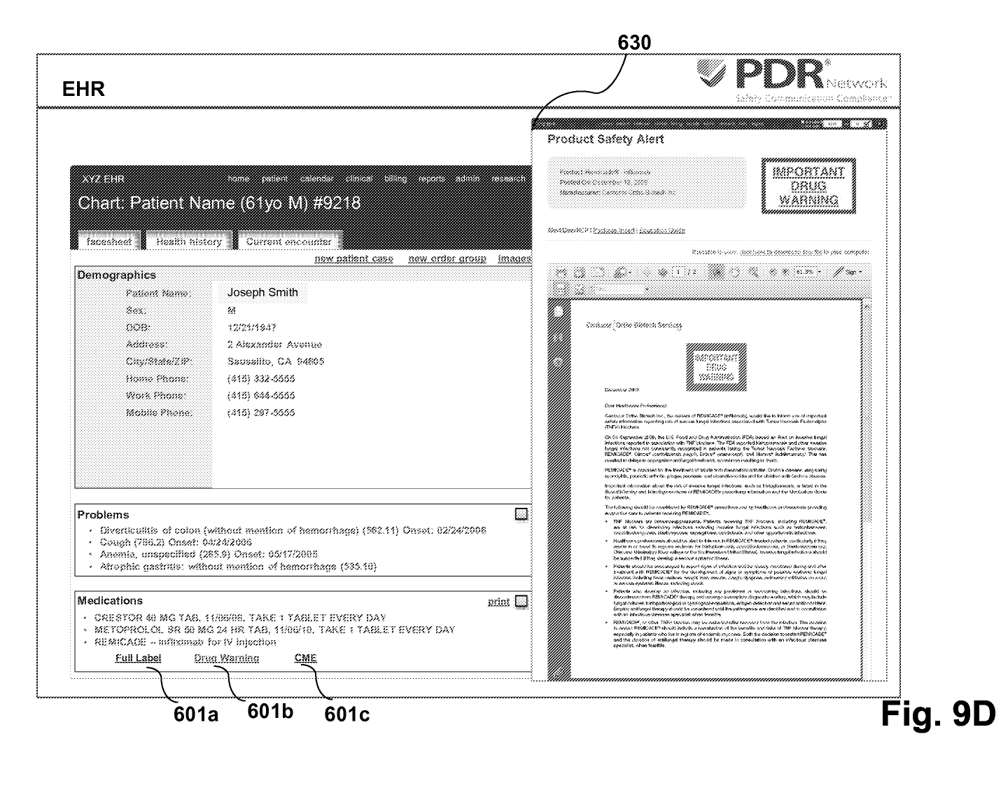

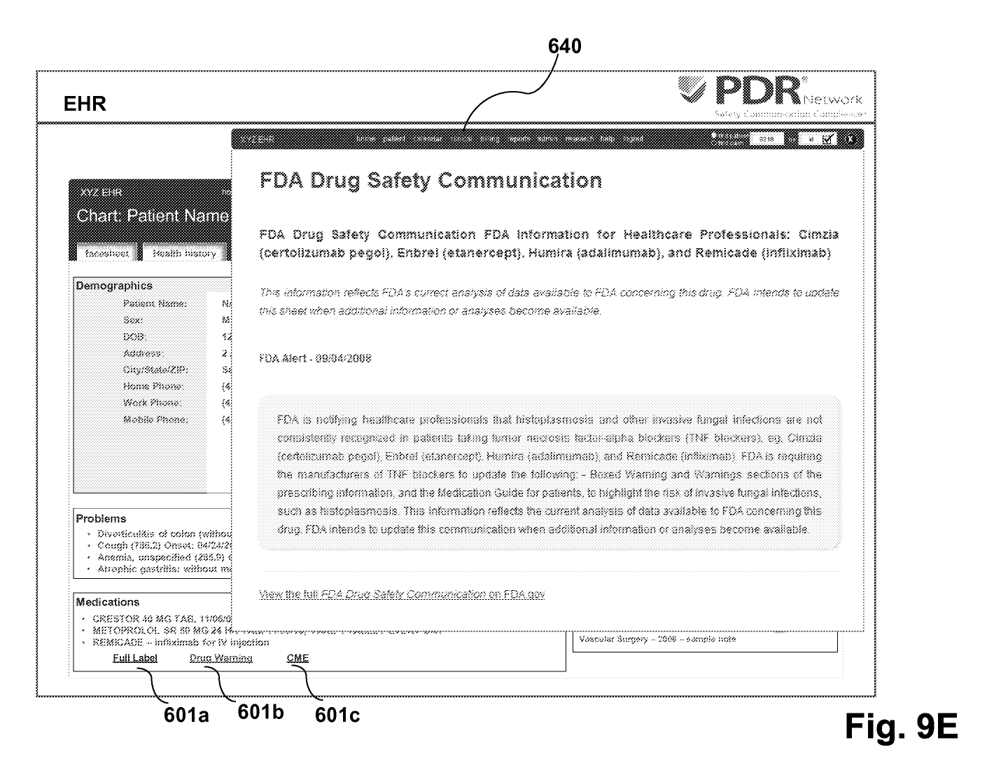

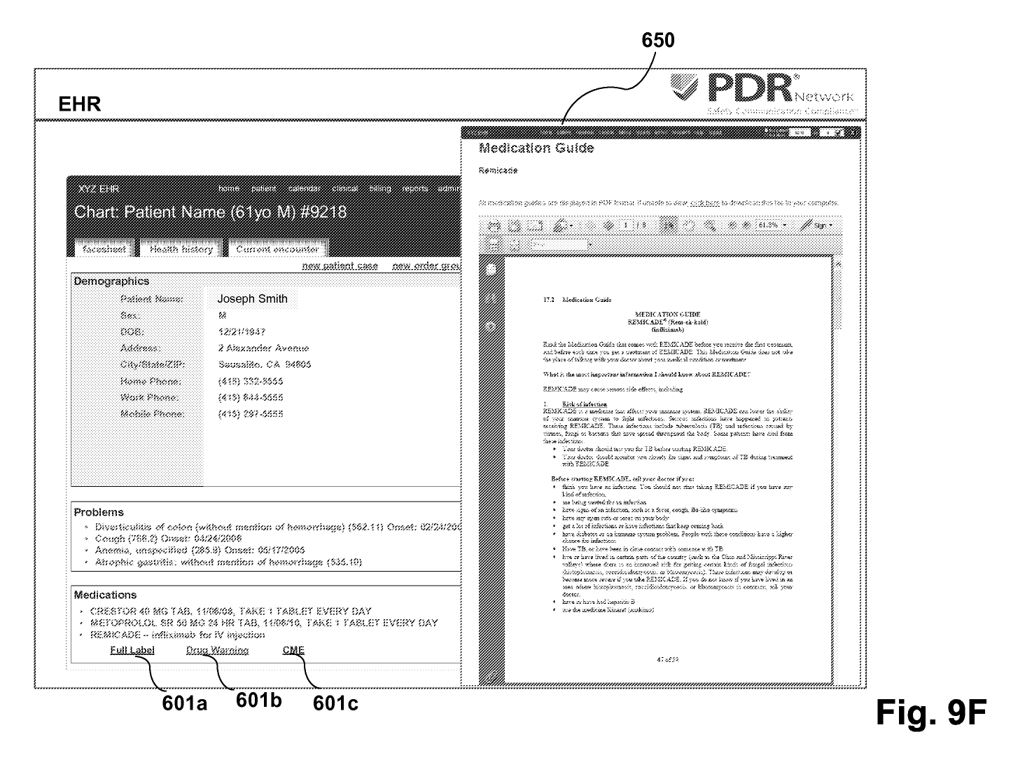

For example, FIG. 9A illustrates an exemplary web page 600 at an EHR web site that includes links 601a-c to drug safety information provided by drug safety and support processing device 110 and software 109. In an embodiment, a healthcare provider 106 is viewing an EHR chart or web page 600 of a patient “Joseph Smith” during a typical workflow. Web page 600 includes “facesheet” “health history” and “current encounter” tabs for Mr. Smith. Under the “facesheet” tab, Mr. Smith's “Demographics,” “Problems,” “Medications”, “Past Medial History,” “Social History,” “Family History” and “Surgical History” is provided. Under the “Medications” or drug section, the healthcare provider is notified that Mr. Smith uses a “REMICADE” drug, among other medications. Under the “REMICADE” drug, “Full Label,” “Drug Warning” and “CME” hyperlinks 601a-c are provide for a healthcare provider 106 to select or click on in order to obtain the associated drug safety information for REMICADE. Similarly, drug and device support information may be provided to healthcare provider 106 by way of similar hyperlinks.

For example, FIG. 9B illustrates a web page 610 that shows the Full Label (Product Labeling) for REMICADE when a healthcare provider or user clicks on the hyperlink “Full Label” 601.

FIGS. 9C-F illustrate web pages 620-650 that illustrate a corresponding Concise, Alert (Product Safety Alert), FDA Drug Safety Communication, and MG that may be similar accessed by way of corresponding hyperlinks.

Logic block 307 illustrate providing adverse reporting tools to report an adverse event during or after the use of a prescribed drug or medical device. In an embodiment, AER 404 provides the adverse reporting tool at an associated healthcare website (or associated healthcare processing device 113) during the workflow of a healthcare provider.

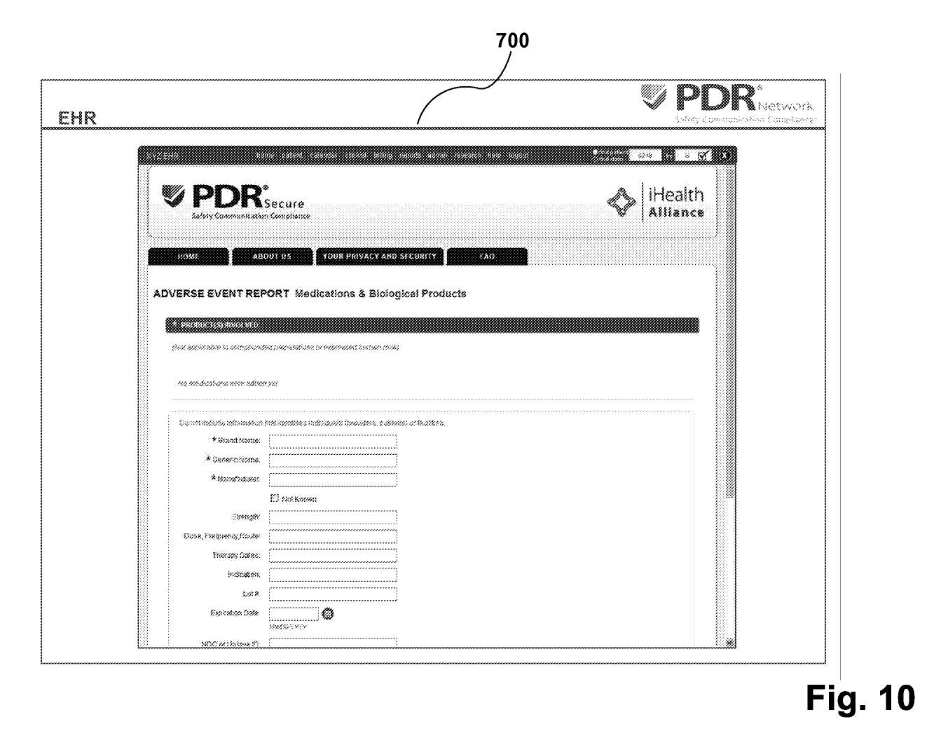

Logic block 308 illustrates acquiring an adverse event that may be reported by healthcare provider 106 (by way of associated healthcare processing device 113) based on observations of patient 108. Data 254 as shown in FIG. 3 illustrate how adverse event information is provided to DSS processing device 110, and in particular to AER 404. In an embodiment, FIG. 10 illustrates a web page 700 that illustrates providing an adverse event reporting form to be filled out by a healthcare provider during a workflow in an embodiment.

Logic block 309 illustrates acquiring and aggregating a plurality of adverse events reported from plurality of healthcare providers. In an embodiment, an Adverse Event report for a particular drug or medical device is provided in an industry standard format. In an embodiment, AER 404 in DSS processing device 110 generates the Adverse Event report.

Logic block 310 illustrates electronically transferring the Adverse Event report (illustrated as data 255 in FIG. 3) to the FDA 101, Drug manufacturer 112 (as well as medical device manufacturers) and Malpractice Insurance carriers 103. In an embodiment, an Adverse Event report is provided to third party patient safety organizations.

In response to the Adverse Event report, the various entities may provide further information or data to DSS processing device 110 and other entities.

For example, logic block 311 illustrates the FDA 101 electronically transferring updated drug (and medical device) safety communications, FDA early warnings and/or REMS for a drug or medical device that was subject to the Adverse Event report. Data 256 illustrated in FIG. 3 represents the updated drug and medical device safety information that is electronically transferred to DSS processing device 110, Drug manufacturer 112 as well as patient (or consumers) 108.

Logic block 312 illustrates a drug (or medical device) manufacturer 112 transferring updated safety information to DSS processing device 110 in response to the Adverse Event report. The updated safety information may include new alerts and/or recalls for the drug or medical device that was subject to the Adverse Event report. Data 257 illustrated in FIG. 3. represents the updated drug and medical device safety information electronically transferred to DSS processing device 110 from manufacturer 112.

Logic block 313 illustrates a malpractice insurance carrier 103 electronically transferring updated safety information to DSS processing device 110 in response to the Adverse Event report. The updated safety information may include new clinical education programs and CMEs for the drug or medical device that was subject to the Adverse Event report. Data 258 illustrated in FIG. 3. represents the updated drug and medical device safety information electronically transferred to DSS processing device 110 from malpractice insurance carrier 103.

Logic block 314 illustrates DSS processing device 110 electronically transferring updated safety information to healthcare provider 106 (via associated healthcare processing device 113) in response to the Adverse Event report. The updated safety information may include education and training for the drug or medical device that was subject to the Adverse Event report. Data 253 (or portion thereof) illustrated in FIG. 3. represents the updated drug and medical device safety information transferred to healthcare provider 106.

### III. Software Architecture

FIG. 6 illustrate a software architecture or software components of DSS software 109 that may be executed on DSS processing device 110, shown in FIGS. 1 and 2-4, to provide drug and medical device safety and support information. In embodiments, one or more software components illustrated in FIG. 6 are at least partially stored and/or at least partially executed by DSS processing device 110. In an embodiment, DSS software 109 includes machine/computer readable or executable instructions.

In an embodiment, DSS software 109 is stored in storage device or an article of manufacture, such as a computer readable medium that may be removable from or included in a processing device. For example, DSS software 109 may be stored in a magnetic hard disk, an optical disk, a floppy disk, Compact Disk Read-Only Memory (“CD-ROM”) as illustrated in FIG. 1, Random Access Memory (“RAM”), Read-Only Memory (“ROM”), Electrically Erasable Programmable Read-Only Memory (“EEPROM”) or other readable or writeable data storage technologies, singly or in combination. In alternate embodiments, DSS software 109 may be transferred by an electronic signal or downloaded by way of the Internet using wired and/or wireless connections.

In embodiments, FIG. 6 illustrates software components that may include a software program, software object, software function, software subroutine, software method, software instance or a code fragment, singly or in combination. In embodiments, software components illustrated in FIG. 6 have functions described in detail below.

A. Drug and Device Safety Information (“DDSaI”) 401

DDSaI 401 is responsible for, at least, acquiring drug and medical device safety information from at least one source. In an embodiment, drug and medical device safety information is obtained from multiple sources, such as the FDA as well as Drug and Medical device manufacturers. In an embodiment, drug and medical device safety information is obtained from FDA processing device 102 and/or Drug manufacturing processing device 111. For example, DDSaI 401 acquires, at least one of, Alerts or issues notification regarding the safety of a drug or medical device, Drug safety communications (such as FDA DHCPLs sheets or Box Warnings), MGs, REMS information (including REMS terms Summary and REMS Notification Summary), and FDA Early Warnings.

In an embodiment, DDSaI 401 generates summaries in an XML or other electronic form.

In an embodiment, one or more of the above types of drug and medical device safety information is then mapped to database 405 for each drug and/or medical device as drug and medical safety information 405a. For each drug and medical device, an external identifier (“Ext Id”) associated with industry standard nomenclature and internal identifier (“Int Id”) is assigned or associated with each drug and medical device. One or more of the identifiers is then used to provide one or more of the different types of drug and medical safety information to a healthcare provider during a workflow at an EHR website. In an embodiment, a healthcare provider selects on a hyperlink to access one or more of the different types of drug and medical safety information.

B. FDA-Approved Drug (and Medical Device) Content (“FADC”) 402

FADC 402 is responsible for, at least, acquiring FDA-approved Full Labels for drugs and medical device, from at least one source. In an embodiment, FDA-approved Full Labels is obtained from multiple sources, such as the FDA as well as Drug and Medical device manufacturers. In an embodiment, an FDA-Approved Full Label for drug and medical device is then mapped to database 405 for each drug and/or medical device.

In an embodiment, FADC 402 generates summaries of a FDA-Approved Full Label or a Concise.

In an embodiment, a FDA-approved Full Label and/or Concise is then mapped to database 405 for each drug and/or medical device as drug and medical safety information 405a.

A CME for each FDA-approved Full Label and/or Alert is provided by FADC 402 in an embodiment. Each CME then may be mapped to database 405. In an embodiment, a corresponding CME is associated with each FDA-approved Full Label and/or alert.

In an embodiment, FADC 402 then provides a FDA-approved Full Label and/or Concise for a selected drug or medical device by a healthcare provider during a workflow at an EHR website as similarly described above.

C. Drug and Device Support Information (“DDSuI”) 403

DDSuI 403 is responsible for, at least, acquiring various drug and medical device support information from at least one source. In embodiments, the drug and device support information is acquired from at least drug and medical device manufacturers. In an embodiment, drug and medical device support information for each drug, medical device and/or manufacturer includes at least one of: 1) available samples or alternate drugs samples; 2) available patient financial assistance; 3) patient education; 4) adverse event information; 5) clinical reference; 6) ask the expert; 7) physician communications/education; 8) patient communications/education; 9) registries; 10) clinical trials that are available; and 11) patient medication adherence programs.

In an embodiment, drug and medical device support information is then mapped to database 405 for each drug, medical device and/or manufacturer as drug and medical support information 405b.

In an embodiment, DDSuI 403 then provides drug and medical device support information for a selected drug or medical device by a healthcare provider during a workflow at an EHR website as similarly described above.

D. Adverse Event Reporting (“AER”) 404

AER 404 provides a service/tool to a healthcare provider to report (and review previously reported) adverse events associated with a selected drug or medical device. In an embodiment, AER 404 provides this service to Associated Healthcare websites, such as Associated Healthcare website 114, for a healthcare provider 106 to report/review adverse events during a workflow.

In an embodiment, AER 404 acquires and aggregates a plurality of adverse events from multiple healthcare providers and compiles an Adverse Event report in an industry standard format. For example, the number of times a particular type of adverse event occurred for a particular drug during a particular time period may be aggregated. In embodiments, the Adverse Event report is electronically transferred to one or more of manufacturers, malpractice insurance carriers, and governmental agencies, such as the FDA and AHRQ. In embodiments, drug and medical device safety information for a particular drug or manufacturer may be updated or corrected based on an Adverse Event report.

In an embodiment, AER 404 provides a form, such as web page 700, to a healthcare provider in a workflow so that adverse event information may be submitted. In an embodiment, AER 404 crawls or searches Full Labels to create web page 700 that will inform the healthcare provider of current known adverse reactions/information to a particular drug or medical device. Thus, the healthcare provider will not waste valuable time in submitting adverse event information that is already known or spend time submitting a “false report.” For example, when a healthcare provider enters a particular “brand name” or “generic name,” AER 404 may provide the healthcare provider (by way of another web page or pull down menu) with known adverse event information, such as known adverse reactions with other drugs. The healthcare provider would therefore increase their knowledge of use of the a particular drug as well as save time in not filling out the rest of an adverse report form that would not reflect any new adverse event information.

E. Safety and Support Information Database (“Database”) 405

Safety and Support Information database 405 stores a plurality of different types of drug and medical device safety information 405a including FDA-approved Full Label or Concise labels for each drug and medical device. Similarly, drug and medical device support information for each drug, medical device and manufacturer is likewise stored in Safety and Support Information database 405 as drug and medical device support information 405b. In an embodiment, DDSaI 401, FADC 402 and DDSuI 403 stores and retrieves information associated with particular external and internal identifiers.

In an embodiment, multiple external identifiers corresponding to different terminology or nomenclature used by different organizations are assigned to each drug and medical device. In an embodiment, each drug and medical device is organized in a data structure or content bundle that includes the various external and internal identifiers as well as links to the plurality of different types of drug and medical device safety information 405a (for example, “Full Label”, “Concise,” “Alert”, . . . ) In an embodiment, drug and medical support information 405b is similarly stored in a data structure or content bundle that includes links to the various drug and medical support information 405a. In an embodiment, the content bundle includes respective fields to store a link (represented as “linkx, . . . ” in FIG. 6) that identifiers where the corresponding information 405a-b is located.

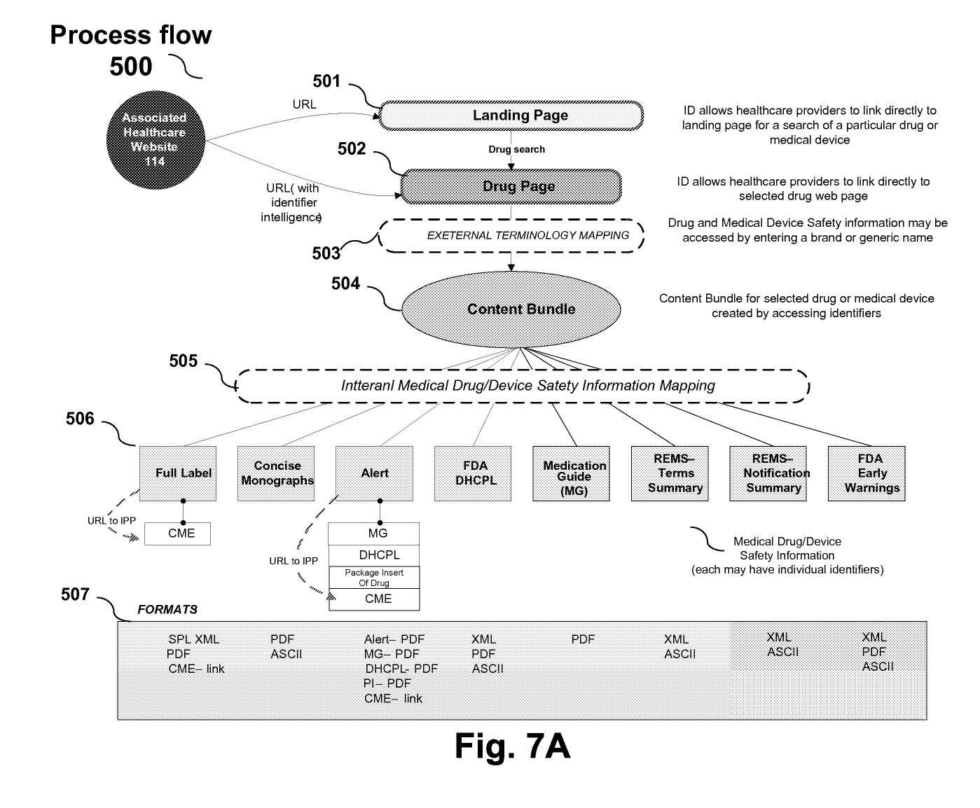

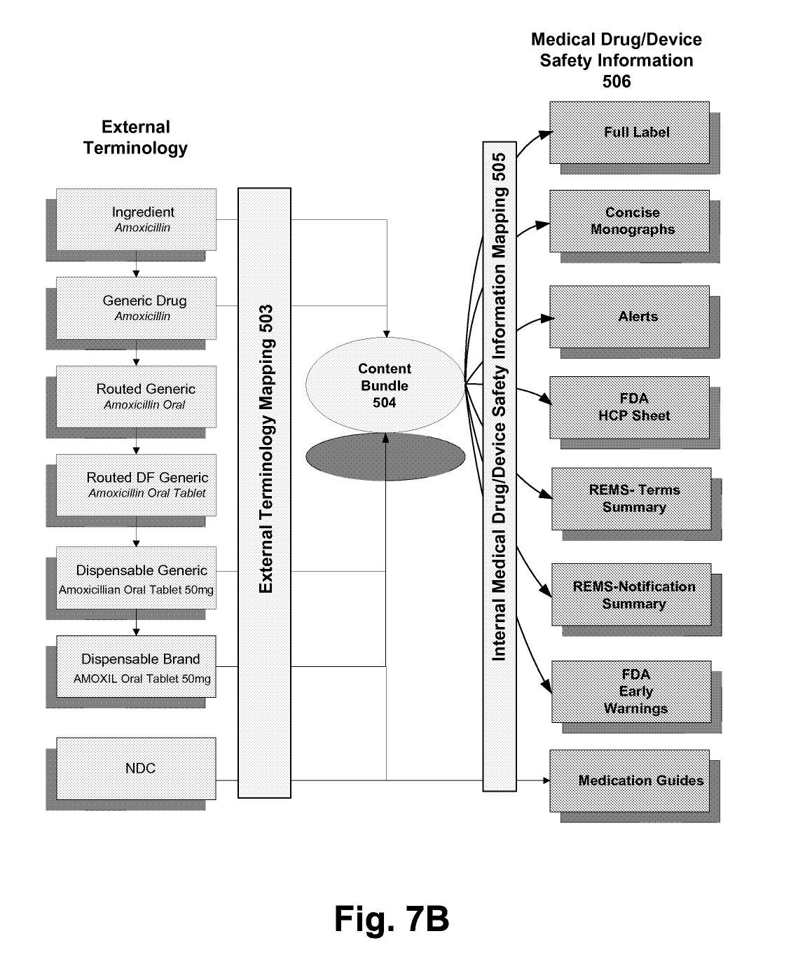

FIG. 7A illustrates a process flow 500 of DSS software 109 according to embodiments. In an embodiment, FIG. 7A illustrates a process flow of DDSaI 401. A healthcare provider 106 may access a landing page 501 from an associated healthcare website 114 when the appropriate URL is used at the associated healthcare website 114. The landing page 501 is a web page that allows for the search of a particular drug and/or medical device. After a query regarding a particular drug and/or medical device is entered at landing page 501, a drug/medical device search provides a drug/medical device page 502 associated with the queried drug/medical device. Drug/medical device page 502 provides the plurality of different types of drug and/or medical device safety information 506. Alternatively, the drug page 502 may be accessed directly from associated healthcare website 114 by way of URL (with identifier intelligence).

In an embodiment, one or more of the plurality of different types of drug and/or medical device safety information 506 for the queried or selected drug or medical device is provided to healthcare provider 106 using a content bundle 504 and DDSaI 401. For example, a “Concise Monograph” for the selected or queried drug “Remicade” may be provided as shown in FIG. 9C by web page 620. In an embodiment, content bundle 504 is a data structure as illustrated by database 405 of FIG. 6. Content bundle 504 includes external identifiers and internal identifiers to link the plurality of different types of drug and/or medical device safety information 506 to a particular drug or medical device.

In an embodiment, the plurality of different types of drug and/or medical device safety information 506 are stored in different types of formats as illustrated by format chart 507. For example, the “Medication Guide” is stored in a PDF format.

In an embodiment, an external terminology/identifier mapping process 503 and internal identifier mapping process or method 505 is performed by DDSaI 401 to create a content bundle 504 for each drug and medical device.

FIG. 7B illustrates how different external terminology or identifiers used by different organizations are mapped or associated with a content bundle 504 for a particular drug. For example, an active “Ingredient” such as “Amoxicillin” is mapped or stored in content bundle 504. Similarly, a “Generic Drug” name, such as “Amoxicillin” is mapped. As illustrated in FIG. 7B, “Routed Generic,” Routed DF Generic,” “Dispensable Generic,” “Dispensable Brand” and “National Drug Code” (“NDC”) Directory names are likewise mapped.

For each external identifier, mapping 505 associates one or more of the plurality of different types of drug and/or medical device safety information 506 in content bundle 504. In an embodiment, mapping 505 stores in a designated field of content bundle 504 a link to the corresponding drug and/or medical safety information 506.

While FIG. 7B illustrates mapping one set of external identifiers for a drug used by one particular organization, such as the NDC directory, other different sets of terminology used by different organizations for the same drug are also mapped to content bundle 504 by mapping 503 in an embodiment.

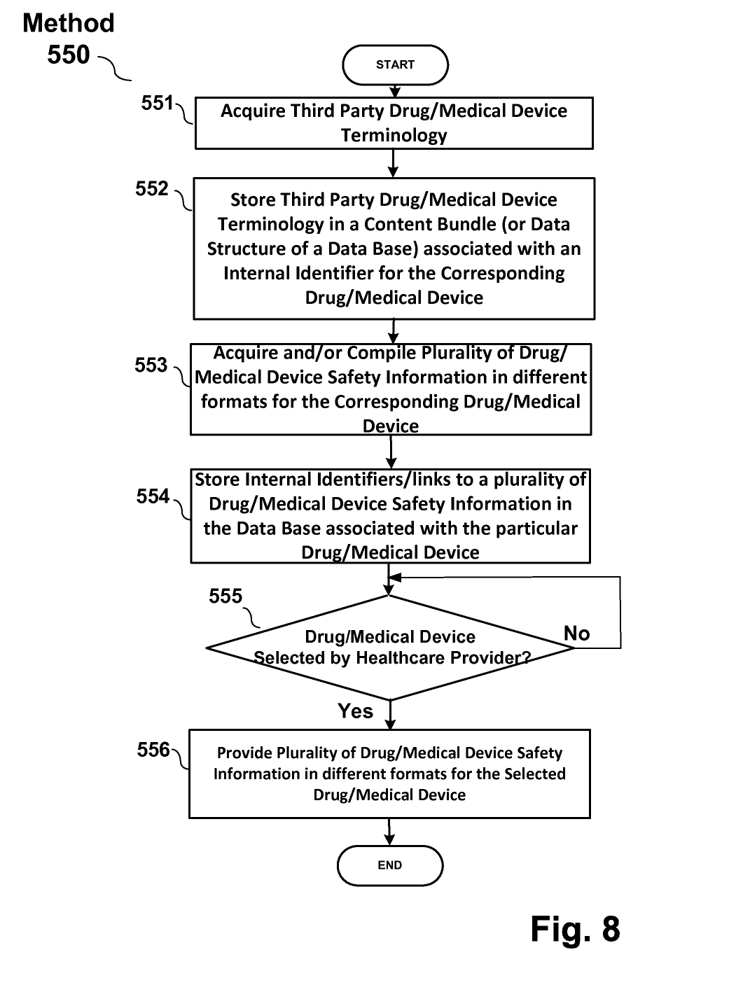

FIG. 8 illustrates a method 550 to provide one or more of the plurality of different types of drug and/or medical device safety information 506 to a healthcare provider 106. In an embodiment, method 500 is performed by DSS processing device 110 and DSS software 109. In an embodiment, method 550 corresponds at least in part to logic blocks 301-306 illustrated in FIG. 4. Logic block 551 begins by acquiring third party or external identifiers/terminology for particular drugs and/or medical devices. In an embodiment, multiple external identifiers are obtained from multiple sources by DDSaI 401.

In an embodiment, the external identifiers are stored in a content bundle 504 for a each drug and/or medical device as illustrated by logic block 552.

Logic block 553 illustrates acquiring and compiling the plurality of different types of drug and/or medical device safety information 506 stored in different types of formats in an embodiment. In embodiments, FADC 402 and DDSaI 401 acquires some of the drug and/or medical device safety information 506 from FDA processing device 102 and Drug Manufacturer processing device 111. Other drug and/or medical device safety information 506 is generated or summarized in embodiments.

Logic block 554 illustrates storing internal identifiers in a content bundle 504 for each drug/medical device that points to or links the plurality of different types of drug and/or medical device safety information 506 for that content bundle.

In an embodiment, logic block 555 illustrates a healthcare provider 106 selecting one or more of the plurality of different types of drug and/or medical device safety information 506a for a selected drug/medical device. In an embodiment, DSS software 109, and in particular DDSaI 401, uses external identifiers (in the case of query) or hyperlinks (in the case of a selection at a EHR website) to associate a selected drug/medical device with its respective content bundle.

Once a content bundle is identified DDSaI 401 accesses the requested different types of drug and/or medical device safety information 506a and provides them to healthcare provider 106 as illustrated by logic block 556.

Accordingly, one or more of a plurality of different types of drug and/or medical device safety information 506 may be provided to a healthcare provider during a workflow at an associated healthcare website 114.

### IV. Unexpected Results

One of ordinary skill in the art would appreciate the numerous unexpected results for at least healthcare providers, manufacturers, patient and/or the FDA provided by various embodiments.

A. Healthcare Providers

1. Healthcare providers, or prescribers, may have reduced liability and malpractice insurance premiums provided by malpractice insurance carriers because of the reduction in risks associated with accessing current, accurate and complete drug and medical device safety information. Reduced insurance premiums may then lead to decreased patient costs.

2. Healthcare providers, or prescribers, may have reduced liability and malpractice insurance premiums provided by malpractice insurance carriers because the healthcare provider will be able to provide the patient with the most current, accurate and complete drug and medical device safety information. Thus, the informed patient will be less likely to pursue a legal claim if a discussed potential adverse event occurs to the patient after taking the drug or medical device.

3. Prescribers may be compensated by drug manufacturers for the time required to report adverse events. Thus, more current, accurate and complete drug and medical device information may be timely reported due to the increased and incentivized reporting of adverse events.

4. Healthcare providers are able to report the most current adverse events because of access to the most current, accurate and complete drug and medical device safety information. If similar adverse events have been reported by other healthcare providers and thus caused an update of safety information, the healthcare provider does not have to repeat the reporting of adverse events that have already been acted upon. By not having to report duplicate adverse events, the healthcare provider is able to reduce the time and cost associated with reporting adverse events.

5. Healthcare providers receive direct and immediate feedback if the adverse event they are reporting is already in the product label. Therefore, the healthcare provider may address the issue with the patient thereby providing better care, decrease potential for time loss and further issues with the patient and increase patient safety and decrease liability. Also, direct and immediate feedback in reporting an adverse event reduces the occurrence of false adverse event reports.

6. Healthcare providers costs are reduced while healthcare provider's knowledge of risks associated with particular drugs and medical devices are increased. Complementary CMEs associated with particular drugs or medical devices further reduces healthcare provider costs.

7. The use of CMEs ensure understanding of the most current information, and facilitates completion of required CME courses to maintain license and MOC.

8. Healthcare providers have increased efficacy and efficiency in the analysis and resolution of safety issues, which reduces the time and costs associated with adverse event reporting for healthcare providers.

9. Healthcare providers are able to increase their efficiency and improve patient safety by reducing the amount of time required for researching safety information and significantly improving access to information associated with drugs or medical devices as well as other information such as patient financial assistance and drug education material, thereby facilitating access to a drug important to patient treatment that otherwise would potentially be compromised, therefore decreasing liability.

B. Drug and Medical Device Manufacturers

1. Drug and medical device manufacturers may sell more products by providing more current, accurate and complete drug and medical device information in a healthcare provider workflow.

2. Drug and medical device manufacturers may be able to reduce costs in reporting adverse events as well as increase efficacy and efficiency in the analysis and resolution of safety events that may ultimately improve patient safety.

3. Drug and medical device manufacturers may have greater access to patient's use of particular drugs or medical devices by way of their healthcare provider in order to accurately and timely fulfill FDA requirements for patient follow-up, surveys, etc. associated with REMS and other related risk programs.

4. Drug and medical device manufacturers may directly fulfill FDA requirements for distribution of medication guides to patients on associated drugs, and thereby reduce the potential for patient safety issues, through the immediate electronic delivery of those MGs via the EHR website to the patient as a result of electronically prescribing the drug.

C. Patients

1. Patients may have improved awareness of important drug and device services and options, in-workflow with their healthcare provider during an office visit, and drive better and more timely decisions regarding the use of drugs and medical devices through the delivery of patient-needed information through the EHR website to the healthcare provider and on to the patient, resulting in improved patient safety through improved efficacy of decision making.

2. Patients increase safety and reduce risk through timely electronic delivery of newly reported safety issues with drugs and medical devices through the EHR websites to patients whose records indicate they are taking/using the particular drug or device.

D. FDA

1. FDA has time-sensitive delivery of all FDA-required drug and device alert information to healthcare providers and their patients.

2. FDA receives in real time more comprehensive and timely Adverse Event reports.

### V. Website System

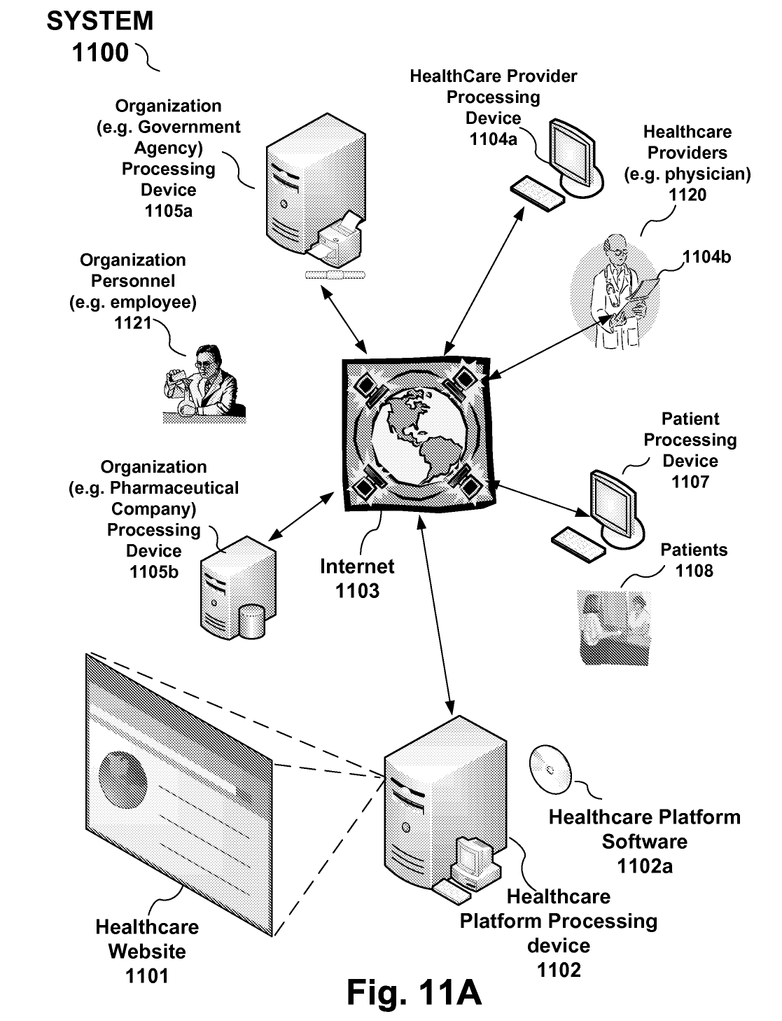

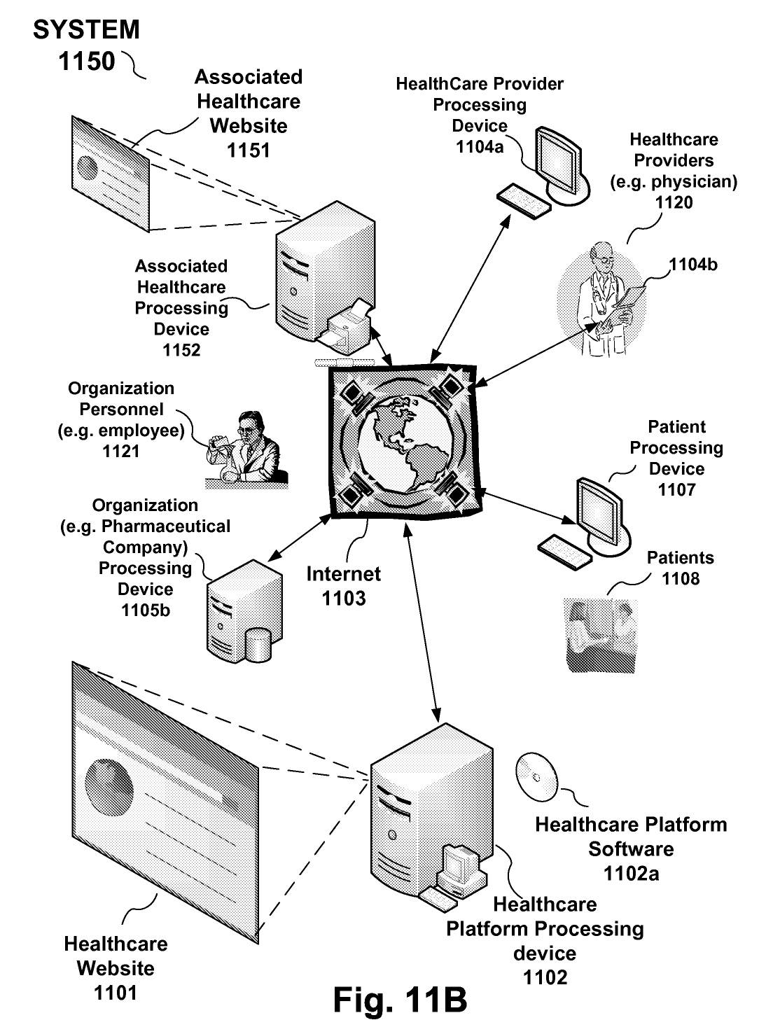

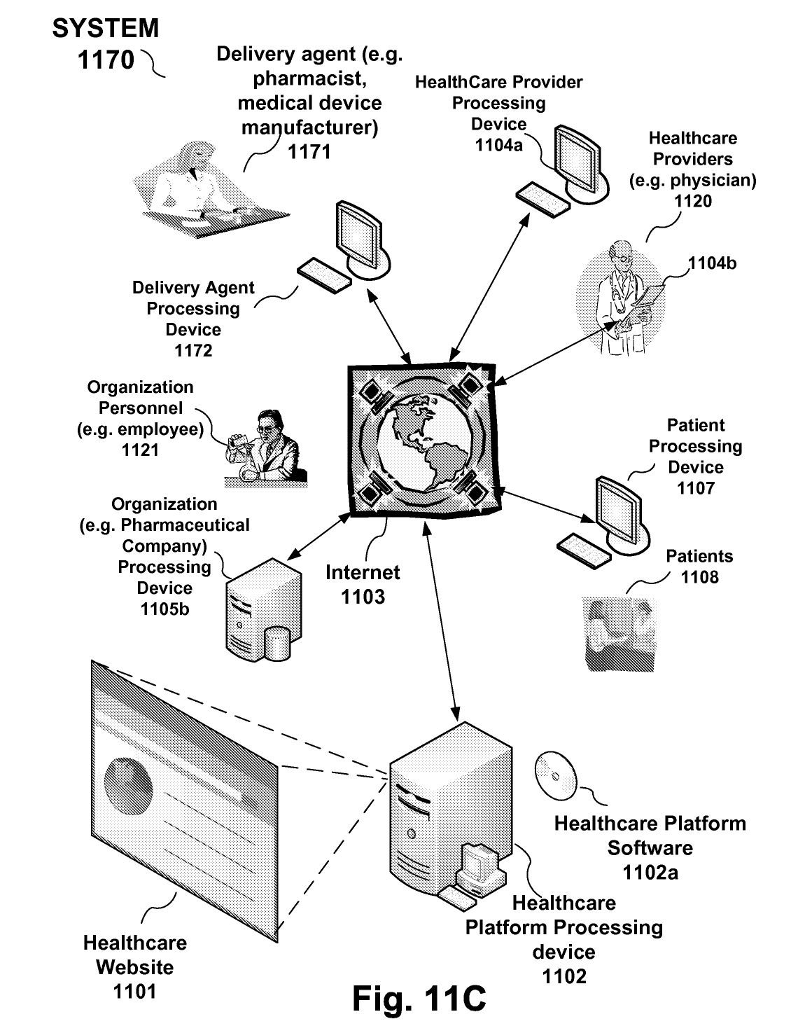

FIG. 11A illustrates a system 1100 that provides time critical healthcare related information, along with other healthcare related services, in an efficient and timely manner to one or more selected healthcare providers 1120. System 1100 provides healthcare related electronic notifications from organizations or organization personnel 1121 (via at least one organization processing device 1105a/1105b)) to selected healthcare providers 1120 (via at least one healthcare processing device 1104a-1104b) based on the subject matter of the notice. In an embodiment, system 1100 provides acknowledgement messages from a healthcare provider processing device that may include healthcare provider survey answers in response to receiving the healthcare related notification. Healthcare providers 1120 may also generate healthcare related notifications to selected patients 1108 (via at least patient processing device 1107) based on the subject matter of the notification. System 1100 includes a healthcare website 1101 to provide healthcare related notifications including other healthcare related services to healthcare providers 1120 and organization personnel 1121.

Healthcare website 1101 including healthcare related services are provided by healthcare platform processing device 1102 and associated healthcare platform software 1102a. In an embodiment, information is transferred similarly as described herein. Also, processing devices and websites illustrated in FIGS. 11A-C maybe similarly connected as described herein.

In an embodiment, an organization an organization as illustrated in FIGS. 11A-C may include a pharmaceutical company, medical device manufacturer, medical equipment manufacturer, government organization, or medical society.

Healthcare website 1101 (via healthcare platform processing device 1102 and software 1102a) provides a number of functions/services to content consumers, such as organizations, delivery agents and healthcare providers. In embodiments, healthcare website 1101 provides the following services to content consumers:

1) Register, create and maintain a content consumer account with pertinent and up-to-date contact/profile information;

2) Real-time electronic notifications to selected healthcare providers regarding healthcare issues with a backup paper based system;

3) Self-managed repository of notifications for future reference;

4) Reference website for access to healthcare information such as information related to product recalls and/or alerts, with robust search functionality;

5) Online provider of resources to obtain additional information on any product, ranging from informational brochures, videos, product samples;

6) Portal which allows access for healthcare providers to connect to other healthcare providers in order to report adverse events, communicate warnings securely to patients and join or initiate discussions with other healthcare providers;

7) Provide CME information including tests associated with healthcare notifications as well as award and store CME credits in response to healthcare providers completing the tests;

8) Provide healthcare notifications to related healthcare websites, such as ERX and EHR websites, based on whether the selected healthcare provider had received the healthcare notification;

9) Provide certifications for healthcare providers and/or patients as well as store such information for access by delivery agents, such as pharmacists and medical device manufacturers; and

10) Provide information to obtain a healthcare provider's MOC and store the status of requirements to obtain the healthcare provider's MOC, such as at least whether the required test to obtain a MOC has been passed by the healthcare provider.

In embodiments, healthcare website 1101 provides the following services to content providers, such as organizations:

1) Access to healthcare providers to disseminate critical healthcare notifications such as drug recalls or bioterrorism;

2) Tools to provide content, such as healthcare notifications, to selected healthcare providers; and

3) Access to reporting tools to monitor receipt of the healthcare notifications.

In an embodiment, healthcare platform processing device 1102 has associated individuals or an organization that is charged with governing, enabling, supporting and providing other operational activities to the healthcare website 1101.

FIG. 11B illustrates a system 1150 similar to system 1100 shown in FIG. 11A except that an associated processing device 1152 provides an associated healthcare website 1151. In an embodiment, associated healthcare website 1151 is an ERX and/or EHR website. Processing device 1152 executes machine readable instructions or software stored on a storage device to communicate with healthcare website 1101 as well as other processing device shown in FIG. 11B by way of Internet 1103 as described herein. In an embodiment, an ERX service or website provides healthcare providers 1120 with the function of providing prescriptions electronically. In an embodiment, an EHR service or website stores and provides electronic health or medical records of patients 1108 that may be accessed by healthcare providers 1120.

FIG. 11C illustrates a system 1170 similar to system 1150 shown in FIG. 11B except that a delivery agent processing device 1172 and delivery agent 1171, such as a pharmacist and/or medical device manufacturer replaces associated processing device 1152 and associate healthcare website 1151. In an embodiment, system 1150 and 1170, as well as other systems described herein may be combined singly or in combination in various embodiments. In an embodiment, healthcare provider(s) 1120 by way of healthcare provider processing device 1104a and Internet 1103 access healthcare website 1101 in order to obtain a certificate to prescribe a particular medication to a patient and/or use a particular medical device on a patient. As described in detail below, healthcare provider(s) 1120 obtains a certificate for a particular medication and/or medical device by passing a test provided by healthcare website 1101. The certificate is then stored in an electronic database of healthcare platform processing device 1102. Delivery agent 1171 may access the electronic database by way of delivery agent processing device 1172 and healthcare website 1101 in order to verify healthcare provider(s) 1120 is certified for a particular medication before filling a prescription for a patient(s) 1108 of healthcare provider(s) 1120 or shipping a medical device to be implanted or provided to patient(s) 1108 by healthcare provider 1120. In embodiments, a medical device may be any object used for medical purposes on a patient. A medical device may be implanted during surgery or used for diagnosis or therapy. For example, a medical device may be, but not limited to, a pacemaker, stent, catheter or ultrasound machine.

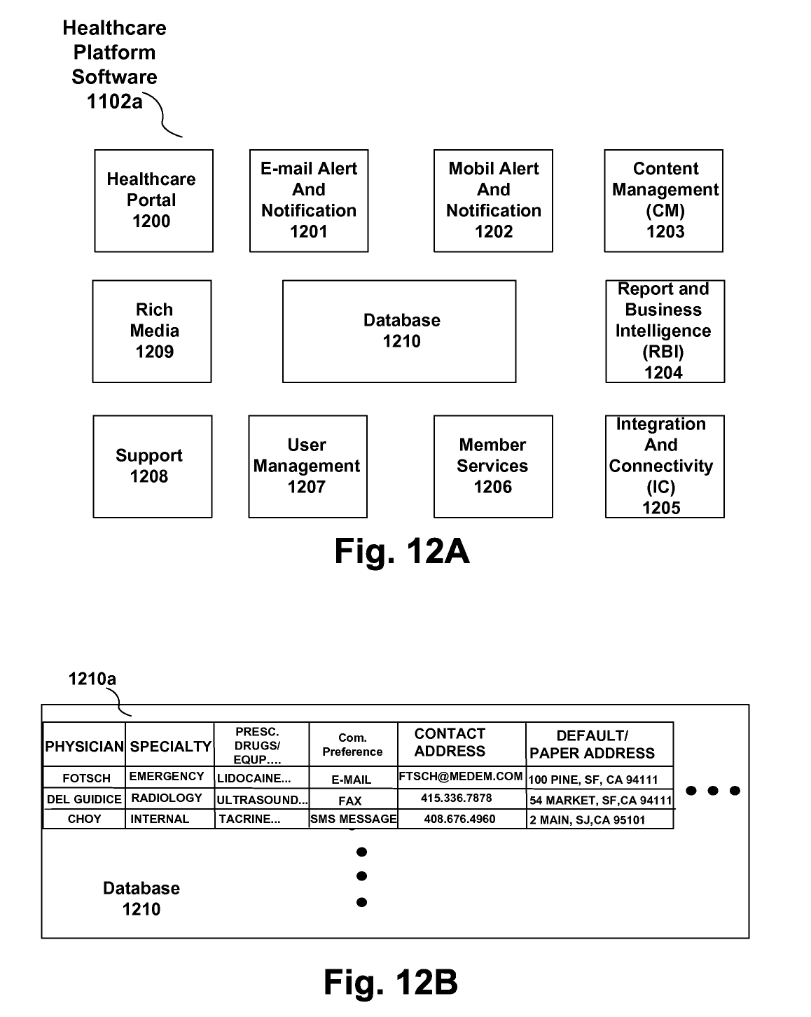

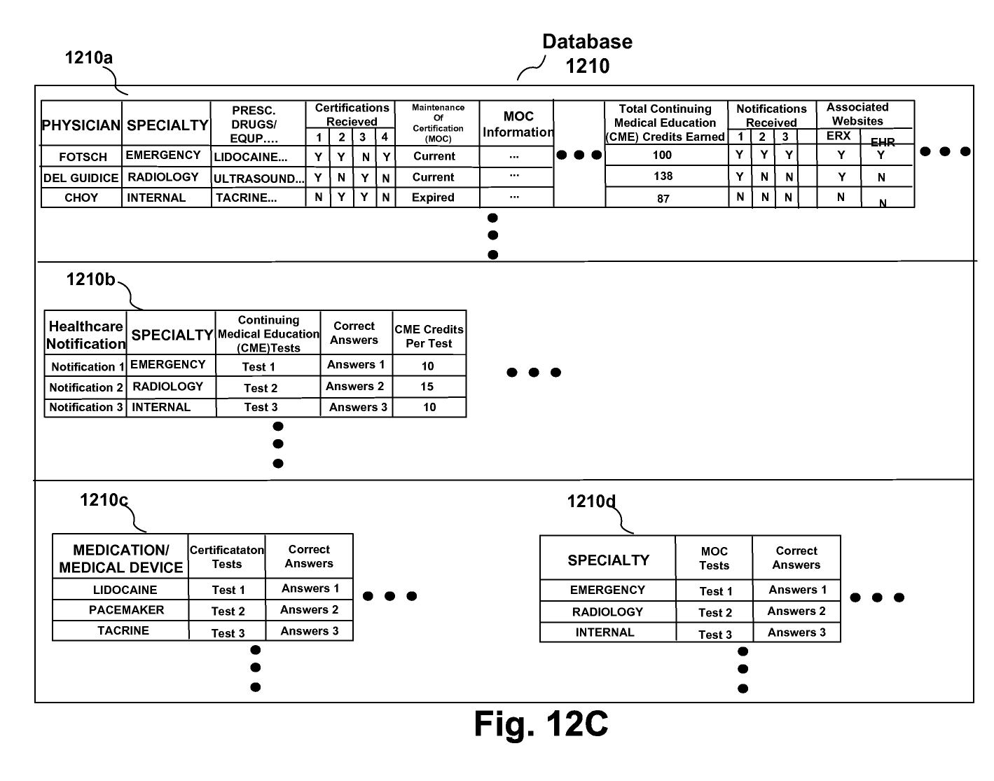

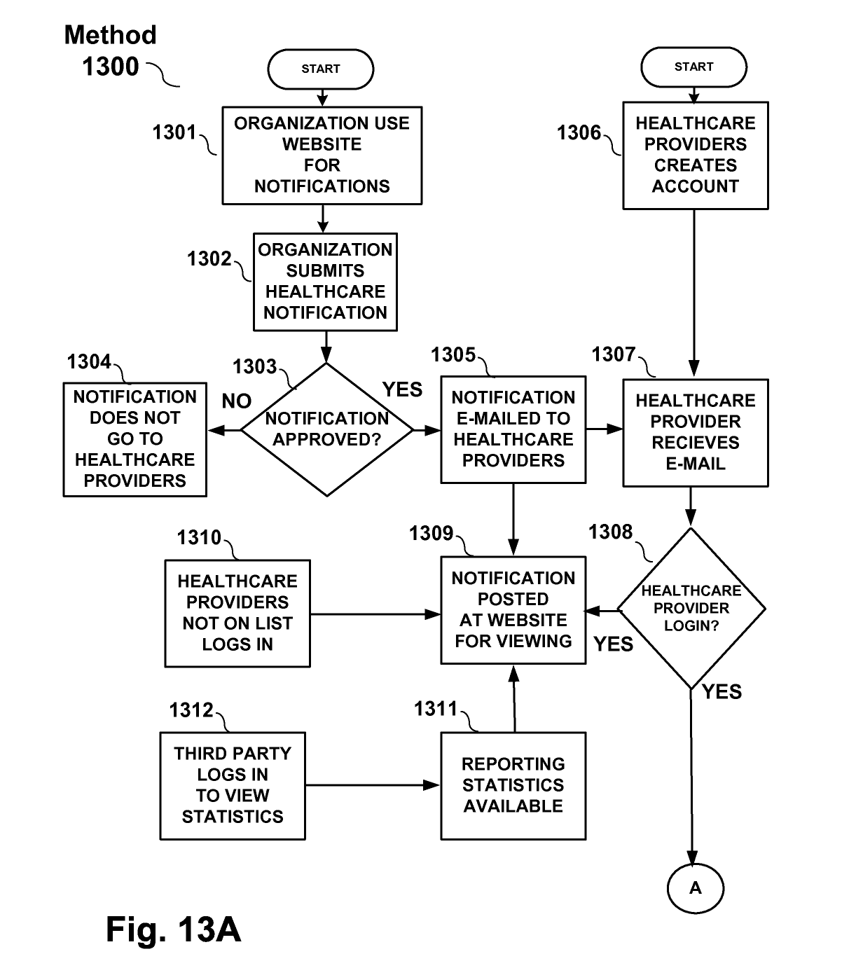

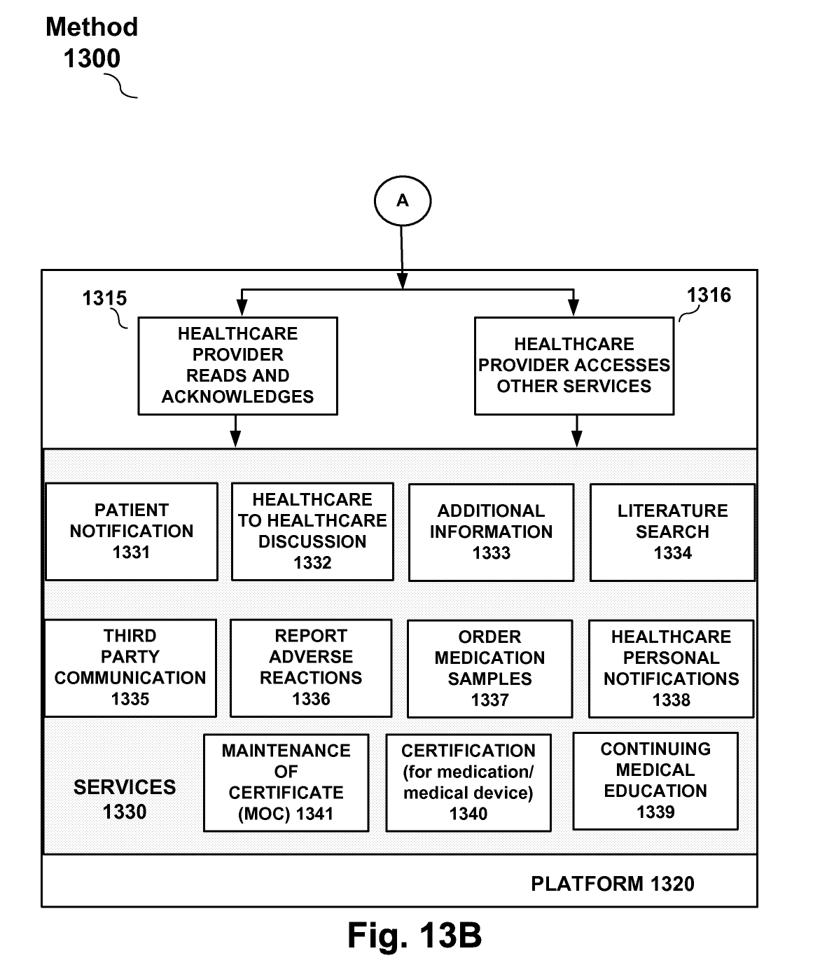

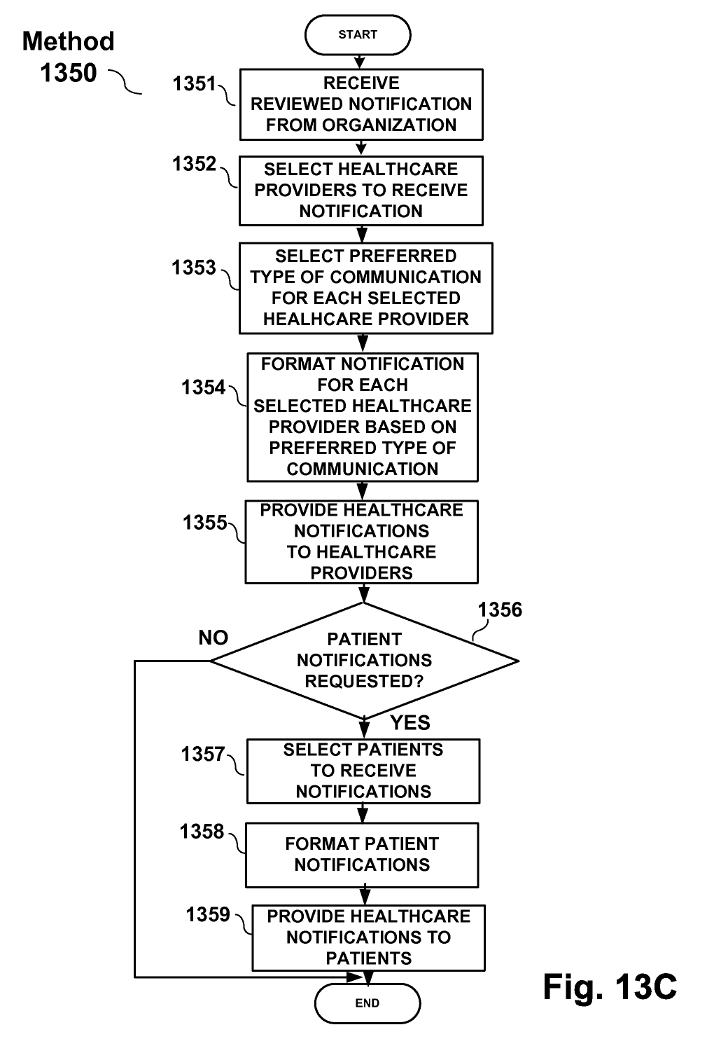

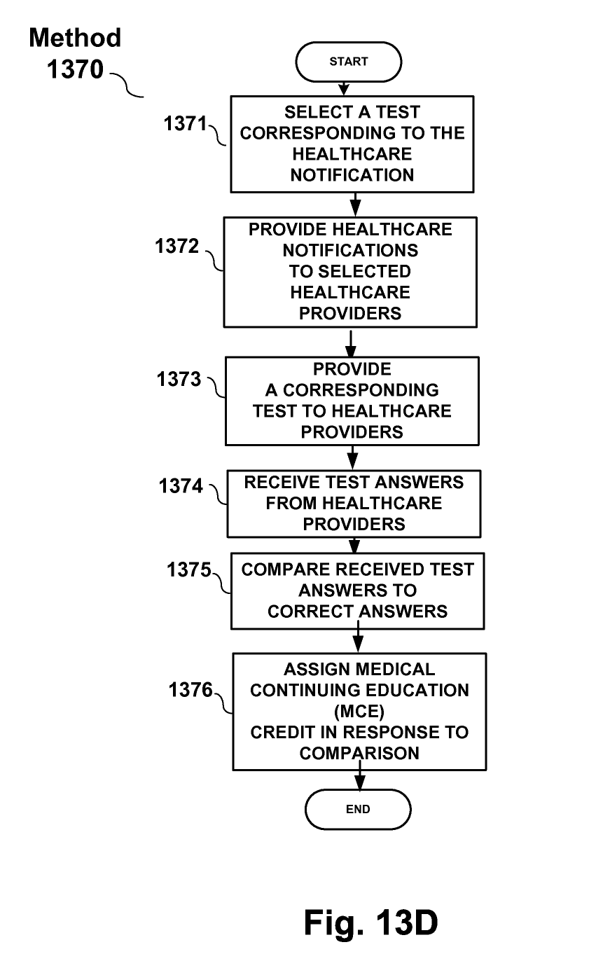

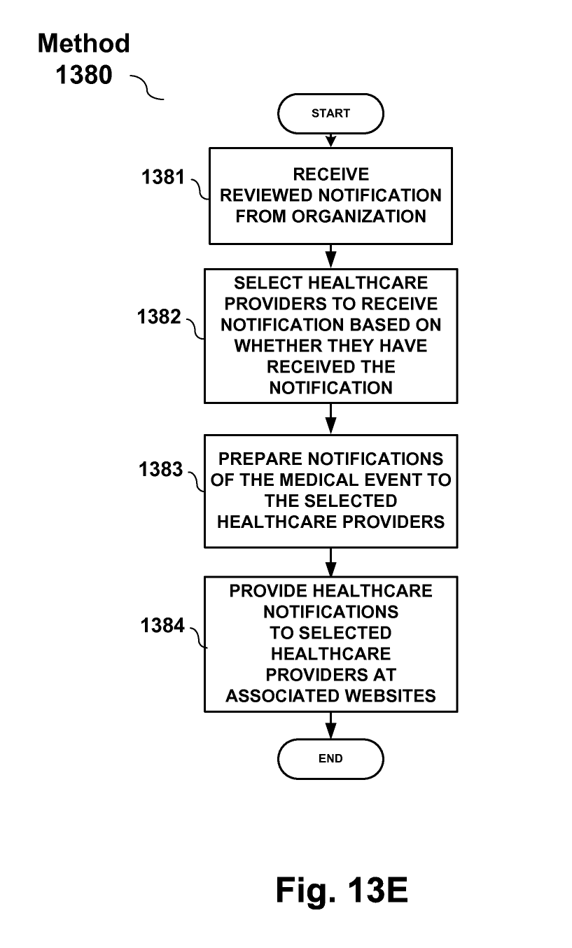

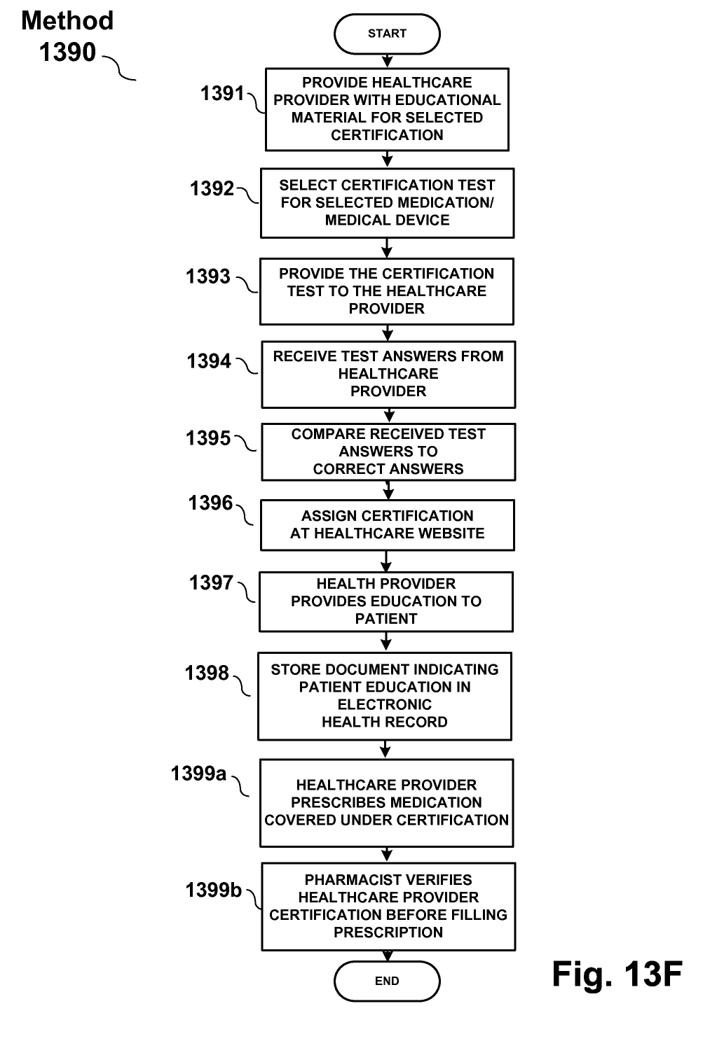

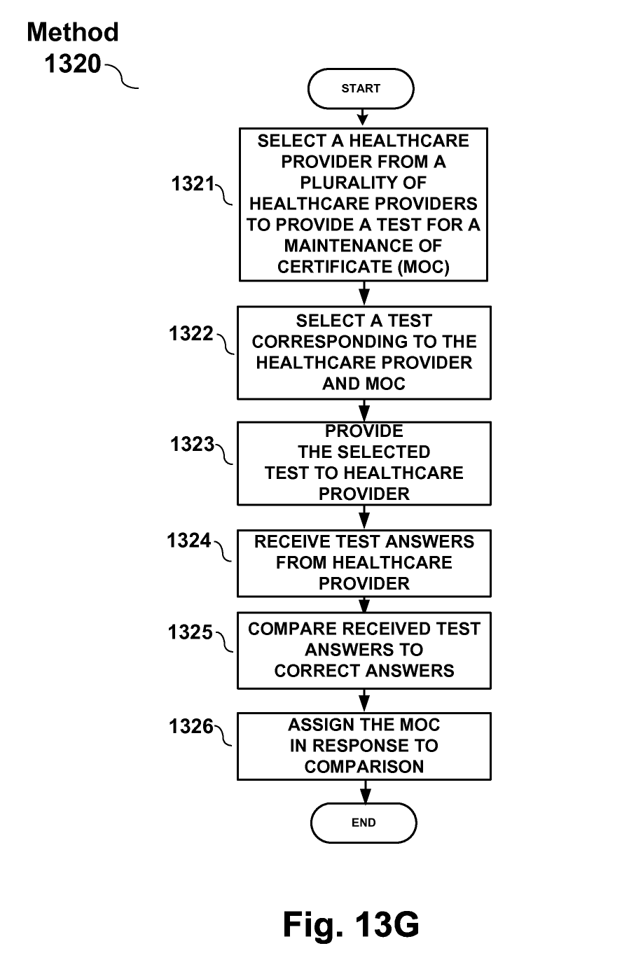

FIGS. 13A-G illustrate methods 1300, 1320, 1350, 1370, 1380 and 1390 according to embodiments. In an embodiment, FIGS. 13A-G illustrate the operation of systems 1100, 1150 and 1170 shown in FIGS. 11A-C. As one of ordinary skill in the art would appreciate, FIGS. 13A-G illustrate logic blocks or steps for performing specific functions as described herein. For example, many logic blocks in FIGS. 13A-G represent the execution of software components illustrated in FIG. 12A on processing device 1102 shown in FIG. 11A.

In regard to FIG. 13A, logic block 1306 illustrates a creation of a healthcare account at website 1101. In an embodiment, individual healthcare providers create an account at website 1101. In an embodiment, a healthcare organization, such as a medical society, health system, physicians group and/or an equivalent, pre-register their members as illustrated by logic block 1306. The healthcare organization provides a data file to website 1101 to create respective healthcare accounts. Website 1101 then may generate respective emails to the members of the healthcare organization so that the members may complete the registration or healthcare account creation process.

Logic block 1301 illustrates an organization, such as a pharmaceutical company, using system 1100 to issue a healthcare related notification to healthcare providers having accounts, such as a recall of a drug used by anesthesiologists. A representative of the pharmaceutical company uses system 1100 to submit a recall or health notification as illustrated by logic block 1302. The representative specifies important parameters of the recall, data and other content associated with the recall, as well as criteria for recipients. The parameters associated with the recall also include the date/time of activation. The proposed notification is reviewed as illustrated by logic block 1303. In an embodiment, a government agency or peer review board reviews the notification. If the notification is rejected, the notification is not sent as illustrated by logic block 1304. In an embodiment, the rejected notification is sent back to the organization with an explanation of the rejection so that the third party may revise and resubmit another healthcare notification and logic blocks 1301-1303 may be repeated.

At the time of activation, as illustrated by logic block 1309, healthcare system 1100 makes recall data available to the selected group of content consumers which in this case includes anesthesiologists and possibly other specialists at healthcare website 1101 for viewing.

At the same time, system 1100 sends email to individuals within the group for whom it has email addresses as illustrated by logic block 1305. Healthcare website 1101 may also send FAXs to some of the healthcare providers, or messages to their mobile devices based on the communication preference of the respective healthcare providers. In other embodiments, a pager or other electronic means may be used. Healthcare website 1101 resends notifications in the event of a delivery failure. Upon several successive failures, the website 1101 would notify a content consumer via standard mail. Some content consumers will have no means of electronic communication. In that case, a process of sending standard mail communication performed by a personnel supporting healthcare website 1101 is triggered.

Logic block 1307 illustrates a healthcare provider receiving an electronic message, such as an email, regarding a healthcare notification. Upon receipt of the electronic message, the healthcare provider may read detailed information or may log into the healthcare website 1101 to view the full notification as illustrated in logic blocks 1308 and 1309.

Healthcare providers that did not receive an electronic message regarding a healthcare notification may also view the notification as illustrated by logic blocks 1310 and 1309.

Also, organizations may log into healthcare website 1101 to view statistics, such as the number of healthcare providers that have received a particular healthcare notification as illustrated by logic blocks 1311 and 1312.

Logic block 1315 illustrates that healthcare website 1101 receives an acknowledgment that the selected healthcare provider has read the healthcare notification. The selected healthcare provider then may access other functions/services 1130 at healthcare website 1101 that may be related to the healthcare related notification. A healthcare provider may access services 1130 that are not related to the healthcare notification as illustrated by separate logic block 1316.

Logic blocks 1331-1339 shown in FIG. 13B represent a suite of services or functions provided at healthcare website 1101. One of ordinary skill in the art understands that more or less services may be provided in embodiments.

Logic block 1331 illustrates a service for a healthcare provider to transform the received healthcare notification to a notification for a patient or a selected subset of patients interested in the healthcare notification.

Logic block 1332 illustrates a service for a healthcare provider to initiate or join a discussion with other healthcare providers regarding the healthcare notification or on another topic.

Logic block 1333 illustrates a service for a healthcare provider to access additional information related or not related to the healthcare notification.

Logic block 1334 illustrates a service for a healthcare provider to access a search program to obtain related literature or not related to the healthcare notification.

Logic block 1335 illustrates a service for a healthcare provider to communicate with third parties, such as organization, regarding or not regarding the healthcare notification.

Logic block 1336 illustrates a service for a healthcare provider to report adverse reactions to third parties.

Logic block 1337 illustrates a service for a healthcare provider to order medication samples.

Logic block 1338 illustrates a service for a healthcare provider to access previously received healthcare notification.

Logic block 1339 illustrates a service for a healthcare provider to earn and view CME credits.

Logic block 1340 illustrates a service for providing a healthcare provider with a certification to prescribe a particular medication and/or use a particular medical device as well as allow verification by delivery agents.

Logic block 1341 illustrates a service for providing a healthcare provider (as well as third parties) with information (including a test to pass) regarding the status of the healthcare provider's MOC.

FIG. 13C illustrates a method 1350 for providing healthcare notifications to selected healthcare providers based on their preferred mode of communication and then to patients of the healthcare providers. In an embodiment, healthcare website 1101 provides healthcare notifications to selected healthcare providers. In an embodiment, method 1350 represents an embodiment represented by at least logic blocks 1305-1309 and 1331 shown in FIG. 13A.

Method 1350 begins by receiving a reviewed healthcare notification from an organization as illustrated by logic block 1351. In an embodiment, the healthcare notification has been reviewed and approved by a reviewing entity. Healthcare providers to receive the notification are selected as illustrated by logic block 1352. Healthcare providers to receive the notification may be selected based on a number of criteria that may be stored in a database, such as database 1210 shown in FIGS. 12B-C. Healthcare providers may be selected based on their specialty or recently entered or prescribed drugs. Similarly, healthcare providers may be selected based on entered or used medical equipment or medical devices. Also, healthcare providers may be selected based on their entries to a database or answers to queries regarding healthcare notifications.

Logic block 1353 illustrates selecting the preferred mode of communication for providing the healthcare notification to the selected healthcare providers. A preferred mode of communication may be email, regular mail, pager, fax, text message or other modes of communication. In an embodiment, healthcare providers enter the preferred mode of communication and profile/contact information at healthcare website 1101. In an embodiment, the preferred mode of communication and profile/contact information are obtained from a healthcare provider record stored in database 1210.

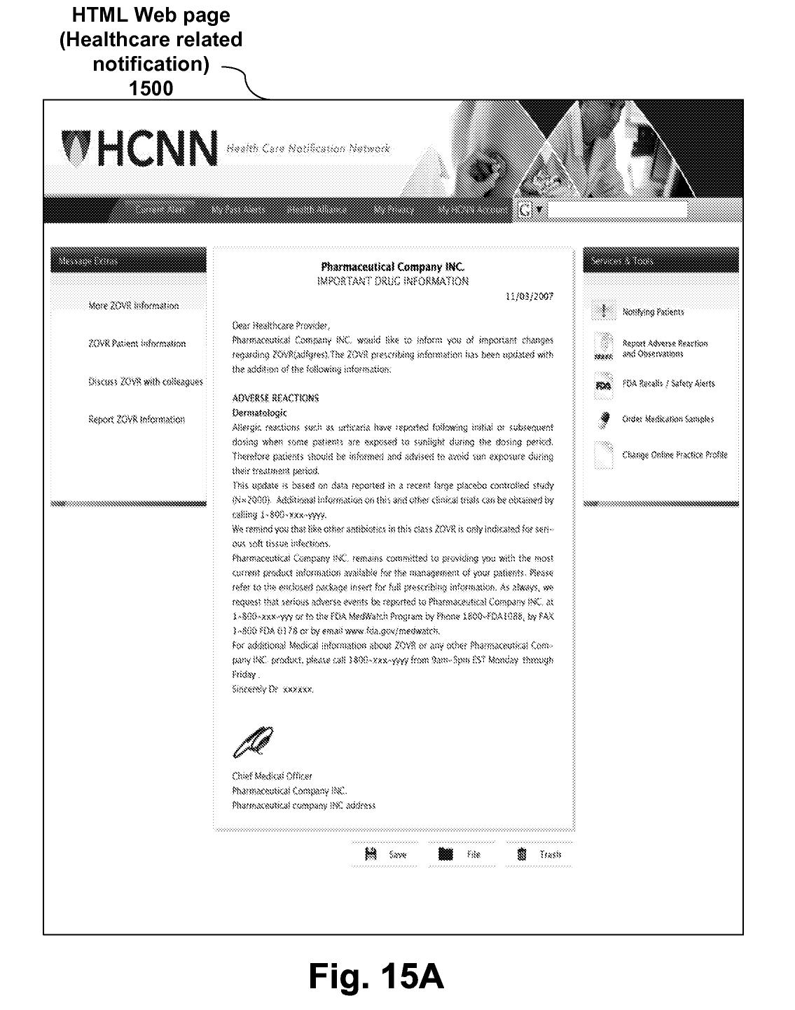

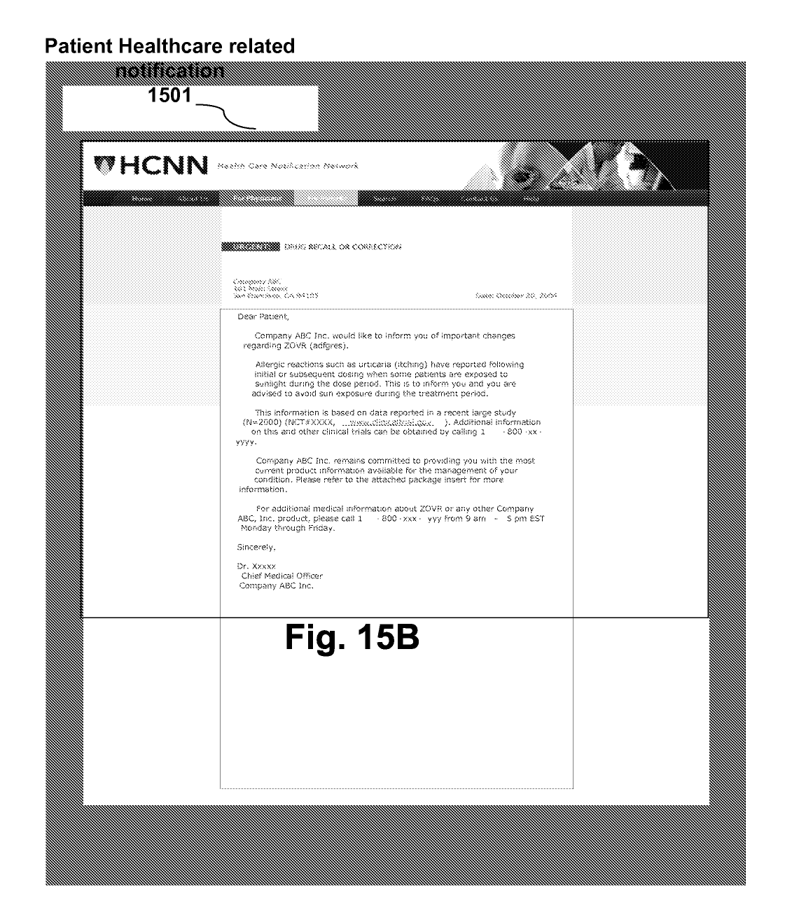

The healthcare notification is then formatted based on the preferred mode of communication and generated to the selected healthcare provider as illustrated in logic blocks 1354 and 1355. In an embodiment, an email message with a link or URL address to a healthcare notification in a web page at healthcare website 1101 is provided to the selected healthcare provider. In embodiments, web pages 1500 and 1600 as illustrated in FIGS. 15A and 16 are provided. Web page 1500 illustrates a notification regarding an allergic reaction of the drug “ZOVR” under certain conditions from a pharmaceutical company Inc. Web page 1600 illustrates a similar notification with a “FDA REQUIRED RESPONSE” or survey questions that may be answered and transferred back to healthcare website 1101.

In an embodiment, healthcare providers may register for pre-alerts or pre-healthcare related notifications. When system 1100 becomes aware that a healthcare notification will be generated shortly, a healthcare provider may receive a pre-alert notice, such as “Healthcare Notification coming tomorrow.” These Pre-Alerts or pre-healthcare notifications may be generated to partners, such as medical societies, a day in advance of the healthcare notification. A partner pre-alert may contain both a message to “look for the Alert via the Healthcare Website 1101” if the healthcare provider is registered and/or a “register on the Healthcare Website 1101 to receive the alert tomorrow” message.

In embodiments, alerts and/or healthcare notifications include a viral marketing message, such as “tell a colleague.” In an embodiment, system 1100 provides a chat area, as illustrated by logic block 1332, where notification recipients can discuss a healthcare notification with colleagues who also received the notification. Similarly, the notification recipient may report adverse reactions or communicate with third parties as illustrated by logic blocks 1335 and 1336.

A determination, as represented by logic block 1356, is made whether the healthcare provider would like to forward a patient version of the healthcare notification to selected patients or all of the healthcare provider patients. When patient notifications are not requested, method 1350 ends. Otherwise, control transfers to logic block 1357 where patients to receive the patient formatted healthcare notification are selected. In an embodiment, patients may be selected based on previously prescribed medications, health conditions, age or other factors that may be stored in an electronic patient health record in database 1210 associated with the healthcare provider.

Patient notifications are then formatted as illustrated by logic block 1358 and generated to selected patients as illustrated by logic block 1359. In an embodiment, patient healthcare related notification 1501, shown in FIG. 15B, is a patient version (or format) of the information in web page 1501 that was provided to the healthcare provider (or the healthcare provider's organization—Company ABC Inc.) of the patient. In an embodiment, patient notifications may be emailed. Method 1350 then ends.

FIG. 3D illustrates a method 1370 for providing CME information, such as associated CME tests, with healthcare notification that are provided to healthcare providers. In an embodiment, healthcare website 1101 provides healthcare notifications and CME information to selected healthcare providers. In an embodiment, method 1370 represents an embodiment represented by at least logic blocks 1305-1309 and 1339 shown in FIG. 13A-B.

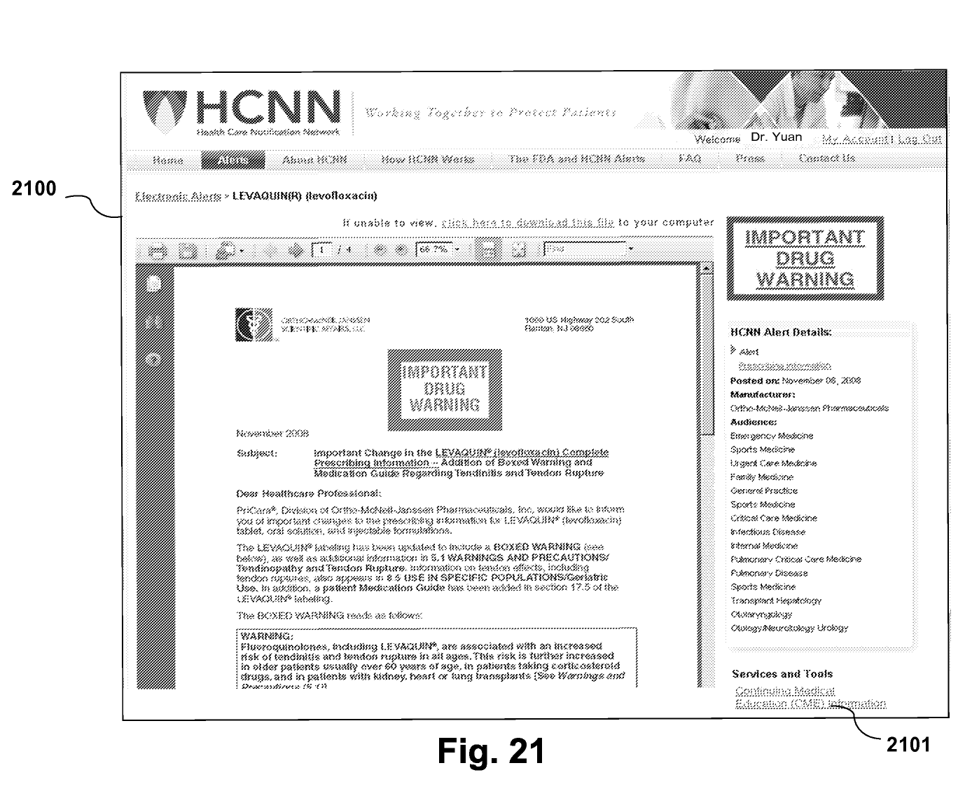

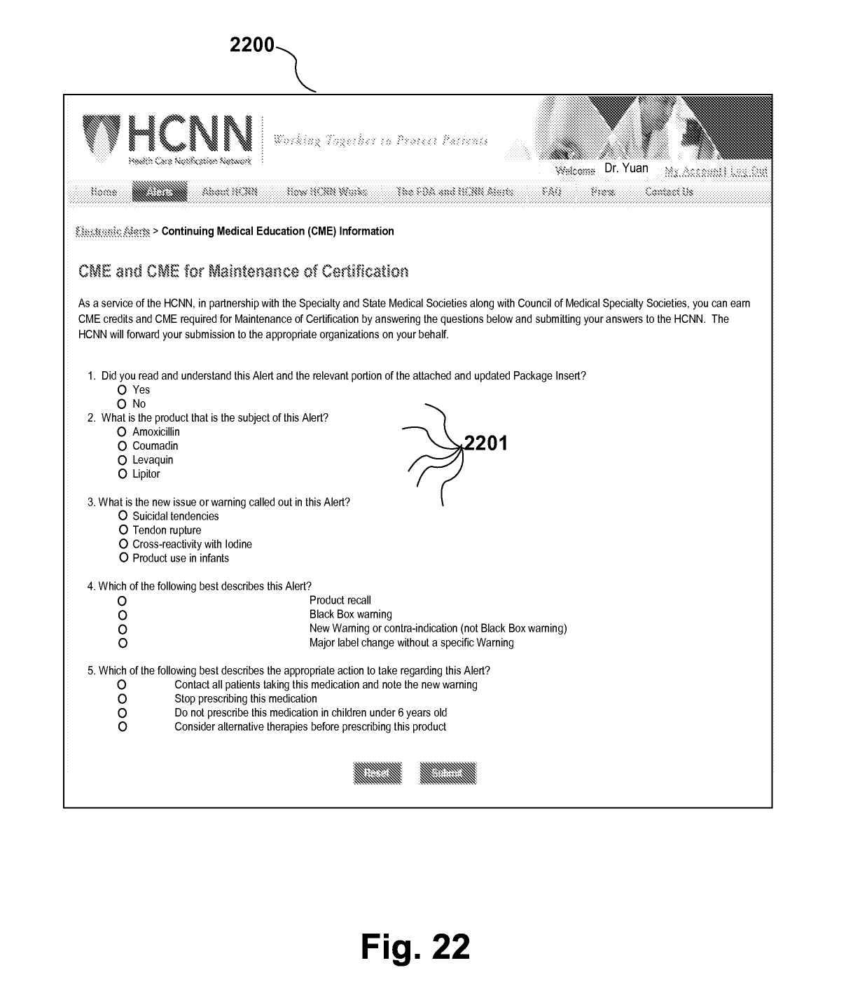

Method 1370 begins by selecting a CME test corresponding to a particular healthcare notification to be provided to a selected number of healthcare providers as illustrated by logic block 1371. In an embodiment, a CME test for a particular healthcare notification is obtained from healthcare notification record 1210b in database 1210 shown in FIG. 12C. In an embodiment, the CME test includes questions regarding an associated healthcare notification to be provided. For example, “Test 3” is selected for “Notification 3” that has a notification that relates to “internal” medicine. In another example, FIG. 21 illustrates a web page 2100 including a healthcare notification regarding a drug (“LEVAQUIN”) warning and FIG. 22 illustrates a web page 2200 including CME questions 2201 regarding the content of the drug warning in FIG. 21. In alternate embodiments, a CME test may be selected not on a specialty but on types of drugs prescribed, medical devices used and/or answers to registration questions, singly or in combination.

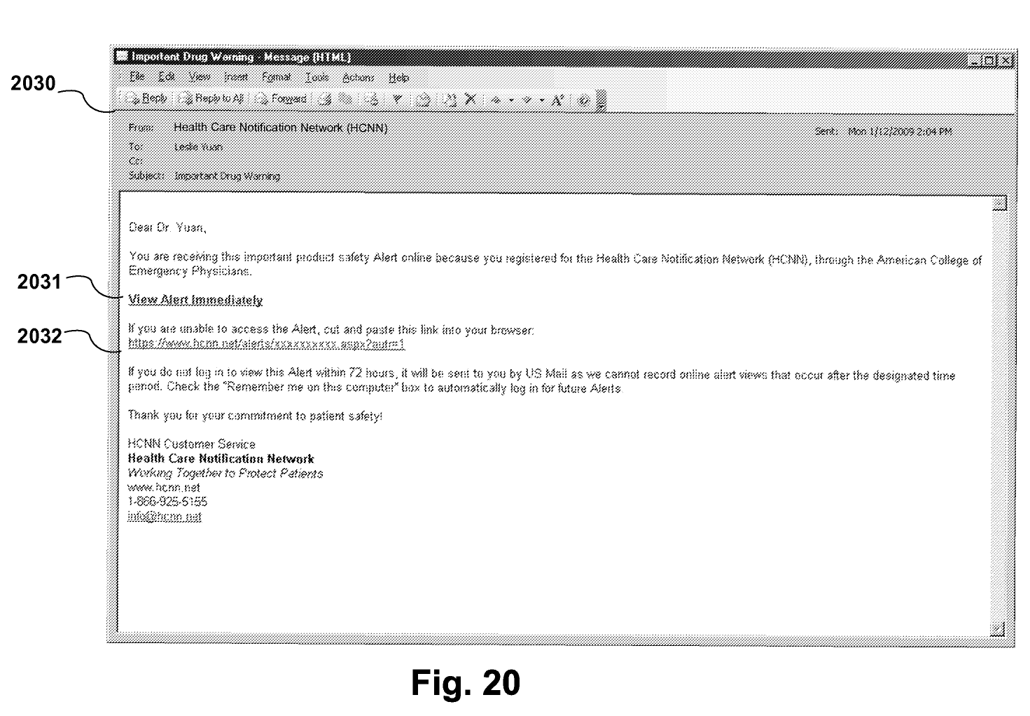

Logic block 1372 illustrates providing healthcare notifications to selected healthcare providers. For example, an email 2030 including a link 2031 to a healthcare notification is provided to “Dr. Yuan,” along with other selected healthcare providers, from website 1101 via one or more healthcare provider processing device 1104a. In an embodiment, link 2031 may be clicked-on by a healthcare provider to access the healthcare notification shown in FIG. 20. If the link does not work, an URL address 2032 for a web browser is provided.

Logic block 1373 illustrates providing a CME test corresponding to the healthcare notification. For example, link 2101 in web page 2100 shown in FIG. 21 may be “clicked-on” to access a CME test, such as questions 2201 shown in FIG. 22. For example, questions 2201 cover the subject matter of the drug warning shown in web page 2100. A question may include a multiple choice question such as “what is the product that is the subject of the Alert?”

After receiving the CME test, a healthcare provider may answer the questions and click-on the “submit” button that transfers the answers back to website 1101 as illustrated by logic block 1374.

Logic block 1375 illustrates comparing the received CME test answers with the correct answers stored in record 1210b in database 1210 by content management software component 1203.

Logic block 1376 then assigns and stores earned CME credits in “Total Continuing Medical Education Credits Earned” to corresponding healthcare providers in profiles 1210a of database 1210. For example, Physician Fotsch has earned “100” CME credits. Healthcare providers are then able to view the earned credits by way of healthcare website 1101. The use of CME information with healthcare notification provides an unexpected result. Healthcare notifications can be provided to healthcare providers in a timely and efficient manner and at the same time allow the healthcare provider to earn CME credits without requiring additional research and time in obtain necessary CME credits. The opportunity of obtaining CME credits with healthcare notifications allows healthcare providers to address CME and Maintenance of Certification (MOC) requirements for patient safety education and also provides an incentive for the healthcare provider to access important healthcare notifications.

FIG. 13E illustrates a method 1380 for providing healthcare notifications that are provided to healthcare providers by way of associated healthcare websites. In an embodiment, healthcare website 1101 provides healthcare notifications to selected healthcare providers by way of associated healthcare website 1151. In an embodiment, method 1380 represents an embodiment represented by at least logic blocks 1305-1309 shown in FIG. 13A.

Method 1350 begins by receiving a reviewed notification from an organization as illustrated by logic block 1381 and similar to the description above in regard to logic block 1351.

Logic block 1382 then illustrates selecting particular healthcare providers that will receive the healthcare notification at associated healthcare websites. In an embodiment, the selection of healthcare providers to receive a healthcare notification at an associated healthcare website is determined as described herein and based at least in part on whether the healthcare provider has already received and acknowledged the healthcare notification (i.e. the healthcare provider has received and acknowledged an email). Also, a selection will be based on whether the selected healthcare provider is a member or registered with a particular associated healthcare website. In an embodiment, Content Management 1203 (shown in FIG. 12A) will determine what healthcare notification in record 1210b will be provided to a particular set of healthcare providers in profiles 1210a in database 1210 of FIG. 12C (i.e. determined based on specialty). Content Management 1203 then may also determine whether the healthcare providers in the selected set have already received the notification and/or are members of the associated healthcare websites as indicated in profiles 1210a. For example, profiles 1210a show that “Physician Del Guidice” has not received/acknowledged “notification 2” (indicated by “N” for no in FIG. 12C) and is a member of the associated electronic prescription (ERX) website. Therefore, “Dr. Del Guidice” would be selected to provide a healthcare notification (i.e. related to “radiology” because of her specialty) at the electronic prescription website.

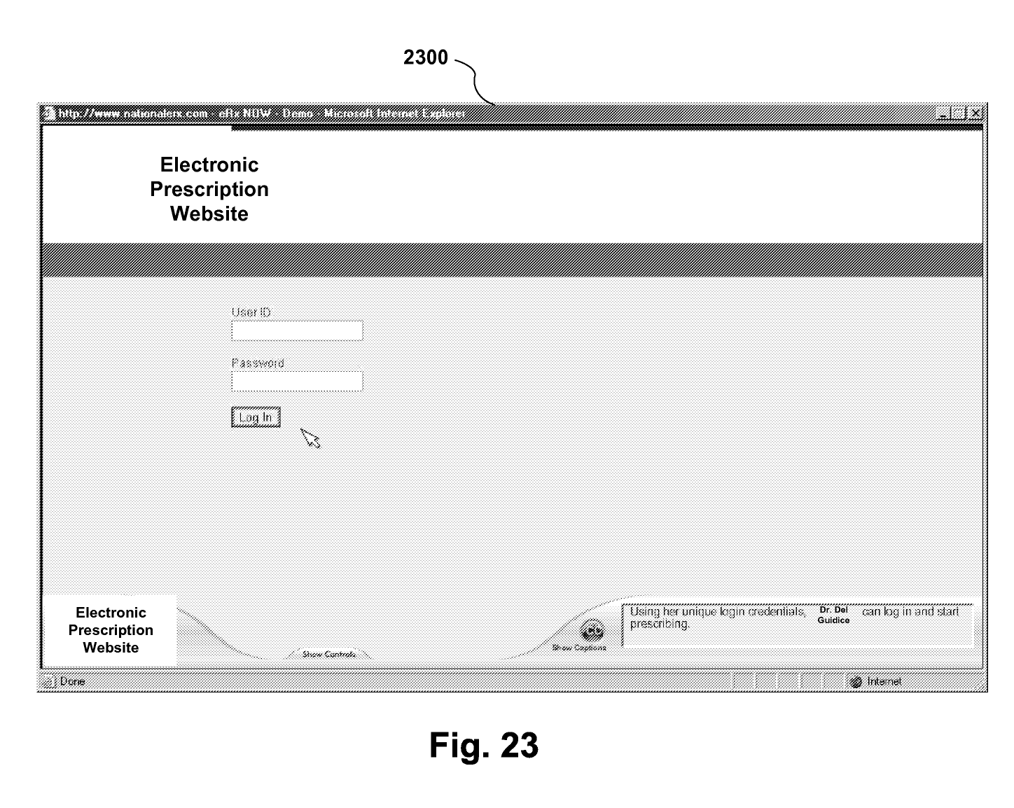

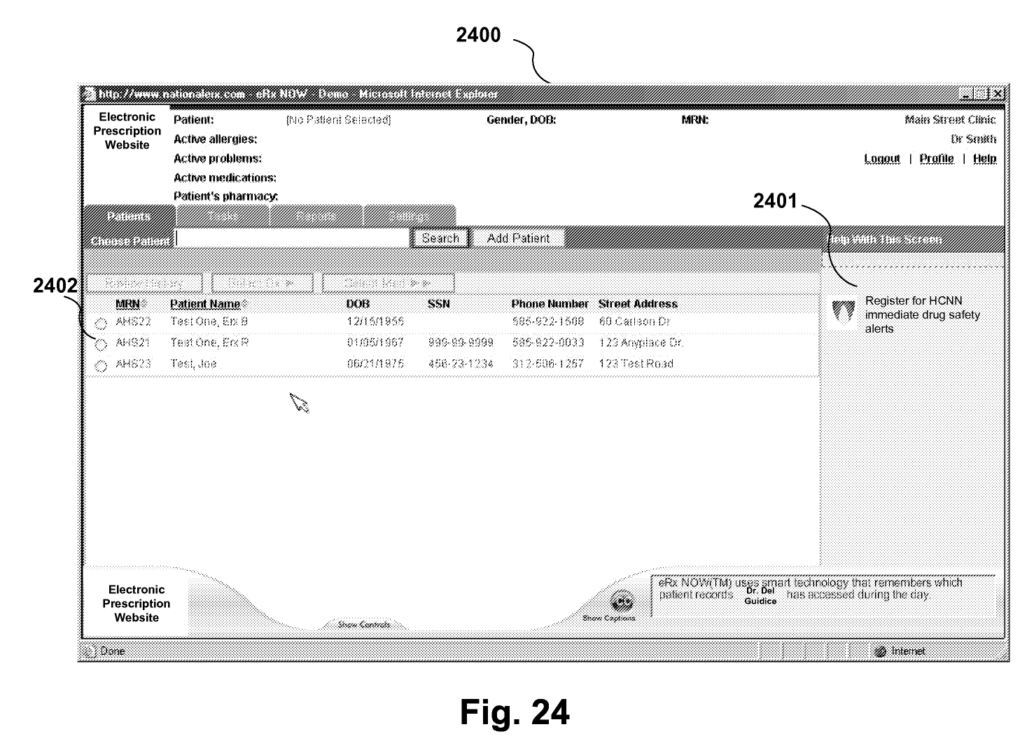

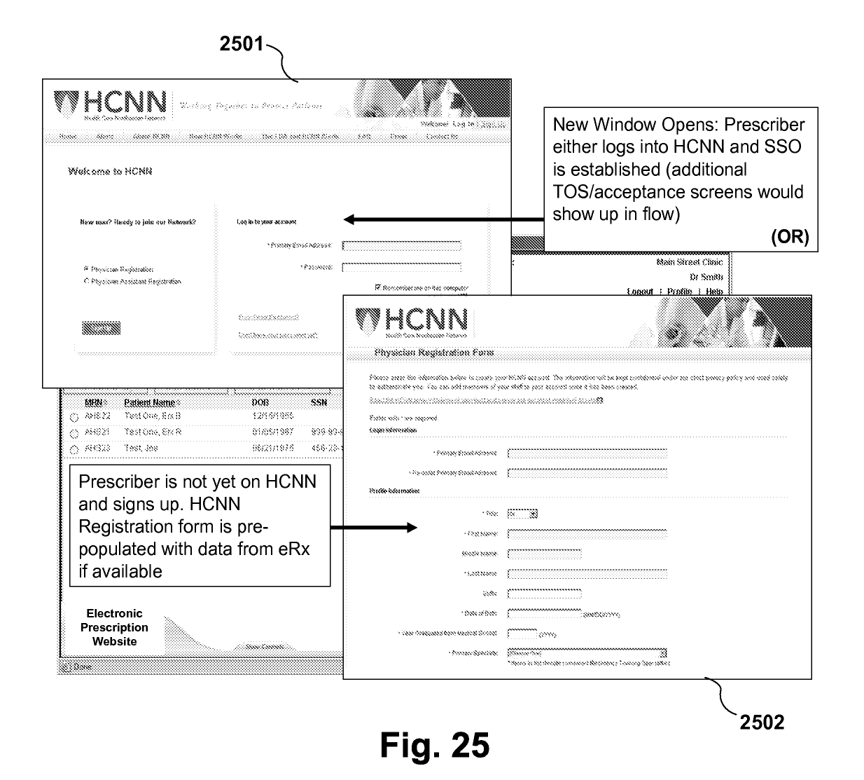

Logic block 1383 illustrates the preparation of the healthcare notifications for the selected healthcare providers at the associated healthcare websites. In an embodiment, a healthcare notification may be provided at an associated healthcare website by a link to register at healthcare website 1101 as illustrated by link 2401 in web page 2400 at the electronic prescription website. Before reaching web page 2400 a healthcare provider would log into the electronic prescription website by providing the appropriate “username” and “password” as shown by web page 2300 in FIG. 23. After a healthcare provider clicks-on link 2401, either web pages 2501 or 2502 shown in FIG. 25 may be provided in embodiments. If the healthcare provider is already registered with healthcare website 1101, web page 2501 is provided and allows for the healthcare provider to log-in and obtain the healthcare notification. If the healthcare provider is not registered with healthcare website 1101, web page 2502 is provided for registration and subsequent viewing of the healthcare notification.

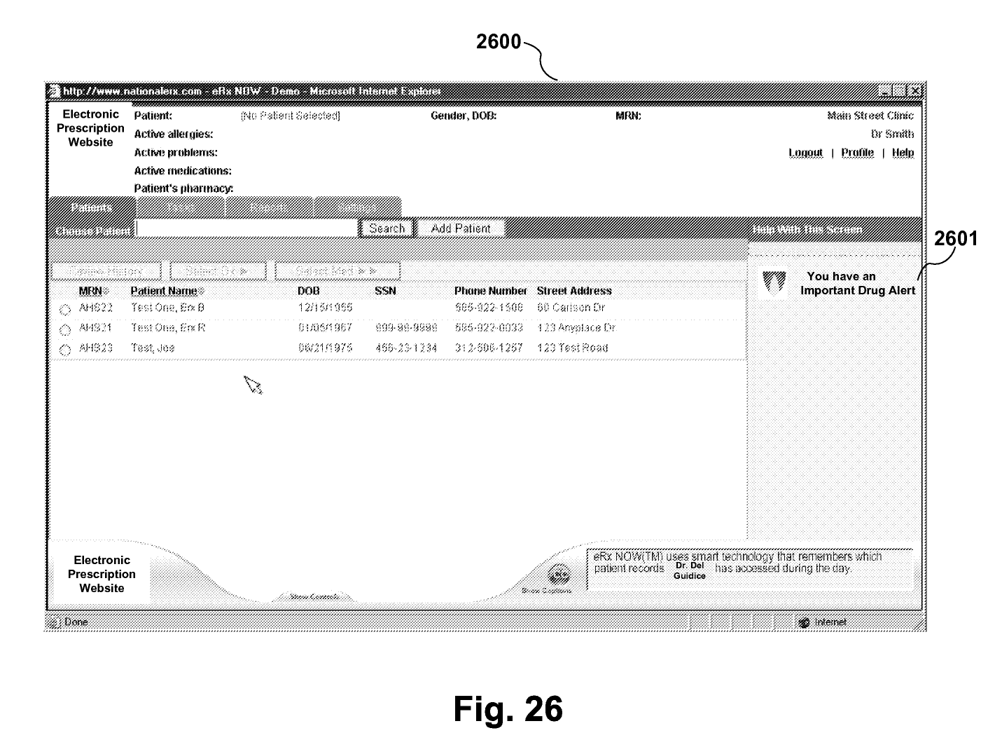

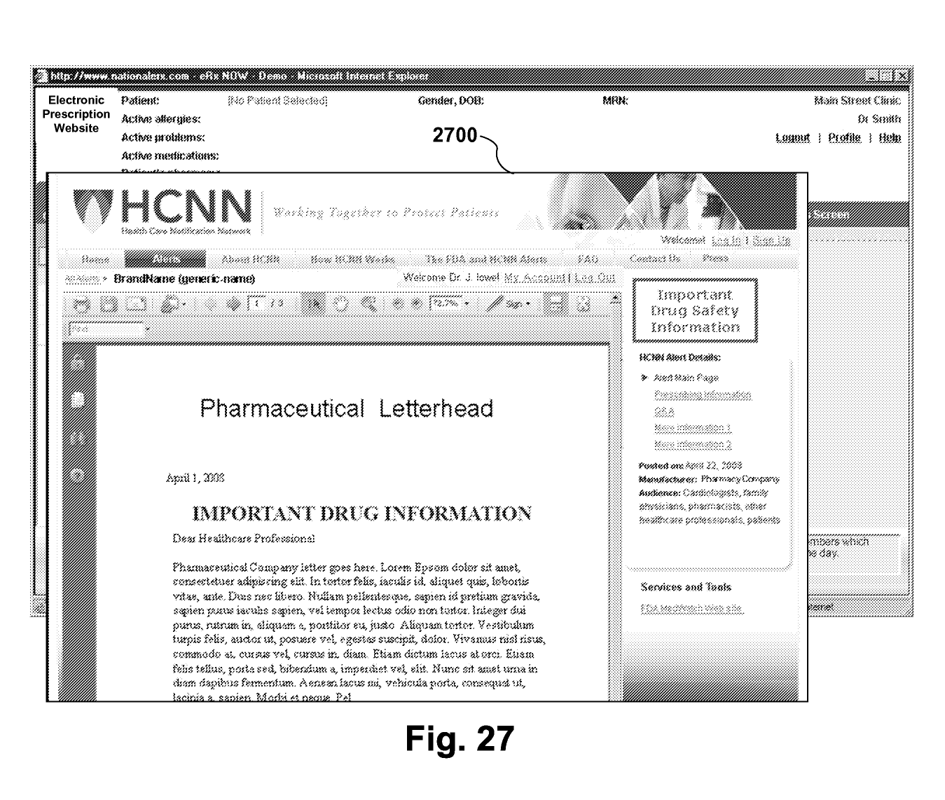

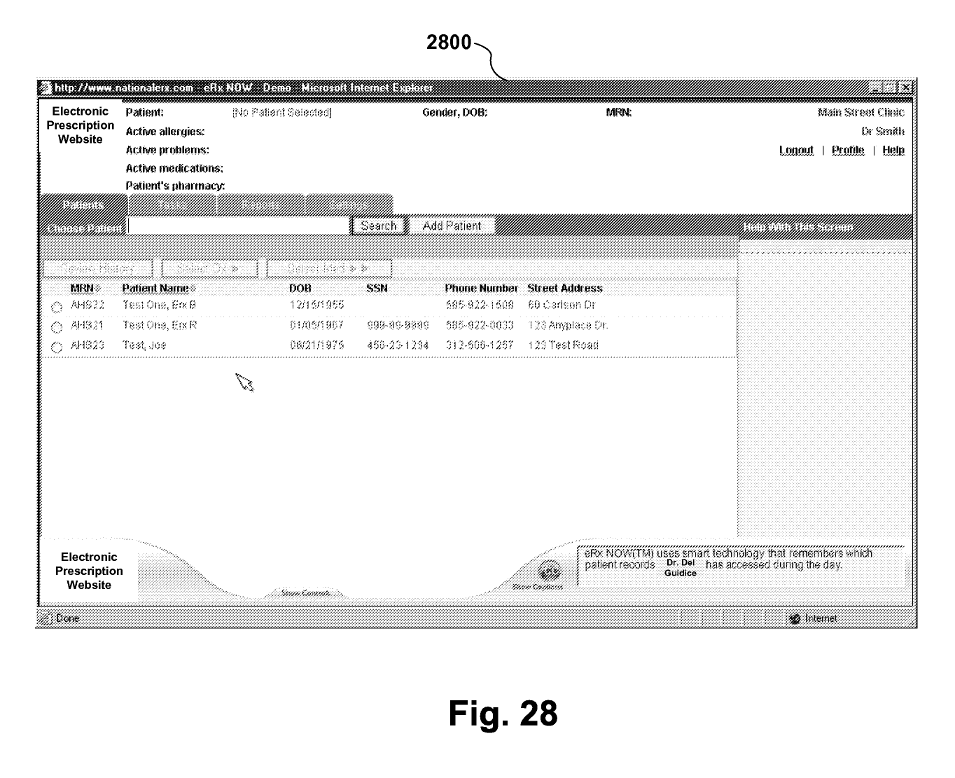

Logic block 1384 illustrates providing the healthcare notification to the selected healthcare providers by way of the associated healthcare website. In an embodiment, healthcare notifications are posted at the healthcare website 1101 and are accessed after registration or sign-on of the healthcare provider at the associated healthcare website described above. In an alternate embodiment, an indication of a healthcare notification in the form of a link at an associated web page is provided. For example, link 2601 indicating “You have an Important Drug Alert” is provided at a web page 2600 shown in FIG. 26 of a selected healthcare provider at the electronic prescription website. The healthcare provider then may click-on link 2601 to view the healthcare notification on web page 2700 at healthcare website 1101 through a new browser window as shown in FIG. 27. In an embodiment, a link is not provided as shown in FIG. 28 if the selected healthcare provider had already viewed the selected healthcare notification or received/acknowledged the healthcare notification provided by email.

FIG. 13F illustrates a method 1390 for providing a certificate to a healthcare provider and verifying such certification by way of a healthcare website 1101. In an embodiment, method 1390 represents an embodiment represented by at least logic blocks 1305-1309 and 1340 shown in FIGS. 13A-B. A delivery agent, such as a pharmacist and/or medical device manufacturer, is able to verify that a healthcare provider has been certified for prescribing a particular medication or using a particular medical device before filling a prescription for a patient or providing a medical device to the healthcare provider for the patient. For example, delivery agent 1171 may access healthcare website 1101 by way of delivery agent processing device 1172 and Internet 1103 to verify certification(s) of healthcare provider(s) 1120 before delivering a medication and/or medical device to a patient (or to a healthcare provider for use with a patient).

In an embodiment, method 1390 begins by providing a selected healthcare provider with information to obtain a certificate for a particular medication and/or medical device as illustrated by logic block 1391. In an embodiment, an electronic healthcare notification as described herein may include or attach information for obtaining a certification. For example, an electronic healthcare notification regarding a medical event may include educational material or a link to the educational material at healthcare website 1101 to be reviewed before passing a test necessary for certification. In an embodiment, healthcare providers are selected to obtain the information regarding certification similar to being selected for an electronic healthcare notification. In an embodiment, Content Management 1203 (shown in FIG. 12A) queries record 1210a (shown in FIG. 12C) to determine a healthcare provider's specialty and/or possible medications (drugs) and/or medical devices (such as equipment) used. When Content Management 1203 determines that a healthcare provider is to receive an electronic healthcare notification, a determination is also made by Content Management 1203 whether a certification is required for the particular medication/medical device covered by the electronic notification in record 1210a. For example, record 1210a illustrates that Physician “Fotsch” has received certification in prescribing “Lidocaine” while Physician “Choy” has not received certification in prescribing “Tacrine.”

In an alternate embodiment illustrated by logic block 1391, education material for certification or a link to education material is not provided with an electronic healthcare notification regarding a medical event and is included in periodic electronic communications, such as e-mails, to selected healthcare providers based on specialty and/or medications prescribed and/or medical devices used as well as whether the healthcare provider is already certified. In still another embodiment, logic block 1391 represents healthcare providers receiving educational material or notifications regarding required certifications by registering or logging into healthcare website 1101.

Logic block 1392 illustrates selecting a certification test corresponding to a particular medication or medical device. In an embodiment, a certification test for a particular medication/medical device is obtained from healthcare record 1210c in database 1210 shown in FIG. 12C. In an embodiment, the certification test includes questions regarding a particular medication/medical device is be provided. For example, “Test 3” is selected for certification to prescribe the medication “Tacrine.” In an embodiment, the form of questions for certification is similar to the form of questions shown in FIG. 22.

Logic block 1393 illustrates providing a certificate test in electronic form. The certificate test may correspond to a healthcare notification or may be accessed directly from the healthcare website 1101.

After receiving the certificate test, a healthcare provider may answer the certification questions and transfer the answers back to website 1101 as illustrated by logic block 1394.

Logic block 1395 illustrates comparing the received certification answers with the correct answers stored in record 1210c in database 1210 by content management software component 1203.

Logic block 1396 then assigns and stores a certificate (or representation thereof) for a medication/medical device to a corresponding healthcare provider in record 1210a of database 1210. For example, Physician Fotsch has earned certifications for medication/medical devices illustrated by the numbers 1, 2 and 4 while Physician Del Guidice has earned certifications for medication/medical devices illustrated by the numbers 1 and 3.

In an embodiment, a patient is also educated as illustrated by logic block 1397. In an embodiment, a healthcare provider educates the patient regarding the particular medication and/or medical device that may include side effects and associated risks.

Logic block 1398 illustrates documenting the education of the patient regarding the medication and/or medical device. In an embodiment, a document that describes the medication and/or medical device including its side effects and risks is signed by the patient and stored in the patient's medical records, such as an electronic medical record. The patient electronic medical record may be stored at healthcare website 1101 or at an associated web site. The document indicates that the patient has read, understood, and accepted the risks and side effects associated with the medication/medical device. In an embodiment, healthcare website 1101 stores an indication that such a document exists even though the document may not be stored at healthcare website 1101. In an embodiment, an indication that a particular patient has been educated for a particular medication/medical device or certified (via the stored document) may be stored in database 1210 that may be accessed by way of website 1101.

Logic block 1399a illustrates a healthcare provider prescribing a medication and/or ordering a medical device that requires certification. In various embodiments, the prescription and/or order of a medical device may be provided electronically. In an embodiment, healthcare provider(s) 1120 prescribes a medication to patient(s) 1108 for a medication that requires a certificate. In an alternate embodiment, healthcare provider(s) 1120 order a medical device from a medical device manufacturer. Patient (s) 1108 then may provide the prescription to a pharmacist, or similar delivery agent.

A pharmacist, or other delivery agent, then verifies that healthcare provider(s) 1120 is certified for prescribing the prescribed medication as illustrated by logic block 1399b. In an embodiment, a delivery agent 1171 logs into healthcare website 1101 via delivery agent processing device 1172 in order to verify that healthcare provider(s) 1120 is certified. In an alternate embodiment, delivery agent 1171 also verifies that the patient is likewise certified or has been educated as illustrated in logic block 1399b. After the verification, the delivery agent provides the medication to the patient or the medical device to the healthcare provider as illustrated by logic block 1399b.

FIG. 13G illustrates method 1320 for providing MOCs to healthcare providers. In an embodiment, method 1320 represents an embodiment represented by at least logic blocks 1305-1309 and 1341 shown in FIGS. 13A-B.

Method 1320 begins by selecting a healthcare provider from a plurality of healthcare providers to provide a test for obtaining a MOC as illustrated by logic block 1321. In an embodiment, the MOC test is included or attached to healthcare notification to be received by the healthcare provider. In an embodiment, the healthcare provider is selected based on a specialty stored in record 1210a. In another embodiment, the healthcare provider is selected based on other criteria, such as the date of completion of the previous MOC and/or whether other steps required for a MOC have been completed. Information regarding status/completion of MOC requirements or steps (MOC information) may be stored in record 1210a and accessed by healthcare providers and others by way of healthcare website 101 in embodiments.

A MOC test corresponding to a particular healthcare provider is selected as illustrated by logic block 1322. In an embodiment, a MOC test for a particular healthcare provider is obtained from record 1210d in database 210 shown in FIG. 12C. In an embodiment, a MOC test is selected based on the specialty of the healthcare provider.

Logic block 1323 illustrates providing a MOC test corresponding to the healthcare provider. In embodiments, the MOC test may be provided in electronic form, by way of a link in an e-mail and/or from a web page in healthcare website 1101.

After receiving the MOC test, a healthcare provider may answer the MOC questions and submit the answers to healthcare website 1101 as illustrated by logic block 1324.

Logic block 1325 illustrates comparing the received MOC answers with the correct MOC answers stored in record 1210d in database 1210 by content management software component 1203.

When the MOC test is successfully passed, logic block 1326 then assigns and stores such indication in record 1210a in database 1210. For example, Physician Fotsch's MOC is current and the requirements that were completed are stored in a MOC information field of record 1210a.

### VI. Website Software Architecture

FIG. 12A illustrates software components of software 1102a that may be executed on healthcare platform processing device 1102, shown in FIGS. 11A-C, to provide healthcare website 1101 including other healthcare related services. In an embodiment, healthcare platform software 1102a includes machine/computer readable or executable instructions. In an embodiment, software 1102a is stored in an article of manufacture, such as a computer readable medium that may be removable from or included in a processing device as described herein.

In embodiments, software components of healthcare platform software 1102a illustrated in FIG. 12A have functions described in detail below.

F. Healthcare Portal 1200

Healthcare portal 1200 provides content consumers, such as healthcare providers, government agencies, medical boards, medical societies, pharmaceutical manufacturers, medical device manufacturers, etc., with access to medical event information that includes medication recalls and warnings, medical device recalls and warnings, medical equipment recalls and warnings. In particular, Healthcare portal 1200 displays 1) most recent recall and warning information for medicines, medical devices and medical equipment; 2) most viewed recall and warning information; 3) specific recall data and ancillary materials including reach media data (from rich media 1209 described below) such as photos and video and or suggested communications to patients; and 4) search and list data via various combinations of search criteria. For example, a user will be able to enter various search criteria, such as manufacturer name, type of recall, product name, etc., to obtain a healthcare notification from an internal search software component.

Healthcare portal 1200 also provides content consumers with: 1) access to healthcare news and publications; 2) connectivity to selected content providers, such as pharmaceutical companies, manufacturers, and government organization such as the FDA (in an embodiment IC 1205 described below is used to provide this service); 3) a report function of adverse reaction to a medicine; 4) order drug samples; 5) order brochures; 6) access to maintenance functions such as maintaining healthcare provider profiles/contact information; 7) access to targeted search of information within the portal and through external search engines; 8) connectivity to external applications, such as secure messaging communication with healthcare providers, social networks related or dedicated to healthcare content and discussion forums dedicated or related to healthcare content (in an embodiment IC 1205 described below is used to provide this service); 9) provide tests (along with electronic notifications) for CME credits as well as access to earned CME credit totals; 10) provide status of requirements to satisfy MOC as well as providing MOC tests for particular healthcare providers; and 11) provide certificates to healthcare providers to prescribe particular medications and/or use particular medical devices after successful passing provided tests.

G. Email and Mobile Alert and Notification 1201/1202

Email and Mobile Alert and Notification 1201/1202 provides content consumers with real time notifications associated with release of healthcare related information, such as medication recalls and warnings, medical device recalls and warnings, and medical equipment recalls and warnings.

In embodiments, notifications may be delivered to predetermined healthcare providers via a variety of electronic mediums, such as emails, facsimile, SMS messages, IM messages, pager calls or an equivalent. The electronic notifications may be sent at a predetermined time as selected by the organization or a specific end user.

In embodiments, notifications may contain detailed information, brief information or just a pointer (or link) to information which can be accessed via healthcare website 1101.

H. Content Management 1203

Content Management (CM) 1203 provides content contributors with ability to publish content associated with release of healthcare notifications, such as medication recalls and warnings, medical device recalls and warnings, and medical equipment recalls and warnings.

CM 1203 also enables monitoring appropriate use of healthcare website 1101 by content providers. In an embodiment, CM 1203 is responsible for providing CME service 1339 and in particular selecting CME tests corresponding to healthcare notifications. In addition, CM 1203 may compare received CME test answers with correct answers to assign and record CME credits. Similarly, CM 1203 is responsible for certification service 1340 and MOC service 1341. CM 1203 selects a particular educational material and test to be passed to a particular certificate and/or MOC. CM 1203 also compares certificate and MOC test answers with correct answers to assign and store certificates and MOC test results. CM 1203 may also be responsible for recording the status of other MOC requirements. In an embodiment, CM 1203 may initiate the transfer of a selected MOC test to selected healthcare providers based on the healthcare provider's specialty and/or the previous MOC completion date.

I. Reporting and Business Intelligence 1204

Reporting and Business Intelligence (RBI) 1204 provides content providers with a variety of data associated with release and receipt of healthcare information, such as medication recalls and warnings, medical device recalls and warnings, and medical equipment recalls and warnings. In an embodiment, RBI 1204 provides a report to organizations of healthcare providers who have received notifications and answers to survey questions.

Reports provided by RBI 1204 are delivered based on roles and data access rules maintained by user management 1207 described below.

J. Integration and Connectivity 1205

Integration and Connectivity (IC) 1205 provide external parties with connectivity to healthcare website 1101. Connectivity to external parties is bidirectional, meaning that external parties can submit and retrieve data from healthcare website 1101. Both submission and retrieval of the data is controlled through multilayer security ensuring that only authorized parties can access information. In an embodiment, IC 1205 provides communication with associated healthcare websites by way of applets and/or portlets. In an embodiment, IC 1205 allows for a single sign-on (“SSO”) at associated healthcare website 1151 that allows access to healthcare website 1101.

K. Member Services 1206

Member Services 1206 enables healthcare website 1101 support and customer service staff to perform operations that require accessing or altering data. In particular, Member Services 1206 is used to provide minor technical support to the content providers and content consumers, such as restoring lost passwords and user IDs.

L. User Management 1207

User Management 1207 stores information associated with content consumers and content providers as well as the associated permissions, roles and access rights.

M. Support 1208

Support 1208 maintains a safe and secure operation of healthcare website 1101. With security, privacy and safety being complex multi-fold objectives, Support 1208 includes a number of software components serving multiple objectives: logging and auditing, internal alert and notification, performance and availability control.

N. Rich Media 1209

Rich Media 1209 stores and provides photos, audio, large documents and video and/or suggested communications to patients in regard to healthcare notifications.

O. Centralized Database1 1210

Central database1 1210 stores and maintains information such as recall data, notification information and application metadata or information that describes the composition and architecture of data. For example, metadata may include a data dictionary. Most software components illustrated in FIG. 12A access central database 1210.

FIG. 12B illustrates healthcare provider profiles/records 1210a that includes a plurality of healthcare provider profiles and preferred electronic notification contact information. FIG. 12B illustrates a portion of a data structure stored in database 1210 and one of ordinary skill in the art understands that database 1210 includes other data as well. Healthcare provider profile 1210a includes fields of information associated with each healthcare provider name or physician. In particular, each physician name has an associated 1) medical specialty; 2) typically prescribed or currently prescribed drugs and typically used equipment or currently used equipment; 3) preferred type of electronic notification; 4) contact address; and 5) default or address that the notification may be mailed. One of ordinary skill in the art also understands that healthcare provider profiles 1210a may include more or less fields of information depending upon a particular embodiment.

In an embodiment illustrated in FIG. 12C, database 1210 includes healthcare provider profiles 1210a that include 1) certifications received for medications and medical devices, 2) MOC status, 3) MOC information, 3) total continuing medical education (CME) credits earned by the healthcare provider, 4) which healthcare notification has been received/acknowledged by the healthcare provider (Yes-Y, No-N) and 5) which associated healthcare websites (ERX, EHR, etc.) does the healthcare provider belong to (Yes-Y, No-N).

In an embodiment, CM 1203 software component accesses healthcare provider profiles 1210a to select which healthcare provider will receive a healthcare related electronic notification in response to healthcare notification from an organization, such as a drug manufacturer. In an embodiment, user management 1207 and CM 1203 software components accesses healthcare provider profiles 1210a to determine how and where the electronic notification will be sent to the selected healthcare provider. For example, if an ultrasound manufacturer provided a recall of a particular ultrasound device to healthcare website 1101, Physician Del Guidice would receive a facsimile notification while Physicians Fotsch and Choy would not receive a notification because they do not work with ultrasound equipment. Similarly, Physician Fotsch would receive an email notification of a recall of the drug lidocaine; while Physicians Del Guidice and Choy would not as their specialty and typically prescribed drugs indicate that they do not typically prescribe lidocaine.

In an embodiment, CME and MOC tests are provided to physicians by CM 1203 similar to healthcare notifications.

In an embodiment, database 1210 includes records 1210b having particular notifications associated with specialties, CME tests, correct CME answers and CME credits per test.

In an embodiment, database 1210 includes records 1210c having certification tests and answers associated with medication and/or medical devices that require certification.

In an embodiment, database 1210 includes records 1210d having MOC tests and answers associated with MOC specialties.

In an embodiment, database 1210 includes a plurality of patient electronic health records associated with each physician. Each patient electronic health record includes information, such as prescribed drugs, medical conditions/allergies, age, certificates, etc., that allow healthcare website 1101 to identify patients to receive particular healthcare notifications.

### VII. Website Hardware Architecture

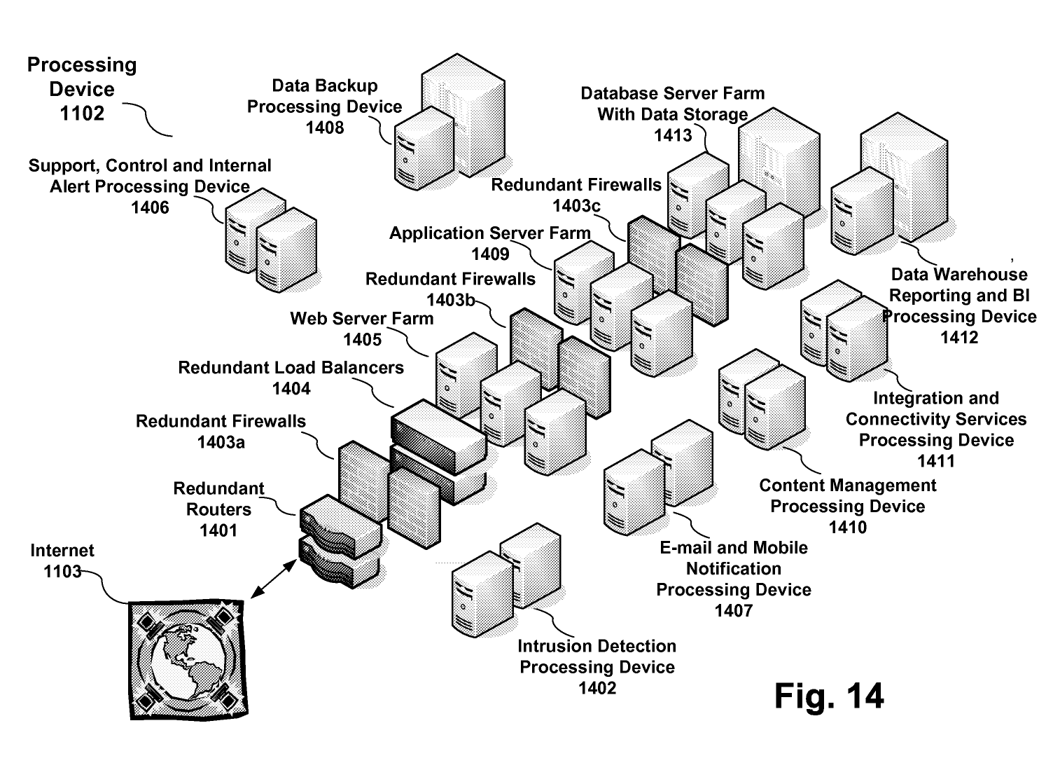

FIG. 14 illustrates a hardware architecture embodiment of processing device 1102 shown in FIG. 11A-C.

Processing device 1102 and software 1102a operate under an Application Service Provider (ASP) model. Software is delivered from processing device 1102 as services rather than a set of deliverables (s/w packages, executables, CDs, etc.) to processing devices 1105a-b, 1104a-b, 1152, 1172 and 1107 via Internet 1103. Software offered using an ASP model may be called On-demand software or Software as a Service (SaaS). For example, access to an application program, such as Healthcare Portal software component 1200 shown in FIG. 12A, using a standard protocol such as HTTP is provided by processing device 1102. Applications are accessed by content consumers and content providers through a web browser on their respective processing devices using HTML or by special purpose client software which access interfaces exposed by processing device 1102.

In embodiments, processing device 1102 includes a large number of servers, networking equipment, other processing devices, sub-systems and/or equivalent hardware, designed to support uninterrupted functioning of software components and services. As one of ordinary skill in the art would appreciate, more or less processing devices shown in FIG. 14 may be used in alternate embodiments. In embodiments, one or more software components illustrated in FIG. 12A are at least partially stored and/or at least partially executed by processing devices illustrated in FIG. 14. In alternate embodiments, processing devices illustrated in FIG. 14 may be replaced by functionally equivalent software components.

Redundant routers 1401 are coupled to Internet 1103 and are responsible for routing messages, such as IP packets, between Internet 1103 and the rest of processing device 1102 or the local area network of processing devices illustrated as processing device 1102 in an embodiment.

Redundant firewall 1403a, coupled to redundant router 1401, is responsible for, along with intrusion detection processing device 1402, detecting unauthorized users (such as hackers and intruders) and preventing unauthorized users from accessing processing device 1102.

Redundant firewalls 1403b and 1403c coupled to web server farm 1405, application server farm 1409 and database server farm with data storage 1413 also are responsible for preventing unauthorized users from accessing processing device 1102 and in particular application server farm 1409 and database server farm with data storage 1413.

Redundant load balancers 1404, coupled to redundant firewall 1403a, are responsible for providing a single Internet service from multiple servers and spread work among the multiple servers.

Support, Control and Internal Alert processing device 1406 is responsible for controlling, reporting, auditing and notifications associated with processing device 1102. In an embodiment, Support Control and Internal Alert processing device 1406 is used to support and maintain availability of processing device 1102. In an embodiment, support software component 1208 is at least partially stored and/or executed by processing device 1406.

Web server farm 1405 includes a plurality of processing devices that accept HTTP requests from Internet 1103 from healthcare providers and organizations as well as providing HTTP responses that may include data (such as HTML web pages/documents) to the healthcare providers and organizations. Web server farm 1405 accesses other processing devices that may provide information and services. For example, Web server farm 1405 may access email and mobile notification processing device 1407 to generate an email healthcare notification to a particular set of healthcare providers stored in database server farm with data storage 1413.

Email and mobile notification processing device 1407 is responsible for generating email and mobile healthcare notifications to selected healthcare providers. Software components 1201 and 1202 are at least partially stored and/or executed by processing device 407.

Application server farm 1409 includes a plurality of processing devices, coupled to redundant firewall 1403b, that are responsible for delivering applications/services to processing devices coupled to Internet 1103 using HTTP. Application server farm 1409 is responsible for dynamic content and accessing database server farm with data storage 1413. In an embodiment, healthcare portal 1200 is at least partially stored and/or executed by application server farm 1409.

Content Management processing device 1410 is responsible for creating and maintaining of the content such as publishing, editorial workflow, as well as definition of target distribution criteria. In an embodiment, content management software component 1204 is at least partially stored and/or executed by processing device 1410.

Integration and connectivity services processing device 1411 is responsible for integration with a variety of third party systems. Integration includes both publishing and subscription activities supporting two-way flow of the data. In an embodiment, IC software component 1205 is at least partially stored and/or executed on processing device 1411,

Database server farm with data storage 1413 includes a plurality of processing devices, coupled to redundant firewall 1403c, that are responsible for accessing database software component 1210 and rich media software component 1209. In an embodiment, database server farm with data storage 1413 accesses selected healthcare providers based on the content of healthcare related notifications provided by organizations and the healthcare provider profile. This selected list of healthcare providers along with associated electronic addresses are then passed to email and mobile notification processing device 1407 to generate the appropriate notices to the appropriate electronic addresses.

Data warehouse reporting and BI processing device 1412 is responsible for tracking and storing statistics, such as the number of acknowledgements and which healthcare providers had received healthcare related notifications and/or provided answers to survey questions. Organizations may access these statistics.

Data backup processing device 1408 backs up or provides a duplicate of data and transactions performed in processing device 1102.

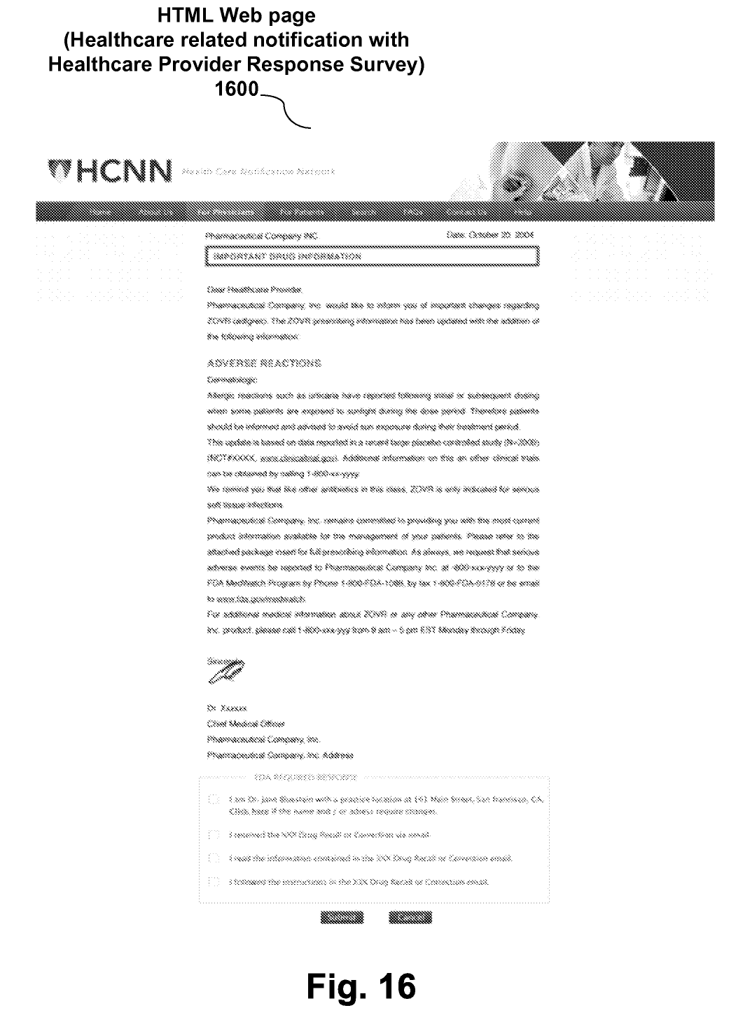

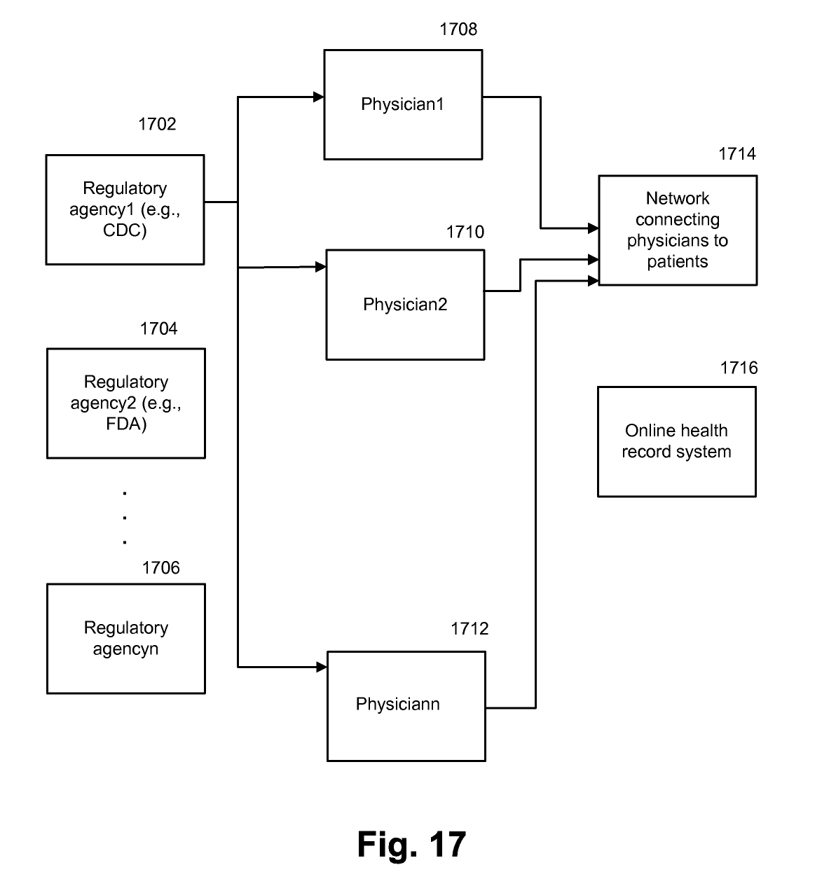

FIG. 17 is a system diagram illustrating a system in which another embodiment may be implemented. Specifically, the system enables organizations to communicate with healthcare providers regarding health-related issues affecting patient health. The organizations may include any organizations with a need to communicate with healthcare providers (e.g., physicians) on a local, regional or national level regarding health-related issues affecting patient health, such as the CDC or FDA. The health-related issue may, for example, pertain to issues such as those related to a product (e.g. product recall), food, medical device, or a drug (e.g., drug recall or correction, such as a label change), an epidemic, or bio-terrorism alert. Other examples may include newly discovered information about a medication such as drug interactions, use of the drug with patients with various medical disorders, or modifications to the proper dosage and administration of the drug.

In this example, a healthcare notification network enables communication on behalf of organizations such as regulatory agencies 1702, 1704, 1706 to healthcare providers such as physicians 1708, 1710, 1712. This may be accomplished, for example, through registration of the organizations and physicians with the network. In this manner, regulatory agencies such as the FDA or the CDC may communicate with healthcare providers such as physicians.

While it is possible that email may be used to support communication between the regulatory agencies 1702, 1704, 1706 and the healthcare providers 1708, 1710, 1712, there is currently no national professional healthcare email network. Through the use of a healthcare notification network, healthcare providers may access communications from these agencies. Similarly, the agencies may also receive responses from the healthcare providers, via the network, in response to the notifications. These communications may be secured (e.g., via username and password) or unsecured. The healthcare notification network enables notifications to be composed and delivered to physicians via email, as well as acknowledgements to be delivered back to the network, and then on to the organizations in response to the notifications, as will be described in further detail below.

In the example shown in FIG. 17, the regulatory agency 1702 (e.g., CDC) sends an electronic notification for a particular health-related issue to the network, for distribution to one or more healthcare providers. The electronic notification may also include a mechanism for obtaining an acknowledgement indicating, at minimum, that the healthcare provider has received and opened the electronic notification. In this manner, the regulatory agency 1702 may receive information from the network regarding an acknowledgement from the healthcare provider indicating that the healthcare provider has received and opened the electronic notification. The acknowledgement may also indicate that the healthcare provider has read the electronic notification, as well as indicate that the healthcare provider has followed or agrees to follow the instructions in the notification and/or that the healthcare provider has notified or will notify patients affected by the health-related issue. Other organizations 1704, 1706 (e.g., companies or regulatory agencies) may transmit or have electronic notifications transmitted and receive acknowledgements in a similar manner. From the acknowledgements (or reports thereon), the organizations 1702, 1704, 1706 may compile the appropriate reports in compliance with FDA and CDC regulations.

Once a healthcare provider (e.g., physician) has been notified of a particular health-related issue, they should notify the appropriate patients. This may be accomplished, for example, by notifying the patients via a network 1714 connecting the physician(s) to their patients. In other words, the network 1714 may be a network to which the healthcare provider and their patients belong. This notification may be a new notification message that is automatically generated or manually composed by the healthcare provider. Alternatively, the healthcare provider may choose to forward the notification received by the healthcare provider to the affected patients, when an organization has given the physician a notification that is appropriate for distribution to patients. The network 1714 may be a part of the network that enables communication between the organizations and the healthcare providers or, alternatively, the network 1714 may be a separate network connecting the healthcare providers to their patients. One such network connecting healthcare providers with patients is described in further detail in Attorney Docket No. MEDE-01000US0, patent application Ser. No. 10/387,041, entitled “HEALTHCARE PROVIDER-PATIENT ONLINE CONSULTATION SYSTEM,” filed on Mar. 10, 2003, naming Fotsch et al as inventors, which is incorporated herein by reference for all purposes. Through this network, secure and confidential communications between healthcare providers and patients is supported (e.g., via registration and login using a username/user ID and password).

The healthcare provider may send an appropriate notification message to all of his or her patients. Alternatively, the healthcare provider may identify the patients affected by the particular health-related issue identified in the notification message received by the healthcare provider. In order to identify the affected patients, the healthcare provider may search an online health record system 1716 storing health records for a plurality of patients to identify the subset of his or her patients affected by the particular health-related issue. For instance, the healthcare provider may search the online health record system 1716 for patients affected by a particular medical condition and/or taking a particular medication. An exemplary online health record system is described in further detail in Attorney Docket No. MEDE-01000US2, patent application Ser. No. 11/085,984, entitled “ELECTRONIC PERSONAL HEALTH RECORD SYSTEM,” filed on Mar. 21, 2005, naming Fotsch et al as inventors. In this manner, a healthcare provider may identify a segment of their patients affected by the health-related issue identified in a notification received from an organization such as the FDA or the CDC.

The electronic notification may be implemented in a variety of forms, and in accordance with a variety of formats and protocols. For instance, the electronic notification may be sent in the form of an electronic mail message. The electronic notification (e.g., electronic mail message) may also include a link to a web page that includes at least a part of the content of the electronic notification. The electronic mail message containing the notification can be sent to a computer email system, a pager, a cell phone, or other device, or some combination of the above, that will enable immediate access to the information by the healthcare provider.

Similarly, the acknowledgement may be transmitted by a healthcare provider to the network or organization that transmitted the electronic notification in a variety of forms, and in accordance with a variety of formats and protocols. For instance, the acknowledgement may be sent in the form of an electronic mail, or may be submitted via a website such as that referenced in the link from the electronic notification.

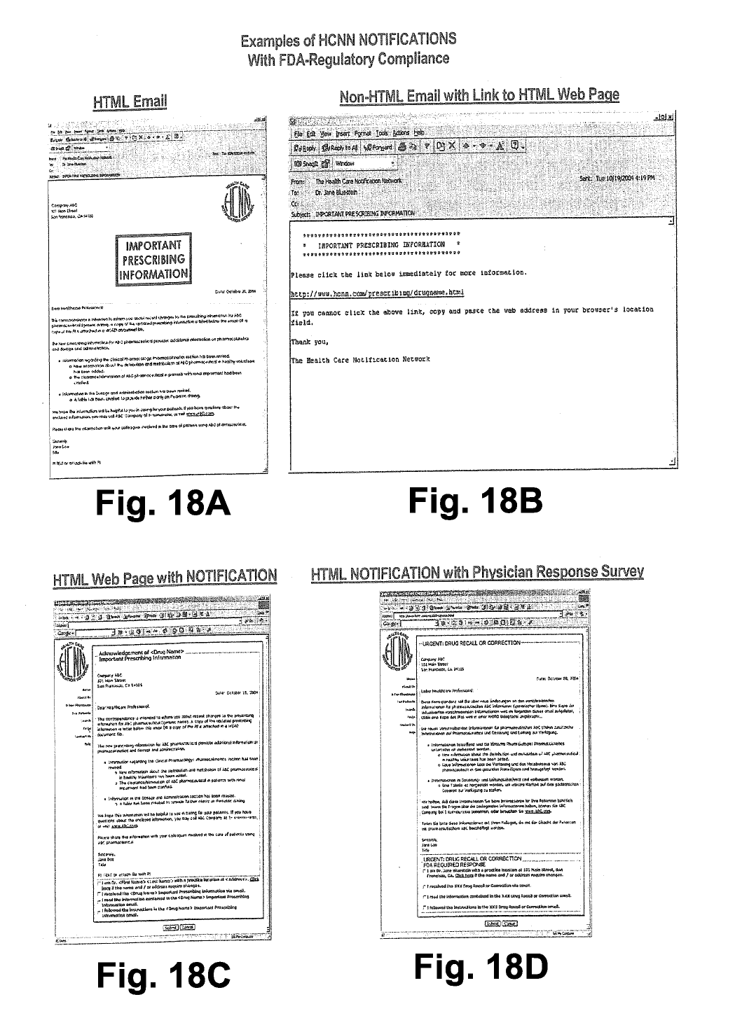

It is also important to note that the acknowledgement may also be sent automatically to the network or organization in the form of an automated response, as well as in response to input by the healthcare provider. For instance, an automated response may be implemented via a HTML tag, as will be described in further detail below. This is particularly useful, for example, in notifying the network, and then the organization, that the healthcare provider has received and opened the corresponding notification, since the healthcare provider may not be required to respond to a particular notification, or forget to respond to the notification. FIGS. 18A-D present exemplary mechanisms for transmitting a notification to a healthcare provider, as well as exemplary mechanisms for obtaining an acknowledgement from the healthcare provider.

It is important to note that, while conventional email systems may be used to transmit notifications, FDA regulations currently require that notifications sent to physicians use specific font sizes and colors. In order to fulfill such requirements, in accordance with one embodiment, HTML-type viewing of the notification is supported. This may be accomplished via a HTML email or an email with a link to a HTML web page.

In accordance with various embodiments, a notification email may be sent in HTML format, as well as non-HTML format. FIG. 18A is an exemplary HTML email including a notification that may be transmitted to healthcare providers. This exemplary email pertains to prescribing information. Specifically, in this example, new information about the distribution and metabolism of the identified drug is provided. In addition, the effect of the medication on patients with renal impairment is clarified, and information regarding the dosage and administration of the drug is clarified with respect to pediatric dosing.

In accordance with one embodiment, if the recipient has a HTML-capable email application, the HTML email will be opened and a HTML tag in the HTML email will report receipt back to the healthcare notification network, thereby supporting automated acknowledgement in response to the notification. In some embodiments or if the recipient's email application is not HTML-capable, the recipient receives a simple message (in HTML or non-HTML format) that an important patient safety message is available through a hypertext link embedded in the email. The recipient then clicks on the link and is taken to a HTML web page. At that time, a HTML tag may be reported to the healthcare notification network. In accordance with one embodiment, the HTML tag will carry the information necessary to accurately identify the healthcare provider.

As set forth above, rather than providing the relevant information in the email itself, the information (or portion thereof) may be provided in a separate web page. FIG. 18B is an exemplary non-HTML email with a link to a HTML web page including a notification that may be transmitted to healthcare providers. In this example, the notification is not provided in the email, but in the web page. Thus, the user must access the web page referenced in the email to read the notification.

As set forth above, a HTML notification may be provided in the form of a link to a HTML web page or HTML email. FIG. 18C is an exemplary HTML web page with notification and physician response survey that may be transmitted to healthcare providers, while FIG. 18D is an exemplary HTML notification with a physician response survey that may be transmitted to healthcare providers.

As shown in both FIGS. 18C and 18D, the notification may include a mechanism for obtaining an acknowledgement, which may be in the form of a physician response survey (as shown). The physician response survey may be accessed when the user accesses the web page (as shown), or alternatively, may be accessed when the user reads the electronic notification (e.g., email). The physician response survey includes one or more questions or entries requiring a response by the healthcare provider.

In this example, the physician response survey enables a healthcare provider to confirm his or her identity, as well as submit any name or address changes. Moreover, the healthcare provider may indicate that he or she has followed or will follow the instructions provided in the electronic notification (as shown), or more specifically, the healthcare provider may indicate that he or she has notified or will notify patients affected by the health-related issue.

The above-described embodiments may be used to notify healthcare providers (e.g., physicians) of issues affecting patient health. Thus, the notifications and content thereof may comply with FDA and/or CDC regulations. For instance, FDA regulations may be found in the ORA/Office of Enforcement, Division of Compliance Management and Operations Guidance for Industry, Product Recalls, including Removals and Corrections, which may be found at HTTP://www.fda.gov/ora/compliance_ref/recalls/ggp_recall.htm, which is incorporated herein by reference. In accordance with such regulations, information may include a description or identification of the product that is the subject of the notification. The description or identifying information may include information such as the identity of the manufacturer, as well as the identity of the recalling firm (e.g., manufacturer, importer, broker, repacker, or own-label distributor). The information provided in the notification may also include the identity of the firm responsible for the violation or problem, as well as the reason for the recall or notification. Furthermore, the notification may also include a health hazard assessment including an assessment of the health risk. Finally, the notification may provide instructions to the patients, such as returning the product, discontinued use of the product, or modification of dosage or other instructions for modified use of the product in accordance with the notification.

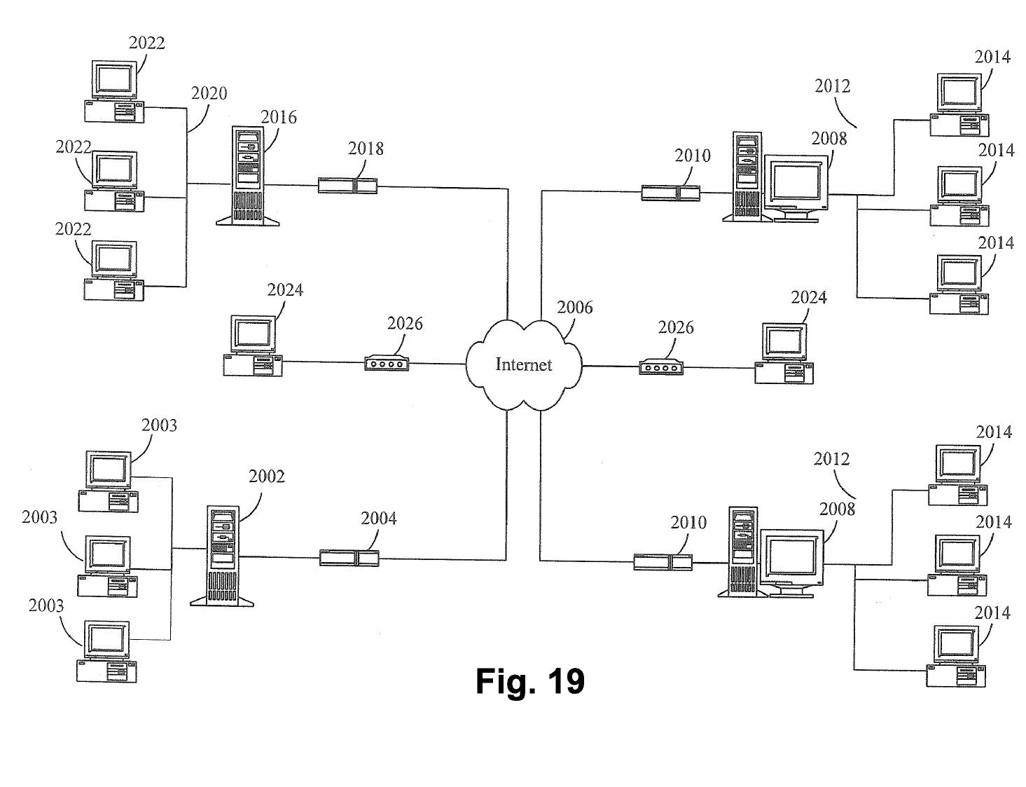

FIG. 19 is a block diagram of a hardware environment in which the various embodiments of the healthcare notification network may be implemented in order to facilitate communication between organizations and healthcare providers. The healthcare notification network through which communications between organizations and one or more physicians are facilitated according to an embodiment and the network itself through which these notifications are sent may be include a server 2002, which is connected by a router 2004 to the Internet 2006. Employees of the network at computers 2003 may be coupled to the server 2002 to receive communications from organizations. Once the employees review the communications and deemed them appropriate for transmission, they may transmit them to healthcare providers by the router 2004 via the Internet 2006.

In addition, physician office computers 2008 may also be connected to the Internet via routers 2010 in order to receive the transmission of emails from the server 2002 and transmit acknowledgement messages to the server 2002 (e.g., via answering a survey or automatically). The physician office computers 2008 may run software as well as store messages such as notification messages received by the physicians. Physician office computers 2008 may have networks 2012 associated therewith interconnecting a plurality of personal computers or work stations 2014. In this manner, an office network may access received emails from the email client through the server 2002. Organizations (e.g., agencies) (represented by computers 2022 and 2024) may be connected to the Internet in a variety of ways for transmission of messages to the network. For example, an agency worker employed by an agency may be connected from his home via a modem 2026, or from his workplace via a network 2020, a file server 2016, and a router 2018. It will be understood that, according to various embodiments of the invention, employees of such organizations or agencies may gain access to the Internet for transmission of information to the network and then on to the healthcare provider via a variety of hardware configurations. Similarly, such employees may be coupled to a website on server 2002 in order to gain access to the server 2002 and to initiate the transmission of communications such as email notifications to the network, for distribution to one or more physicians. Similarly, an employee may access the network 2002 or website from his computer 2014 at his place of employment. It will also be understood that the hardware environment of FIG. 19 is shown for illustrative purposes and that a wide variety of hardware environments may be employed to implement the various embodiments of the present invention. It should also be understood that specific embodiments of the methods and processes described herein may be implemented as computer program instructions, i.e., software, in the memory of the computers and servers.

Although illustrative embodiments are shown and described herein, many variations and modifications are possible which remain within the concept, scope, and spirit of the claims, and these variations would become clear to those of ordinary skill in the art after perusal of this application. For instance, an embodiment is based upon the generation and transmission of notification messages via email and/or website. However, it should be understood that embodiments are not limited to this arrangement, but instead would equally apply regardless of the mode of transmission or system configuration, including the use of pagers, cell phones, or other instruments as receiving devices for the notifications. Accordingly, the present embodiments are to be considered as illustrative and not restrictive, and the invention is not to be limited to the details given herein, but may be modified within the scope and equivalents of the appended claims.

What is claimed is:

1. A reporting system to provide drug or medical device information to a healthcare provider, the system comprising:
a first processing device including a first processor to execute first machine readable instructions stored on a first storage device, the first processing device to provide first drug or medical device information for a first drug or first medical device in response to the execution of the first machine readable instructions;
a second processing device including a second processor to execute second machine readable instructions stored on a second storage device, the second processing device to provide second drug or medical device information for the first drug or first medical device in response to the execution of the second machine readable instructions;
a third processing device including a third processor to execute third machine readable instructions stored on a third storage device, the third processing device to receive and map the first and second drug or medical device information into compiled drug or medical device information in response to the execution of the first machine readable instructions; and
a fourth processing device including a fourth processor to execute fourth machine readable instructions stored on a fourth storage device, the fourth processing device to provide an electronic health record of a patient to a healthcare provider in response to the execution of the fourth machine readable instructions, the electronic health record including an indication of the compiled drug or medical device information;
wherein the third processing device provides the compiled drug or medical device information to the healthcare provider in response to a selection of the indication of the compiled drug information during a workflow of the healthcare provider.

2. The system of claim 1, wherein the first drug information is drug information in electronic form and provided by the FDA and wherein the second drug information is in electronic form and provided by a manufacturer of the drug.

3. The system of claim 1, wherein the first drug information includes at least one of a drug product label, a drug safety communication, a medication guide, REMS information and FDA early warnings.

4. The system of claim 3, wherein the second drug information includes at least one of a drug product label and an alert regarding the drug.

5. The system of claim 1, wherein the compiled drug information includes summaries of the first and second drug information provided by the third processing device.

6. The system of claim 5, wherein the indication of the compiled drug information includes a hyperlink in the electronic health record of the patient.

7. The system of claim 1, wherein the electronic health record includes an indication to report adverse events associated with the drug, and wherein the third processing device receives information regarding adverse events associated with the drug, and wherein the third processing device aggregates and transfers the information regarding adverse events to the first and second processing device.

8. The system of claim 7, wherein the first and second processing devices update the first and second drug information in response to the information regarding adverse events associated with the drug.

9. The system of claim 7, further comprising:
a fifth processing device including a fifth processor to execute fifth machine readable instructions stored on a fifth storage device, the fifth processing device to receive information regarding adverse events associated with the drug in response to the execution of the fifth machine readable instructions, the fifth processing device to transfer information regarding clinical education or CMEs to the third processing device in response to the information regarding adverse events associated with the drug.

10. A method performed by a processing device to report drug or medical device information to a healthcare provider, the method comprising:
receiving, by the processing device, first drug or medical device information from a first source;
receiving, by the processing device, second drug or medical device information from a second source;
combining, by the processing device, the first drug or medical device information and second drug or medical device information into compiled drug or medical device information;
providing, by the processing device, the compiled drug or medical device information in response to a selection by a healthcare provider during a workflow of the healthcare provider;
receiving, by the processing device, information regarding an adverse event regarding the drug or medical device; and
aggregating, by the processing device, information regarding the adverse event of the drug or medical device with other information regarding an adverse event of the drug or medical device into an adverse event report; and
transferring, by the processing device, the adverse report to the first and second source so that the first and second drug or medical device information is updated.

11. The method of claim 10, wherein the first source includes a processing device have a storage device to store FDA information, and wherein the first drug information includes at least one of a drug product label, a drug safety communication, a medication guide, REMS information and FDA early warnings.

12. The method of claim 11, wherein the second source includes a processing device having a storage device to store drug manufacturer information, and wherein the second drug information includes at least one of a product label and an alert regarding the drug.

13. The method of claim 10, further comprising providing, by the processing device, information regarding drug or medical device information that is selected from at least one of samples of the drug or medical device, coupons of the drug or medical device, financial assistance for a patient prescribed the drug or to use the medical device, patient education regarding the drug or medical device, clinical reference for the drug or medical device, access to ask the expert, physician communications/education, patient communications/education, registries, clinical trials and patient medication and adherence programs.

14. The method of claim 10, further comprising:
transferring, by the processing device, the adverse report to a processing device having a storage device to store insurance information; and
receiving, from the processing device having insurance information, information regarding clinical education or CMEs in response to the adverse report.

15. The method of claim 14, further comprising:
transferring, by the processing device, the adverse report to a processing device having a storage device to store information to provide an electronic health record; and
receiving, from the processing device having electronic health record information, information regarding education or training for the drug or medical device which is accessible by the healthcare provider.

16. The method of claim 15, wherein the selection by a healthcare provider includes the healthcare provider selecting a hyperlink associated with the drug or medical device at an electronic health record of a patient.

17. A processing device to report drug or medical device safety information to a healthcare provider, the processing device comprising:
at least one storage device to store a plurality of different types of safety information regarding a plurality of drugs or medical devices;
at least one processor, coupled to the storage device;
the at least one storage device to store executable machine readable instructions for controlling the processor; and
the at least one processor is operative with the executable machine readable instructions to:
receive the plurality of different types of safety information regarding the plurality of drugs or medical devices from multiple sources;
associate the plurality of different types of safety information for a respective drug or medical device in the plurality of drugs or medical devices with a respective plurality of internal identifiers;
receive a selection of a drug or medical device by the healthcare provider during a workflow; and
provide at least one of the plurality of different types of safety information for the selected drug or medical device to the healthcare provider by using an identifier in the plurality of internal identifiers.

18. The processing device of claim 17, wherein the at least one processor is operative with the executable machine readable instructions to further:
receive information regarding a plurality of adverse events of using the drug or medical device;
aggregate the plurality of adverse events to provide a report; and
transfer the report to at least one of the sources so that at least of one the plurality of different types of safety information that is received is updated with current safety information.

19. The processing device of claim 18, wherein the plurality of different types of safety information are in a plurality of different types of formats.

20. The processing device of claim 19, wherein the plurality of different types of safety information includes at least one of following types of safety information: full label, concise, alert, FDA DHCPLs, MGs, REMS-term summary, REMS-Notification Summary and FDA Early Warning.

21. The processing device of claim 17, wherein the at least one processor is operative with the executable machine readable instructions to:
associate external identifiers corresponding to respective drug or medical device in the plurality of drugs or medical devices with the respective plurality of internal identifiers.
